(19) United States
(12) Patent Application Publication
(10) Pub. No.: US 2004/0097366 A1
(43) Pub. Date: May 20, 2004

(54) Polyolefin-based composite resin, method for production thereof, catalyst for polymerization of vinly compound and method for polymerization of vinly compound using the same

(76) Inventors: Haruhito Sato, Chiba (JP); Harumi Nakashima, Chiba (JP); Toshiya Ariko, Chiba (JP); Kazuhiko Ito, Chiba (JP); Kiyohiko Yokota, Chiba (JP); Takenori Fujimura, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/472,487

(22) PCT Filed: Mar. 25, 2002
(86) PCT No.: PCT/JP02/02854

(30) Foreign Application Priority Data
Mar. 29, 2001 (JP) 2001-95464
Mar. 29, 2001 (JP) 2001-95454
May 18, 2001 (JP) 2001-149344
Nov. 9, 2001 (JP) 2001-344183

(51) Int. Cl. B01J 31/00

(52) U.S. Cl. 502/152; 524/445; 526/160; 526/943

(57) ABSTRACT

Disclosed are (1) a polyolefin-based composite resin obtained using a catalyst comprising a silane-treated product of a layered compound such as clay and a transition metal complex, (2) a polyolefin-based composite resin comprising a polyolefin-based resin composition obtained using a catalyst comprising the layered compound and the transition metal complex each described above and a specific compound, (3) a production process for a high rigidity composite molded article, comprising subjecting the polyolefin-based composite resin obtained using the catalyst described above to shearing treatment during heating, (4) a production process for an olefin/polar vinyl monomer copolymer, using the catalyst described above and (5) a vinyl compound-polymerizing catalyst comprising a layered compound treated with a specific silane compound and a transition metal complex. A polyolefin-based composite resin having a high rigidity in which a layered compound or a silane-treated product thereof is dispersed to a high degree is obtained by using the catalyst described above.

### TECHNICAL FIELD

The present invention relates to (1) a polyolefin-based composite resin in which a silane-treated product is dispersed to a high degree in polyolefin by polymerizing olefin and/or diene using a catalyst comprising the silane-treated product and a transition metal complex, a composition comprising the above composite resin and a production process for the above composite resin, (2) a polyolefin-based composite resin having less content of clay, a clay mineral or an ion-exchangeable layered compound and a high rigidity, (3) a process for producing a composite molded article having a light weight and a high rigidity from a polyolefin-based composite resin containing a layered compound, and (4) a process for producing an olefin/polar vinyl monomer copolymer which is excellent in an adhesive property, a printing property, a hydrophilic property and a miscibility in a polymer blend and which is suited as a sheet material, an extrusion-molding material and a material for automobiles. The present invention also relates to (5) a vinyl compound-polymerizing catalyst which can elevate a viscoelasticity and a mechanical characteristic of a vinyl compound polymer to a large extent and a method for production thereof, a polymerizing process for a vinyl compound using the same, a vinyl compound polymer which is obtained by the above process and which has the characteristics described above and a composite resin comprising the above vinyl compound polymer and a thermoplastic resin.

### BACKGROUND ART

Processes for polymerizing olefins using a layered silicate and a metallocene complex have so far been proposed. Among them, composite resins having an elevated content of a layered silicate contained in polyolefin obtained therefrom are proposed in WO99/47598 and WO00/22010.

However, expensive methylaluminoxane is used in either of WO99/47598 and WO00/22010, and only a polymerization example of ethylene is investigated. This is because of the reasons that a layered silicate used is an Na type and an amine compound is intercalated and that an inexpensive aluminum compound can not be used instead of methylaluminoxane and in addition thereto, a monomer which is less liable to be polymerized such as propylene has not been able to be polymerized. Further, a layered silicate was less likely to. be dispersed in polyolefin.

It is generally proposed in Japanese Patent Application Laid-Open No. 41346/1994, etc., to try to disperse clay having a particle diameter of a nano- (10⁻⁹) meter order in polyolefin by a method of only kneading, but it is only proposed in both WO99/47598 and WO00/22010 to produce a polyolefin-based composite resin containing a layered silicate by a polymerization process.

On the other hand, processes for copolymerizing olefins with polar vinyl monomers using metallocene complex-based catalysts include those described in Japanese Patent Application Laid-Open No. 25320/1994, Japanese Patent Application Laid-Open No. 172447/1994, Japanese Patent Application Laid-Open (through PCT) No. 513761/2000, Japanese Patent Application Laid-Open No. 319332/2000 and Japanese Patent Application Laid-Open No. 11103/2000. A process using a non-metallocene complex-based catalyst is disclosed as well in Japanese Patent Application Laid-Open No. 319332/2000.

Among these processes, in the processes for producing copolymers of olefins with polar vinyl monomers described in Japanese Patent Application Laid-Open No. 25320/1994, Japanese Patent Application Laid-Open No. 172447/1994, Japanese Patent Application Laid-Open (through PCT) No. 513761/2000 and Japanese Patent Application Laid-Open No. 11103/2000, expensive methylaluminoxane or expensive fluoroborate is used as a promoter. It is not described in these publications to use a layered compound of the present invention as a promoter. Also, the copolymerization activity was not high.

Further, in examples described in Japanese Patent Application Laid-Open No. 25320/1994 and Japanese Patent Application Laid-Open No. 172447/1994, 10-undecene-1-ol in which an olefin part is separate from a functional group (OH) is used as a polar vinyl monomer in order to make it possible to copolymerize olefin with the polar vinyl monomer. Thereafter, it is proposed, as described in examples of Japanese Patent Application Laid-Open (through PCT) No. 513761/2000, to use polar vinyl monomers such as 5-hexene-1-ol in which an olefin part is closer to a polar group. However, the production process described above has had the problem that copolymerization of a polar vinyl monomer in which an olefin part is closer to a polar group with olefin does not sufficiently proceed. Examples using polar vinyl monomers in which a polar group is bonded directly to an allyl (CH₂═CHCH₂) part used in the present examples described later are not shown in the publications described above.

Copolymerization of alkenylsilane with olefin is publicly known, but an addition polymer having a preferred melt viscoelasticity, particularly an addition polymer having a high non-Newtonian property is less liable to be obtained.

Accordingly, cross-linking by radiation (Japanese Patent No. 3169385) or cross-linking by transition metal complex treatment (Japanese Patent No. 3169386) has been required in order to obtain an addition polymer having an excellent melt viscoelasticity.

That is, it is the existing situation that in these techniques, prescribed objects cannot be achieved without producing copolymers of alkenylsilanes and olefins and then passing through more operations.

WO99/14247, WO99/48930, WO00/11044 and WO00/32642 are known as a process for polymerizing olefin using a layered silicate and a metallocene complex, but additional polymers having a high melt viscoelasticity and an excellent mechanical characteristic are not obtained.

All of the techniques described in these publications have an object of reducing a use amount of organic aluminum such as methylaluminoxane or trimethylaluminum which is inconvenient in handling and inferior in storage stability and which is highly hazardous by combining metallocene complexes with layered silicates, and they do not have an object of obtaining olefin-based polymers in which the above layered silicates are dispersed to a high degree to improve a melt viscoelasticity and a mechanical characteristic. Accordingly, the above layered silicates are used in an amount required as a catalyst component, and a trace amount thereof is contained in an olefin-based polymer formed. An effect for improving the physical properties of the above polymer is not at all demonstrated.

Further, no descriptions are found on a polymerization catalyst comprising an alkenylsilane-treated product obtained by treating a layered compound with alkenylsilane and a complex of a transition metal of Group 4 to Group 6 or Group 8 to Group 10 in the Periodic Table.

### DISCLOSURE OF THE INVENTION

Under such circumstances, a first object of the present invention is to provide a polyolefin-based composite resin in which a silane-treated product prepared by subjecting a layered compound such as clay to silane treatment is dispersed to a high degree and which has a high rigidity, a composition comprising the above composite resin and a production process for the above composite resin. A second object thereof is to provide a polyolefin-based composite resin having less content of clay, a clay mineral or an ion-exchangeable layered compound and a high rigidity. A third object thereof is to provide a process for producing a composite molded article having a light weight and a high rigidity from a polyolefin-based composite resin containing a layered compound.

Further, a fourth object of the present invention is to provide a process for producing an olefin/polar vinyl monomer copolymer which is excellent in an adhesive property, a printing property, a hydrophilic property and a miscibility in a polymer blend and which is suited as a sheet material, an extrusion-molding material and a material for automobiles. A fifth object thereof is to provide a vinyl compound-polymerizing catalyst which can elevate a viscoelasticity and a mechanical characteristic of a vinyl compound polymer to a large extent, a method for production thereof, a polymerizing process for a vinyl compound using the same, a vinyl compound polymer which is obtained by the above process-and which has the characteristics described above and a composite resin comprising the above vinyl compound polymer.

Intensive researches repeated by the present inventors in order to achieve the objects described above have resulted in finding that a polyolefin-based composite resin in which a silane-treated product is dispersed to a high degree and which has a high rigidity is obtained by polymerizing olefins and dienes using a catalyst comprising a silane-treated product of a layered compound such as clay and a specific transition metal complex and thus the first object can be achieved and that the second object can be achieved by a polyolefin-based composite resin comprising an olefin-based resin composition obtained using a catalyst comprising a silane-treated product of a layered compound such as clay and a transition metal complex and a specific compound.

Also, it has been found that a composite molded article having a high rigidity is obtained by subjecting a polyolefin-based composite resin obtained using a catalyst comprising a layered compound and a specific transition metal complex to shearing treatment during heating and thus the third object can be achieved and that the fourth object can be achieved by copolymerizing olefin with a polar vinyl monomer using a catalyst comprising a layered compound and a specific transition metal complex.

Further, it has been found that a non-Newtonian property of a vinyl compound polymer is raised and the mechanical characteristics thereof such as a tensile characteristic are elevated to a large extent by using a polymerization catalyst comprising a layered compound treated by alkenylsilane and a specific transition metal complex and that the above polymerization catalyst can efficiently be obtained by subjecting to specific contact treatment, and it has been found that a complex resin comprising the vinyl compound polymer described above and a thermoplastic resin is excellent in various mechanical characteristics, whereby the fifth object can be achieved.

The present invention has been completed based on such findings.

That is, the first object of the present invention is achieved by:

(1) a polyolefin-based composite resin produced using a polymerization catalyst comprising a silane-treated product prepared by treating clay, a clay mineral or an ion-exchangeable layered compound with a silane compound and a complex of a transition metal of Group 4 to Group 6 in the Periodic Table, characterized by comprising a polyolefin resin in an amount of 20 to 99.3% by weight and the silane-treated product in an amount of 80 to 0.7% by weight; (2) a composite resin composition obtained by blending the polyolefin-based composite resin prepared in the item (1) described above with a thermoplastic resin, characterized by comprising the silane-treated product in the item (1) described above in an amount of 0.2 to 20% by weight, (3) an antioxidant-blended polyolefin-based composite resin composition characterized by blending the polyolefin-based composite resin prepared in the item (1) described above with a phenol-based antioxidant and (4) a production process for a polyolefin-based composite resin comprising a polyolefin resin in an amount of 20 to 99.3% by weight and a silane-treated product in an amount of 80 to 0.7% by weight, characterized by polymerizing olefin and/or diene using a polymerization catalyst comprising the silane-treated product prepared by treating clay, a clay mineral or an ion-exchangeable layered compound with a silane compound and a complex of a transition metal of Group 4 to Group 6 in the Periodic Table (hereinafter referred to as the first aspect of the invention).

The second object of the present invention is achieved by:

(5) an olefin-based composite resin comprising an olefin-based resin composition obtained by polymerizing olefin using a polymerization catalyst comprising clay, a clay mineral or an ion-exchangeable layered compound and a transition metal complex and at least one compound selected from a metal salt compound and a basic inorganic compound (hereinafter referred to as the second aspect of the invention).

The third object of the present invention is achieved by:

(6) a production process for a high rigidity composite molded article, comprising a step of molding a polyolefin-based composite resin obtained by polymerizing olefin using a catalyst comprising a layered compound and a complex of a transition metal of Group 4 to Group 10 in the Periodic Table, wherein the above composite resin is subjected to a shearing treatment during heating in the above step (hereinafter referred to as the third aspect of the invention).

The fourth object of the present invention is achieved by:

(7) a production process for an olefin/polar vinyl monomer copolymer, characterized by using a catalyst comprising a layered compound as component (A) and a complex of a transition metal of Group 4 to Group 10 in the Periodic Table as component (B) and characterized by copolymerizing olefin as component (C) with a polar vinyl monomer as component (D) (hereinafter referred to as the fourth aspect of the invention).

The fifth object of the present invention is achieved by:

(8) a vinyl compound-polymerizing catalyst comprising an alkenylsilane-treated product as component (X) obtained by treating a layered compound with alkenylsilane and a complex of a transition metal of Group 4 to Group 6 or Group 8 to Group 10 in the Periodic Table as component (Y),

(9) the vinyl compound-polymerizing catalyst as described in the above item (8), wherein the component (X) obtained by bringing the layered compound into contact with the alkenylsilane is brought into contact with the component (Y),

(10) a polymerization process for a vinyl compound, characterized by polymerizing a vinyl compound as component (Z) using the vinyl compound-polymerizing catalyst prepared in the above item (8) or the polymerizing catalyst produced by the process as described in the above item (9),

(11) a vinyl compound polymer obtained by the polymerization process as described in the above item (10),

(12) a composite resin comprising the vinyl compound polymer as described in the above item (10) and a thermoplastic resin, and

(13) a composite resin composition comprising a copolymer of alkenylsilane and propylene and a layered compound, wherein the layered compound is dispersed in the copolymer in the form of a particle having a particle diameter of 1 μm or less (hereinafter referred to as the fifth aspect of the invention).

### BRIEF DESCRIPTION OF THE DRAWINGS

FIG. 1 is a graph showing a detailed profile of polymerization reaction in Example 1.

FIG. 2 is a graph showing the measuring results of the solid viscoelasticity in Example 5, Example 8 and Example 9.

FIG. 3 is a graph showing the measuring results of the solid viscoelasticity in Example 13 and Comparative Example 2.

FIG. 4 is a drawing showing an infrared absorption spectrum of polypropylene containing primary amine in Example 19.

FIG. 5 is a drawing showing a molecular weight distribution of the polymer and a composition distribution of an allylamine unit in the polymer in Example 19.

FIG. 6 is a drawing showing a molecular weight distribution of the polymer and a composition distribution of an allylamine unit in the polymer in Example 20.

FIG. 7 is a drawing showing a vinylsilane composition curve in Example 21.

FIG. 8 is a drawing showing a melt characteristic of the polymer in Example 22.

FIG. 9 is a radar chart showing various mechanical characteristics of the composite resin in Example 26 and the polymer in Comparative Example 9.

### BEST MODE FOR CARRYING OUT THE INVENTION

First, the first aspect of the present invention shall be explained.

The first aspect of the invention relates to the polyolefin-based composite resin, the composite resin composition using the same and the production process for the above polyolefin-based composite resin.

In this first aspect of the invention, a silane-treated product prepared by subjecting clay, a clay mineral or an ion-exchangeable layered compound (hereinafter they shall be referred to as the layered compound) as one component of the polymerization catalyst to silane treatment is used as a promoter. Clay means a substance which is an aggregate of fine hydrate silicate minerals and produces plasticity by mixing with water and kneading and which shows rigidity by drying and is sintered by baking at a high temperature. A clay mineral means silicate hydrate which is a principal component of clay. They may be not only natural products but also artificially synthesized products. An ion-exchangeable layered compound is a compound having a crystalline structure in which planes structured by an ionic bond are superposed parallel on each other by a weak bonding power and in which ions contained are exchangeable. The clay minerals include the ion-exchangeable layered compounds. In the above first aspect of the invention, a 2:1 type layered compound having a layer charge of 0.05 to 0.7, preferably 0.05 to 0.6 is suitably employed.

For example, the clay mineral includes phyllosilicic acids. The phyllosilicic acids include phyllosilicic acid and phyllosilicate. The phyllosilicate includes montmorillonite, saponite and hectoliter belonging to a smectite group as a natural product, illite and sericite belonging to a mica group and a mixed layer mineral of a smectite group and a mica group or a mixed layer mineral of a mica group and a vermiculite group.

The synthetic products include fluorine tetrasilicon mica, laponite and smectone. In addition thereto, typical examples of the synthetic products include ionic crystalline compounds having a stratified crystalline structure which are not clay minerals, such as α-Zr(HPO₄)₂, γ-Zr(HPO₄)₂, α-Ti(HPO₄)₂ and γ-Ti(HPO₄)₂.

In the above first aspect of the invention, clay minerals called smectite are preferred, and montmorillonite is particularly preferred.

The form of the clay, the clay mineral or the ion-exchangeable layered compound used in the above first aspect of the invention is preferably a particle having a volume average particle diameter of preferably 10 μm or smaller, more preferably a particle having a volume average particle diameter of 3 μm or smaller. In general, the particle form of particles has a particle diameter distribution. However, preferred are the particles having a volume average particle diameter of 10 μm or smaller and a particle diameter distribution in which the particles having a volume average particle diameter of 3.0 μm or smaller have a content of 10% by weight or more, and more preferred are the particles having a volume average particle diameter of 10 μm or smaller and a particle diameter distribution in which the particles having a volume average particle diameter of 1.5 μm or smaller have a content of 10% by weight or more. A measuring method of the volume average particle diameter and the content includes, for example, a measuring method by the use of an apparatus (CIS-1 produced by GALAI Production Ltd.) measuring a particle diameter by a light transmittance by means of a laser beam.

The silane-treated product used in the above first aspect of the invention is obtained by treating a layered compound with a silane compound. An organic silane compound having carbon in an element bonded directly to silicon can be used as the silane compound. The above organic silane compound is preferably an organic silane compound represented by Formula (1):

R^{a}₄₋ₙSiXₙ (1)

(wherein R^{a} represents a group in which an element bonded directly to silicon is carbon, silicon or hydrogen, and at least one R^{a} is a group in which an element bonded directly to silicon is carbon; when a plurality of R^{a} is present, a plurality of R^{a} may be the same or different; X represents a halogen atom or a group in which an element bonded directly to silicon is nitrogen or oxygen, and when a plurality of X is present, a plurality of X may be the same or different; and n is an integer of 1 to 3). In Formula (1), the group in which an element bonded directly to silicon is carbon includes an alkyl group, an alkenyl group, an aryl group, an aralkyl group and a cyclic saturated hydrocarbon group. In the above first aspect of the invention, an alkyl group, an alkenyl group and a saturated hydrocarbon group are preferred. When it is an alkyl group, the alkyl group has preferably total 2 to 12 carbon atoms.

The alkyl group includes methyl, ethyl, n-propyl, isopropyl, n-butyl, isobutyl, tert-butyl, n-hexyl and n-decyl. The alkenyl group includes vinyl, propenyl and cyclohexenyl, and the group having 2 to 6 carbon atoms is preferred. The aryl group includes phenyl, tolyl, xylyl and naphthyl. The aralkyl group includes benzyl and phenethyl. The cyclic saturated hydrocarbon group includes cyclopentyl, cyclohexyl and cyclooctyl, and cyclopentyl and cyclohexyl are preferred.

The group in which an element bonded directly to silicon is silicon includes hexamethyldisilane, hexaphenyldisilane, 1,2-dimethyl-1,1,2,2-tetraphenyldisilazane and dodecamethylcyclohexadisilane.

The group in which an element bonded directly to silicon is hydrogen includes ethyldichlorosilane, dimethyldichlorosilane, trimethoxysilane, diethylsilane, dimethyldiethylaminosilane and allyldimethylsilane.

X is the same as in Formula (1′) described later.

In the above first aspect of the invention, more suited silane compound is an organic silane compound represented by Formula (1′):

R¹₄₋ₙSiXₙ (1′)

(wherein R¹ represents a hydrocarbon group, and when a plurality of R¹ is present, a plurality of R¹ may be the same or different; X represents a halogen atom or a group in which an element bonded directly to silicon is nitrogen or oxygen, and when a plurality of X is present, a plurality of X may be the same or different; and n is an integer of 1 to 3). In Formula (1′), the hydrocarbon group includes an alkyl group, an alkenyl group, an aryl group, an aralkyl group and a cyclic saturated hydrocarbon group. In the above first aspect of the invention, an alkyl group, an alkenyl group and a saturated hydrocarbon group are preferred. When it is an alkyl group, the alkyl group has preferably total 2 to 12 carbon atoms.

The alkyl group includes methyl, ethyl, n-propyl, isopropyl, n-butyl, isobutyl, tert-butyl, n-hexyl and n-decyl. The alkenyl group includes vinyl, propenyl and cyclohexenyl, and in the above first aspect of the invention, the group having 2 to 6 carbon atoms is preferred. The aryl group includes phenyl, tolyl, xylyl and naphthyl. The aralkyl group includes benzyl and phenethyl. The cyclic saturated hydrocarbon group includes cyclopentyl, cyclohexyl and cyclooctyl, and in the above first aspect of the invention, cyclopentyl and cyclohexyl are preferred.

X is a halogen atom or a group in which an element bonded directly to silicon is nitrogen or oxygen. The halogen atom includes fluorine, chlorine, bromine and iodine, and in the above first aspect of the invention, chlorine is preferred. The group in which an element bonded directly to silicon is nitrogen includes an amino group, an alkylamino group, a triazole group and an imidazole group. The group in which an element bonded directly to silicon is oxygen includes an alkoxy group and an aryloxy group. To be specific, it includes methoxy, ethoxy, propoxy, butoxy and phenoxy, and in the above first aspect of the invention, methoxy and ethoxy are preferred.

The specific compounds of the organic silane compound represented by Formula (1′) include, for example, chlorosilanes such as trimethylchlorosilane, triethylchlorosilane, triisopropylchlorosilane, t-butyldimethylchlorosilane, t-butyldiphenylchlorosilane and phenethyldimethylchlorosilane; dichlorosilanes such as dimethyldichlorosilane, diethyldichlorosilane, ethylmethyldichlorosilane, diisopropyldichlorosilane, isopropylmethyldichlorosilane, n-hexylmethyldichlorosilane, di-n-hexyldichlorosilane, dicyclohexyldichlorosilane, cyclohexylmethyldichlorosilane, docosylmethyldichlorosilane, vinylmethyldichlorosilane, divinyldichlorosilane, bis(phenethyl)dichlorosilane, methylphenethyldichlorosilane, diphenyldichlorosilane, dimesityldichlorosilane and ditolyldichlorosilane; trichlorosilanes such as methyltrichlorosilane, ethyltrichlorosilane, isopropyltrichlorosilane, t-butyltrichlorosilane, phenyltrichlorosilane and phenethyltrichlorosilane; halosilanes obtained by substituting the part of chlorine in the compounds described above with other halogens; alkoxysilanes such as dimethyldimethoxysilane, dimethyldiethoxysilane, diethyldimethoxysilane and diethyldiethoxysilane; and nitrogen-containing compounds such as dimethyldimethylaminosilane, bis(dimethylamino)methylsilane, bis(dimethylamino)dimethylsilane, 1-trimethylsilyl-1,2,4-triazole, 1-trimethylsilylimidazole, hexamethyldisilazane, 1,1,3,3,5,5-hexamethylcyclotrisilazane and 1,1,3,3,5,5,7,7-octamethylcyclotrisilazane.

In the above first aspect of the invention, among the organic silane compounds represented by Formula (1′), particularly preferred is an organic silane compound represented by Formula (1a)

R²R³SiX₂ (1a)

(wherein R² and R³ represent an alkyl group having 2 to 12 carbon atoms, and X is the same as described above) . The compound in which R² and R³ are linear or cyclic alkyl groups include, to be specific, dimethyldichlorosilane, dimethyldimethoxysilane, dimethyldiethoxysilane, diethyldichlorosilane, diethyldimethoxysilane, diethyldiethoxysilane, ethylmethyldichlorosilane, isopropylmethyldichlorosilane, cyclohexylmethyldichlorosilane, dicyclohexyldichlorosilane, n-hexylmethyldichlorosilane and di-n-hexyldichlorosilane. The compound in which R² and R³ are alkenyl groups include vinyldichlorosilane and divinyldichlorosilane. Among them, the organic silane compounds in which an alkyl group has total 2 to 4 carbon atoms are more preferred.

The silane-treated product used in the above first aspect of the invention can be obtained by dispersing the clay, the clay mineral or the ion-exchangeable layered compound each described above in water and bringing it into contact with a silane compound. In this case, preferably 0.5 to 50 g, more preferably 5 to 20 g of the clay, the clay mineral or the ion-exchangeable layered compound is added to one liter of water. An addition amount of the silane compound is preferably 0.01 to 1.0 g, more preferably 0.1 to 0.5 g per 1 g of the clay, the clay mineral or the ion-exchangeable layered compound. The treating temperature is usually a room temperature to 100° C. When the treating temperature is a room temperature or higher and lower than 60° C., the treating time is 12 to 48 hours, preferably 8 to 24 hours, and when the treating temperature is 60 to 100° C., the treating time is 1 to 12 hours, preferably 2 to 4 hours.

After finishing contact treatment with the silane compound, the reaction aqueous solution is subjected to pressure filtration during heating, whereby the intended silane-treated product can be obtained. In this after-treatment, the filtering rate controls the workability to a large extent. For example, when a membrane filter having a membrane pore diameter of 3 μm, filtration is finished in 5 minutes to 42 hours. Time required for filtration is varied to a large extent according to the suspension status of the silane-treated product, and the filtering time can be shortened by increasing an addition proportion of the silane compound, raising the treating temperature or extending the treating time.

Treating water remains in the silane-treated product thus obtained. If this water is completely removed by heating treatment or vacuum treatment, reduced is the dispersing property of the silane-treated product into a polymerization solvent, that is, the dispersing property of the silane-treated product into the polymer composition. Accordingly, it is unsuitable to completely remove water in the silane-treated product by the methods described above. A trace amount of remaining water can be removed by a method for removing by reaction with an organic aluminum compound. The organic aluminum compound used is preferably inexpensive triisobutylaluminum, triethylaluminum or an aluminumoxy compound represented by the following Formula (2):

R⁴R⁵Al(OAlR⁶)ₙR⁷ (2)

(wherein R⁴, R⁵, R⁶ and R⁷ represent an alkyl group having 1 to 10 carbon atoms, and at least one of them is an alkyl group having 2 to 10 carbon atoms; and m is an integer of 1 to 3). The same ones as described above can be given as the alkyl group. When expensive trimethylaluminum is used, required is such delicate control as taking care of deactivation brought about by the reduction (a change in a valence of metal) of the metal complex which is a principal catalyst described later.

In respect to the treating conditions, the conditions of 100° C. and about one hour are required in order to react water that is present between the layers of the clay, the clay mineral or the ion-exchangeable layered compound with the organic aluminum compound for short time. Even if they are reacted at 100° C. for exceeding one hour, an efficiency of removing the moisture does not necessarily grow high. Lowering the treating temperature requires a large extent of extension of the treating time. A use amount of the organic aluminum compound is controlled by an amount of water remaining between the layers described above.

The complex of a transition metal of Group 4 to Group 6 in the Periodic Table used in the above first aspect of the invention is called usually a principal catalyst and includes, to be specific, metallocene complexes. The metallocene complexes include publicly known ones. They include, for example, transition metal complexes having at least one of a cyclopentadienyl group, a substituted cyclopentadienyl group, an indenyl group and a substituted indenyl group as a ligand and transition metal complexes in which the above ligands are geometrically controlled, which are described in Japanese Patent Application Laid-Open No. 19309/1983, Japanese Patent Application Laid-Open No. 130314/1986, Japanese Patent Application Laid-Open No. 163088/1991, Japanese Patent Application Laid-Open No. 300887/1992, Japanese Patent Application Laid-Open No. 211694/1992 and Japanese Patent Application Laid-Open (through PCT) No. 502036/1999. The transition metals contained in these transition metal complexes include zirconium, titanium and hafnium.

The specific metallocene complexes include cyclopentadienylzirconium trichloride, pentamethylcyclopentadienylzirconium trichloride, bis(cyclopentadienyl)zirconium dichloride, bis(pentamethylcyclopentadienyl)zirconium dichloride, bis(cyclopentadienyl)zirconium dialkyl, indenylzirconium trichloride, bis(indenyl)zirconium dichloride, dimethylsilylene-bis(indenyl)zirconium dichloride, (dimethylsilylene)(dimethylsilylene)-bis(indenyl)zirconium dichloride, (dimethylsilylene)-bis(2-methyl-4-phenylindenyl)zirconium dichloride, (dimethylsilylene)-bis(benzoindenyl)zirconium dichloride, (dimethylsilylene)-bis(2-methyl-4,5-benzoindenyl)zirconium dichloride, ethylene-bis(indenyl)zirconium dichloride, (ethylene)(ethylene)-bis(indenyl)zirconium dichloride, (ethylene)(ethylene)-bis(3-methylindenyl)zirconium dichloride, (ethylene)(ethylene)-bis(4,7-dimethylindenyl)zirconium dichloride, (t-butylamide) (tetramethyl-η⁵-cyclopentadienyl)-1,2-ethanediylzirconium dichloride, (t-butylamide) -dimethyl (tetramethyl-η⁵-cyclopentadienyl)-silanezirconium dichloride and (methylamide)(tetramethyl-η⁵-cyclopentadienyl)-1,2-ethanediylzirconium dichloride, and those obtained by substituting zirconium in these complexes with hafnium or titanium.

Further, examples of the transition metal complex include a metal complex containing a ligand having a hetero atom, represented by the following Formula (3) or (4):

L¹L²MX¹ₚY¹_{q} (3)

L¹L²L³MX¹ₚY¹_{q} (4)

In Formulas (3) and (4) described above, M represents a transition metal of Group 4 to Group 6 in the Periodic Table, and to be specific, represents titanium, zirconium, hafnium, vanadium and chromium. Among these, titanium and zirconium are preferable.

L¹ to L³ each represent independently a ligand which can be bonded to transition metal via a hetero atom, and L¹ and L² or L¹ and L³ may be combined with each other to form a ring. Preferably, the ligand is bonded to transition metal via a heteroatom. More preferably, L¹ and L² or L¹ and L³ are combined with each other. The heteroatom includes a nitrogen atom, an oxygen atom and a sulfur atom other than a carbon atom. Among them, an oxygen atom and a nitrogen atom are preferred. The nitrogen atom preferably forms carbon-nitrogen unsaturated bonds. Among them, a (C═N—) structural unit is more preferred. X¹ and Y¹ each represent independently a covalent or ion-bonding ligand. To be specific, they represent a hydrogen atom, a halogen atom, a hydrocarbon group having 1 to 20 (preferably 1 to 10) carbon atoms, an alkoxy group having 1 to 20 (preferably 1 to 10) carbon atoms, an amino group, a phosphorus-containing hydrocarbon group (for example, a diphenylphosphine group) having 1 to 20 (preferably 1 to 12) carbon atoms, a silicon-containing hydrocarbon group having 1 to 20 (preferably 1 to 12) carbon atoms or a halogen-containing boron anion (for example, ⁻BF₄) Among them, a halogen atom and a hydrocarbon group having 1 to 20 carbon atoms are preferred. These X¹ and Y¹ may be the same as or different from each other. p and q each represent independently 0 or a positive integer, and the sum of p and q is 0, 1, 2 or 3 according to an atomic value of M.

The transition metal complex represented by Formula (3) or (4) is preferably a complex of a transition metal of Group 4 to Group 6 in the Periodic Table having a phenoxyimino group and a diamido group.

A use amount of the complex of a transition metal of Group 4 to Group 6 in the Periodic Table is preferably 0.01 to 100 micromole, further preferably 0.1 to 100 micromole and more preferably 1 to 50 micromole per 1 g of the silane-treated product.

In the above first aspect of the invention, in producing the olefin-based resin composition, olefin and/or diene are preferably polymerized using the catalyst prepared by bringing the silane-treated product into contact with the organic aluminum compound and then bringing it into contact with the transition metal complex. In the case described above, the contact order of the silane-treated product, the transition metal complex, the organic aluminum compound and the monomer shall not specifically matter. The organic aluminum compound is preferably triethylaluminum, triisobutylaluminum or the aluminumoxy compound represented by the following Formula (2):

R⁴R⁵Al (OAlR⁶)₂R⁷ (2)

(wherein R⁴, R⁵, R⁶ and R⁷ represent an alkyl group having 1 to 10 carbon atoms, and at least one of them is an alkyl group having 2 to 10 carbon atoms; and m is an integer of 1 to 3). The same ones as described above can be given as the alkyl group.

The olefin used in the above first aspect of the invention is preferably ethylene and α-olefins having 3 to 20 carbon atoms. This α-olefin includes, for example, α-olefins such as propylene, 1-butene, 1-pentene, 1-hexene, 1-heptene, 1-octene, 1-nonene, 1-decene, 4-phenyl-1-butene, 6-phenyl-1-hexene, 3-methyl-1-butene, 4-methyl-1-butene, 3-methyl-1-pentene, 4-methyl-1-hexene, 5-methyl-1-hexene, 3,3-dimethyl-1-pentene, 3,4-dimethyl-1-pentene, 4,4-dimethyl-1-pentene and vinylcyclohexane; halogen-substituted α-olefins such as hexafluoropropene, tetrafluoroethylene, 2-fluoropropene, fluoroethylene, 1,1-difluoroethylene, 3-fluoropropene, trifluoroethylene and 3,4-dichloro-1-butene; and cyclic olefin such as cyclopentene, cyclohexene, norbornene, 5-methylnorbornene, 5-ethylnorbornene, 5-propylnorbornene, 5,6-dimethylnorbornene and 5-benzylnorbornene.

The diene used in the above first aspect of the invention includes linear dienes such as butadiene, isoprene, 1,4-pentadiene and 1,5-hexadiene; and cyclic dienes such as norbornadiene, 5-ethylidenenorbornene, 5-vinylnorbornene and dicyclopentadiene.

The polyolefin-based composite resin of the above first aspect of the invention is preferably a resin obtained by polymerizing at least one monomer selected from 1-olefins having 2 to 4 carbon atoms and dienes.

A content of the polyolefin resin contained in the polyolefin-based composite resin of the above first aspect of the invention is 20 to 99.3% by weight, and in the case of uses other than use for a master batch, a content of the polyolefin resin is preferably 70 to 99.3% by weight, more preferably 60 to 98% by weight and further preferably 90 to 98% by weight in terms of the physical properties of the composite resin and the dispersing property of the silane-treated product.

In the above first aspect of the invention, the polymerization is preferably carried out in a range of a room temperature to 150° C. When the polymerization temperature exceeds 150° C., the silane-treated product is likely to be deteriorated in dispersing property. When a titanium complex is used as the transition metal complex, it is preferred to treat the silane-treated product with the organic silane compound of an amount which can remove water remaining very slightly in the silane-treated product or a surface hydroxyl group originally held by the silane-treated product and then prepare a polymerization catalyst comprising the silane-treated product and the transition metal complex to polymerize olefin and/or diene. In the polymerizing step, it is preferred in terms of uniformly dispersing the silane-treated product in the polyolefin-based resin to satisfy any condition of (i) suppressing a rise in the internal temperature caused by heat generation in a polymerizing reactor to 15° C. or lower (preferably 10° C. or lower) and (ii) subjecting the polymerization catalyst in advance to prepolymerizing treatment with olefin. When (i) or (ii) described above is not satisfied, a lot of the particles of the silane-treated product which does not participate in the polymerization reaction is present in the resulting polymer, and it is a polymer composition in which the silane-treated product is present merely in a mixture and is likely not to be a composite resin.

The composite resin composition of the above first aspect of the invention containing 0.2 to 20% by weight of the silane-treated product is prepared by using the polyolefin-based composite resin of the above first aspect of the invention as a master batch and diluting it with a thermoplastic resin. In this case, used is the polyolefin-based composite resin containing 80 to 0.7% by weight, preferably 40 to 2% by weight of the silane-treated product. The thermoplastic resin includes polyolefin-based resins such as polypropylene and polyethylene, polystyrene resins, polycarbonate resins, polyacetal resins, polyester resins and polyamides.

The polyolefin-based composite resin used for the antioxidant-blended polyolefin-based composite resin of the above first aspect of the invention blended with a phenol-based antioxidant contains 20 to 99.3% by weight, preferably 70 to 99% by weight of the polyolefin resin. The phenol-based antioxidant includes 2,6-di-tert-butyl-p-cresol, 2,6-di-tert-butyl-p-phenol, 2,4-dimethyl-6-di-tert-butyl-cresol, butylhydroxyanisole, 2,2′-methylenebis(4-methyl-6-tert-butylphenol), 4,4′-butylidenebis(3-methyl-6-tert-butylphenol), 4,4′-thiobis(3-methyl-6-tert-butylphenol), tetrakis[methylene-3-(3,5-di-tert-butyl-4-hydroxyphenyl)propionate]methane and 1,1,3-tris(2-methyl-4-hydroxy-5-tert-butylphenyl)butane. A blending amount of the phenol-based antioxidant is preferably 0.001 to 5 parts by weight, more preferably 0.01 to 1 part by weight per 100 parts by weight of the polyolefin-based composite resin.

The composite resin composition of the above first aspect of the invention containing 0.2 to 20% by weight of the silane-treated product may be blended with the phenol-based antioxidant. In this case, a blending amount of the phenol-based antioxidant is preferably 0.001 to 10 parts by weight, more preferably 0.01 to 5 parts by weight per 100 parts by weight of the above composition.

Next, the second aspect of the invention shall be explained.

In the polyolefin-based composite resin of this second aspect of the invention, clay, clay mineral or an ion-exchangeable layered compound which is a layered compound as one component of the polymerization catalyst is used as a promoter. The clay, the clay mineral or the ion-exchangeable layered compound described above is the same as explained in the first aspect of the invention described above.

The foregoing layered compound used in the above second aspect of the invention is treated preferably with an organic silane compound. An organic silane compound having carbon in an element bonded directly to silicon can be used as this organic silane compound. The organic silane compound represented by Formula (1) can preferably be given as such organic silane compound. The organic silane compound represented by Formula (1′) is more preferred.

The treating methods of the above organic silane compound and layered compound are the same as explained in the first aspect of the invention described above.

The transition metal complex used in the above second aspect of the invention is called usually a principal catalyst and includes a metallocene complex of Group 4 to Group 6 in the Periodic Table and a chelate complex of a transition metal of Group 4 to Group 10 in the Periodic Table. In the above second aspect of the invention, the metallocene complex of Group 4 to Group 6 in the Periodic Table is preferred. The metallocene complex includes various publicly known ones shown in the first aspect of the invention described above.

Specific examples of metallocene complex include compounds shown as the examples in the first aspect of the invention described above.

Further, specific examples of the chelate complex of transition metal include a metal complex containing a ligand having a hetero atom, represented by the following Formula (3′) or (4′):

L¹L²M′X¹ₚY¹_{q} (3′)

L¹L²L³M′X¹ₚY¹_{q} (4′)

In Formulas (3′) and (4′) described above, M′ represents a transition metal of Group 4 to Group 6 in the Periodic Table, and to be specific, titanium, zirconium, hafnium, vanadium, chromium, manganese, iron and nickel can be given. Among them, iron and nickel are preferred. L¹ to L³, X¹ and Y¹ are the same as in Formulas (3) and (4) described above. p and q each represent independently 0 or a positive integer, and the sum of p and q is 0, 1, 2 or 3 according to an atomic value of M′.

The transition metal chelate complex represented by (3′) described above shall not specifically be restricted, and the chelate complex having an oxygen-nitrogen bond and a carbon-nitrogen bond is preferred. The chelate complex having a carbon-nitrogen bond is preferably a complex having a diamine structure represented by the following Formula (5):

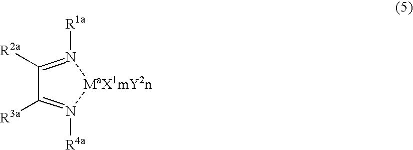

(wherein M^{a} represents transition metal of a Group 8 to Group 10 in the Periodic Table; R^{1a} and R^{4a} each represent independently an aliphatic hydrocarbon group having 1 to 20 carbon atoms or an aromatic group having a phenyl group or a hydrocarbon group on a ring having total 7 to 20 carbon atoms; R^{2a} and R^{3a} each represent independently a hydrogen atom or a hydrocarbon group having 1 to 20 carbon atoms, and R^{2a} and R^{3a} may be combined with each other to form a ring; X¹ and Y¹ each represent independently a covalent or ion-bonding group and may be the same as or different from each other; m and n represent 0 or a positive integer, and the sum of m and n is 0, 1, 2 or 3 according to an atomic value of M^{a}).

In Formula (5) described above, M^{a} is particularly preferably nickel. X¹ and Y¹ are preferably a halogen atom (preferably a chlorine atom) or a hydrocarbon group (preferably methyl) having 1 to 20 carbon atoms. The aliphatic hydrocarbon group having 1 to 20 carbon atoms in R^{1a} and R^{4a} includes a linear or branched alkyl group having 1 to 20 carbon atoms or a cycloalkyl group having 3 to 20 carbon atoms, to be specific, methyl, ethyl, n-propyl, isopropyl, n-butyl, isobutyl, sec-butyl, t-butyl, pentyl, hexyl, octyl, decyl, tetradecyl, hexadecyl, octadecyl, cyclopentyl, cyclohexyl and cyclooctyl. A suitable substituent such as a lower alkyl group may be introduced onto a ring of the cycloalkyl group. The aromatic group having a hydrocarbon group on a ring having total 7 to 20 carbon atoms includes, for example, a group in which at least one linear, branched or cyclic alkyl group having 1 to 10 carbon atoms is introduced onto an aromatic ring such as phenyl and naphthyl. These R^{1a} and R^{4a} are preferably an aromatic group having a hydrocarbon group on a ring and particularly suitably 2,6-diisopropylphenyl. R^{1a} and R^{4a} may be the same as or different from each other.

The hydrocarbon group having 1 to 20 carbon atoms in R^{2a} and R^{3a} includes, for example, a linear or branched alkyl group having 1 to 20 carbon atoms or a cycloalkyl group having 3 to 20 carbon atoms, an aryl group having 6 to 20 carbon atoms and an arylalkyl group having 7 to 20 carbon atoms. In this case, the linear or branched alkyl group having 1 to 20 carbon atoms or the cycloalkyl group having 3 to 20 carbon atoms includes the same ones as described above. The aryl group having 6 to 20 carbon atoms includes, for example, phenyl, tolyl, xylyl, naphthyl and methylnaphthyl, and the arylalkyl group having 7 to 20 carbon atoms includes, for example, benzyl and phenethyl. R^{2a} and R^{3a} may be the same as or different from each other. Further, they may be combined with each other to form a ring.

The examples of the complex compound represented by Formula (5) described above includes compounds represented by the following Formulas [1], [2], [3], [4], [5], [6], [7], [8], [9], [10], [11] and [12]:

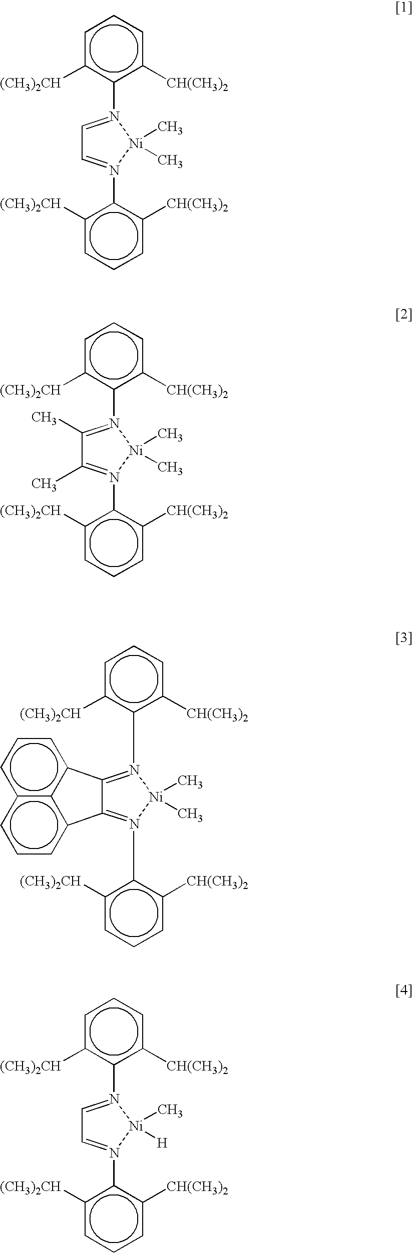

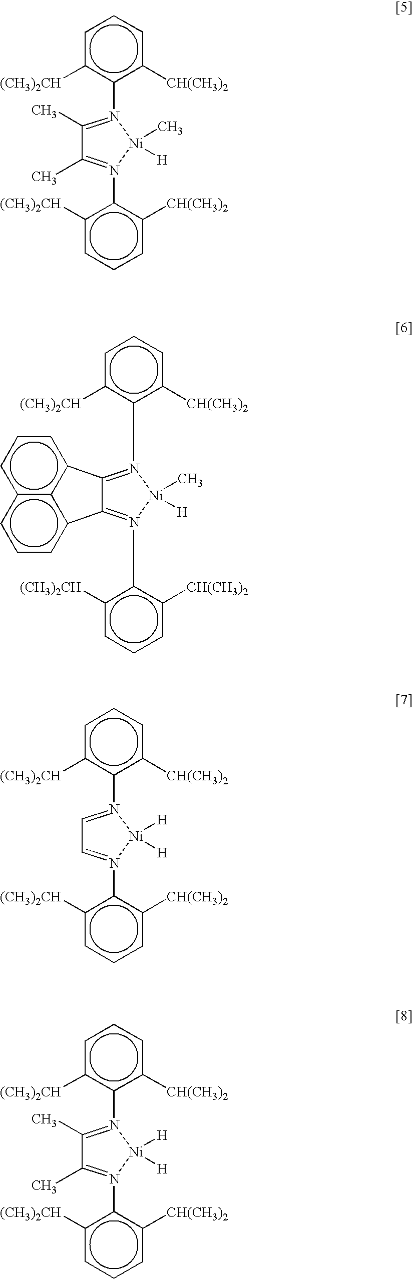

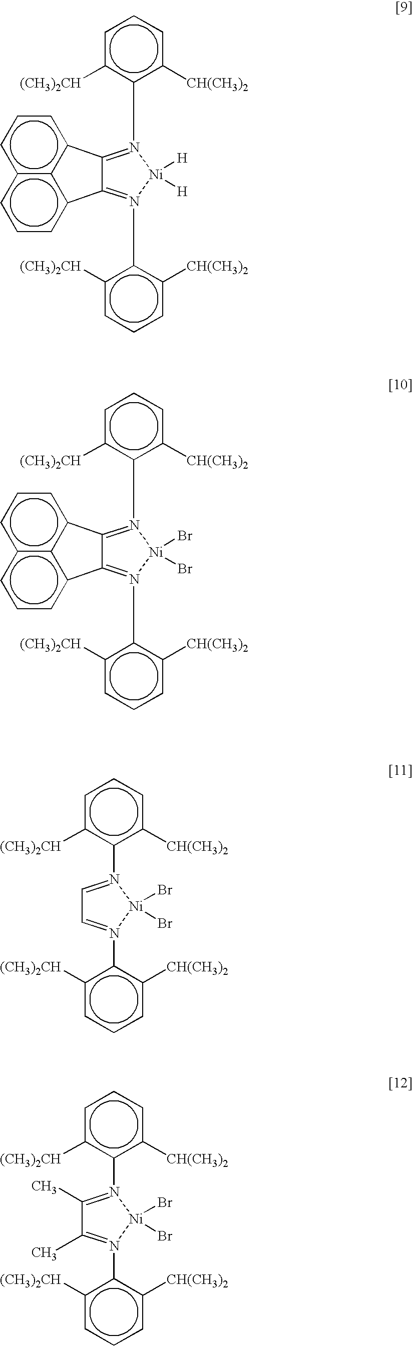

The chelate complex of transition metal represented by Formula (4′) described above is more preferably a chelate complex of iron containing a nitrogen atom, a chelate complex of cobalt or a chelate complex of nickel. Such complexes include transition metal complexes described in J. Am. Chem. Soc., 1998, 120, 4049-4050, Chem. Commun. 1998, 849-850, International Patent Application Laid-Open No. 98-27124, International Patent Application Laid-Open No. 99-02472 and International Patent Application Laid-Open No. 99-12981. For example, a complex represented by the following Formula (6) is indicated:

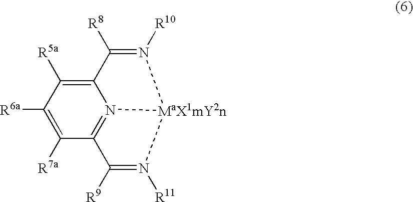

(wherein M^{a} represents a transition metal of a Group 8 to Group 10 in the Periodic Table; R^{5a} to R^{7a}, R⁸ and R⁹ each represent independently a hydrogen atom or a hydrocarbon group having 1 to 20 carbon atoms, and they may be combined with each other to form a ring; R¹⁰ and R¹¹ each represent independently an aliphatic hydrocarbon group having 1 to 20 carbon atoms or an aromatic group having a hydrocarbon group on a ring having total 7 to 20 carbon atoms; X¹ and Y¹ each represent independently a covalent or ion-bonding group and may be the same as or different from each other; m and n represent 0 or a positive integer, and the sum of m and n is 0, 1, 2 or 3 according to an atomic value of M^{a}).

In Formula (6) described above, the hydrocarbon group having 1 to 20 carbon atoms in R^{5a} to R^{7a} , R⁸ and R⁹ may be, for example, a linear or branched alkyl group having 1 to 20 carbon atoms, a cycloalkyl group having 3 to 20 carbon atoms, an aryl group having 6 to 20 carbon atoms and an arylalkyl group having 7 to 20 carbon atoms. To be specific, the linear or branched alkyl group having 1 to 20 carbon atoms described above may be methyl, ethyl, n-propyl, isopropyl, n-butyl, isobutyl, sec-butyl, t-butyl, various pentyls, various hexyls, various octyls, various decyls, various tetradecyls, various hexadecyls and various octadecyls. The cycloalkyl group having 3 to 20 carbon atoms described above may be, to be specific, cyclopentyl, cyclohexyl and cyclooctyl. A suitable substituent such as a lower alkyl group may be introduced onto the ring of the cycloalkyl group. Also, the aryl group having 6 to 20 carbon atoms may be, to be specific, phenyl, tolyl, xylyl, naphthyl and methylnaphthyl. To be specific, benzyl and phenethyl can be nominated as the arylalkyl group having 7 to 20 carbon atoms.

In Formula (6) described above, the aliphatic hydrocarbon group having 1 to 20 carbon atoms in R¹⁰ and R¹¹ includes the same ones as in the linear or branched alkyl group having 1 to 20 carbon atoms and the cycloalkyl group having 3 to 20 carbon atoms described above in R^{5a} to R^{7a}, R⁸ and R⁹. Further, the aromatic hydrocarbon group having a hydrocarbon group on a ring having total 7 to 20 carbon atoms includes, for example, a group in which at lest one linear, branched or cyclic alkyl group having 1 to 10 carbon atoms is introduced onto an aromatic ring such as phenyl and naphthyl. These R¹⁰ and R¹¹ are preferably an aromatic ring having a hydrocarbon group on a ring and are particularly suitably 2-methylphenyl and 2,4-dimethylphenyl.

M^{a}, X¹ and Y¹ in Formula (6) described above include the same ones as described above. M^{a} is preferably iron, cobalt or nickel. X¹ and Y¹ are preferably a halogen atom (preferably a chlorine atom) and a hydrocarbon group (preferably methyl) having 1 to 20 carbon atoms. m and n are the same as explained above.

The chelate complex of transition metal represented by Formula (6) described above includes, being specific, iron or cobalt complexes having a 2,6-diacetylpyridinebisimine compound, a 2,6-diformylpyridinebisimine compound and a 2,6-dibenzoylpyridinebisimine compound as a ligand. Among them, an iron complex having a 2,6-diacetylpyridinebisimine as a ligand is particularly preferred, and such complex includes a chelate complex of metal represented by the following Formula (7):

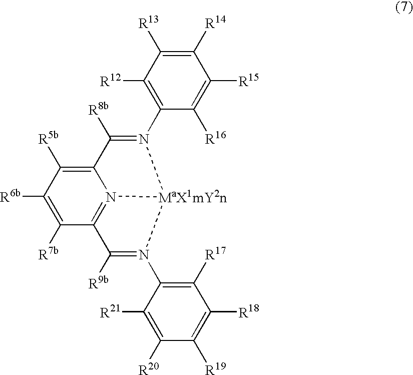

(wherein M^{a} represents a transition metal of Group 8 to Group 10 in the Periodic Table; R^{5b} to R^{9b} and R¹² to R²¹ each represent independently a hydrogen atom, a halogen atom, a hydrocarbon group, a substituted hydrocarbon group or a hydrocarbon group containing a hetero atom; any two close groups of R¹² to R²¹ may be combined with each other to form a ring; X¹ and Y¹ each represent independently a covalent or ion-bonding group and may be the same as or different from each other; m and n represent 0 or a positive integer, and the sum of m and n is 0, 1, 2 or 3 according to an atomic value of M^{a}).

Among R^{5b} to R^{9b} and R¹² to R²¹, the halogen atom includes a fluorine atom, a chlorine atom, a bromine atom and an iodine atom. The hydrocarbon group includes hydrocarbons group having 1 to 30 carbon atoms. To be specific, it includes a linear hydrocarbon group having 1 to 30 carbon atoms such as methyl, ethyl and n-propyl, a branched hydrocarbon group having 3 to 30 carbon atoms such as isopropyl, sec-butyl and t-butyl, a cyclic aliphatic hydrocarbon group having 3 to 30 carbon atoms such as cyclopentyl and cyclohexyl and an aromatic hydrocarbon group having 6 to 30 carbon atoms such as phenyl and naphthyl. The substituted hydrocarbon group is a group obtained by substituting at least one hydrogen atom in the hydrocarbon group described above with a substituent and includes, for example, a substituted hydrocarbon group having 1 to 30 carbon atoms. The substituent includes a hydrocarbon group, a halogen atom and a hetero atom-containing hydrocarbon group. The hydrocarbon group as the substituent includes the hydrocarbon groups described above. The heteroatom includes nitrogen, oxygen and sulfur. The substituted hydrocarbon group may contain a hetero aromatic ring. The hetero atom-containing hydrocarbon group includes various alkoxy groups, various amino groups and various silyl group.

R¹² may be a group comprising primary carbon, a group comprising secondary carbon and a group comprising tertiary carbon. When R¹² is a group comprising primary carbon, 0 to two of R¹⁶, R¹⁷ and R²¹ are a group comprising primary carbon, and the remainder may be a hydrogen atom. When R¹² is a group comprising secondary carbon, 0 to one of R¹⁶, R¹⁷ and R²⁰ are a group comprising primary carbon or a group comprising secondary carbon, and the remainder may be a hydrogen atom. When R¹² is a group comprising tertiary carbon, R¹⁶, R¹⁷ and R²¹ may be a hydrogen atom. The following case is preferred.

R¹² represents a group comprising primary carbon, a group comprising secondary carbon or a group comprising tertiary carbon, and when R¹² is a group comprising primary carbon, 0 to two of R¹⁶, R¹⁷ and R²¹ are a group comprising primary carbon, and the remainder is a hydrogen atom. When R¹² is a group comprising secondary carbon, 0 to one of R¹⁶, R¹⁷ and R²¹ are a group comprising primary carbon or a group comprising secondary carbon, and the remainder is a hydrogen atom. When R¹² is a group comprising tertiary carbon, R¹⁶, R¹⁷ and R²¹ are a hydrogen atom. Any two close groups of R¹² to R²¹ may be combined with each other to form a ring.

M^{a}, X¹ and Y¹ in Formula (7) described above include the same ones as described above. M^{a} is preferably iron, cobalt or nickel and particularly preferably iron. X¹ and Y¹ are preferably a halogen atom (preferably a chlorine atom) and a hydrocarbon group (preferably methyl or a silicon-containing hydrocarbon group) having 1 to 20 carbon atoms. m and n are the same as explained above.

Preferred combination in Formula (7) described above includes the following examples; R^{8b} and R^{9b} are methyl or a hydrogen atom; and/or all of R^{5b}, R^{6b} and R^{7b} are a hydrogen atom; and/or all of R¹³, R¹⁴, R¹⁵, R¹⁶, R¹⁷, R¹⁸, R¹⁹ and R²⁰ are a hydrogen atom; R¹² and R²¹ each are independently methyl, ethyl, propyl or isopropyl, and both are more preferably methyl or ethyl; and/or X¹ and Y¹ are a monovalent anion, more preferably a monovalent anion selected from groups comprising halogen and hydrocarbon.

Further, the following combinations are preferred as well. That is, when R¹² is a group comprising primary carbon, R¹⁶ is a group comprising primary carbon, and R¹⁷ and R¹¹ are a hydrogen atom. When R¹² is a group comprising secondary carbon, R¹⁶ is a group comprising primary carbon or a group comprising secondary carbon, more preferably a group comprising secondary carbon. When R¹² is a group comprising tertiary carbon, R¹⁶, R¹⁷ and R²¹ are a hydrogen atom.

The particularly preferred combination in Formula (7) described above includes the following examples:

R^{8b} and R^{9b} are methyl; all of R^{5b}, R^{6b}, R^{7b}, R¹³, R¹⁴, R¹⁵, R¹⁶, R¹⁷, R¹⁸, R¹⁹ and R²⁰ are hydrogen atoms; and both of R¹² and R²¹ are methyl.

R^{8b} and R^{9b} are methyl; all of R^{5b}, R^{6b}, R^{7b}, R¹³, R¹⁴, R¹⁵, R¹⁶, R¹⁷, R¹⁸, R¹⁹ and R²⁰ are hydrogen atoms; and both of R¹² and R²¹ are ethyl.

R^{8b} and R^{9b} are methyl; all of R^{5b}, R^{6b}, R^{7b}, R¹³, R¹⁴, R¹⁵, R¹⁶, R¹⁷, R¹⁸, R¹⁹ and R²⁰ are hydrogen atoms; and both of R¹² and R²¹ are isopropyl.

R^{8b} and R^{9b} are methyl; all of R^{5b}, R^{6b} , R^{7b}, R¹³, R¹⁴, R¹⁵, R¹⁶, R¹⁷, R¹⁸, R¹⁹ and R²⁰ are hydrogen atoms; and both of R¹² and R²¹ are n-propyl.

R^{8b} and R^{9b} are methyl; all of R^{5b}, R^{6b}, R^{7b}, R¹³, R¹⁴, R¹⁵, R¹⁶, R¹⁷, R¹⁸, R¹⁹ and R²⁰ are hydrogen atoms; and all of R¹², R¹⁴, R¹⁹ and R²¹ are methyl.

R^{8b} and R^{9b} are methyl; all of R^{5b}, R^{6b}, R^{7b}, R¹³, R¹⁴, R¹⁵, R¹⁶, R¹⁷, R¹⁸, R¹⁹ and R²⁰ are hydrogen atoms; and both of R¹² and R²¹ are chlorine atoms.

R^{8b} and R^{9b} are methyl; all of R^{5b}, R^{6b}, R^{7b}, R¹³, R¹⁴, R¹⁵, R¹⁶, R¹⁷, R¹⁸, R¹⁹ and R²⁰ are hydrogen atoms; and both of R¹² and R²¹ are trifluoromethyl.

In this case, both of X¹ and Y¹ are preferably selected from chlorine, bromine and a nitrile compound and particularly preferably chlorine.

One example of a production process for the chelate complex of transition metal represented by Formula (7) described above includes a process in which a ketone compound represented by Formula (8) shown below is reacted with an amine compound represented by H₂NR²² and H₂NR²³:

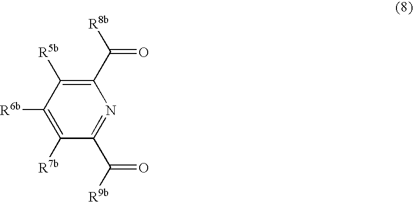

In this case, R²² is phenyl modified with the substituents R¹² to R¹⁶ in Formula (7), and R²³ is phenyl modified with the substituents R¹⁷ to R⁷. When carrying out the reaction, an organic acid such as formic acid may be used as a catalyst. Further, included is a process in which the compound obtained by the process described above is reacted with a halide (for example, metal halide and the like) of the transition metal M^{a}.

A use amount of the transition metal complex described above is preferably 0.01 to 100 micromole, further preferably 0.1 to 100 micromole and more preferably 1 to 50 micromole per 1 g of the clay, the clay mineral or the ion-exchangeable layered compound.

In the above second aspect of the invention, the catalyst prepared by bringing the clay, the clay mineral or the ion-exchangeable layered compound into contact with the organic aluminum compound and then bringing it into contact with the transition metal complex is preferably used in producing the olefin-based resin composition to polymerize olefin and/or diene. In the case described above, the contact order of the clay, the clay mineral or the ion-exchangeable layered compound, the transition metal complex, the organic aluminum compound and the monomer shall not specifically matter.

The organic aluminum compound described above is preferably triethylaluminum, triisobutylaluminum or the aluminumoxy compound represented by Formula (2) described above. This aluminumoxy compound represented by Formula (2) is the same as explained in the first aspect of the invention described above.

In the above second aspect of the invention, capable of being used as the olefin are various α-olefins, halogen-substituted α-olefins, cyclic olefins, linear dienes and cyclic dienes which were given as the examples in the first aspect of the invention described above, and styrenes can be used as well.

The styrenes described above include styrene, alkylstyrenes such as p-methylstyrene, p-ethylstyrene, p-propylstyrene, p-isopropylstyrene, p-butylstyrene, p-t-butylstyrene, p-phenylstyrene, o-methylstyrene, o-ethylstyrene, o-propylstyrene, o-isopropylstyrene, m-methylstyrene, m-ethylstyrene, m-isopropylstyrene, m-butylstyrene, mesitylstyrene, 2,4-dimethylstyrene, 2,5-dimethylstyrene and 3,5-dimethylstyrene; alkoxystyrenes such as p-methoxystyrene, o-methoxystyrene and m-methoxystyrene; halogenated styrenes such as p-chlorostyrene, m-chlorostyrene, o-chlorostyrene, p-bromostyrene, m-bromostyrene, o-bromostyrene, p-fluorostyrene, m-fluorostyrene, o-fluorostyrene and o-methyl-p-fluorostyrene; trimethylsilylstyrene, vinyl benzoate and divinylbenzene.

The diene used in the above second aspect of the invention includes linear dienes such as butadiene, isoprene, 1,4-pentadiene and 1,5-hexadiene; and cyclic dienes such as norbornadiene, 5-ethylidenenorbornene, 5-vinylnorbornene and dicyclopentadiene.

The olefin-based resin composition used in the above second aspect of the invention is preferably obtained by polymerizing a monomer selected from ethylene, propylene, styrene and diene, particularly preferably obtained by polymerizing propylene.

In the olefin-based resin composition according to the above second aspect of the invention, it is preferred that the polyolefin resin has a content of 70 to 99.5% by weight and that the layered compound has a content of 0.5 to 30% by weight, and it is more preferred that the polyolefin resin has a content of 90 to 99% by weight and that the layered compound has a content of 10 to 1% by weight.

When using the silane-treated product obtained by treating the layered compound with the organic silane compound, the polymerization is preferably carried out in a range of a room temperature to 150° C. When the polymerization temperature exceeds 150° C., the silane-treated product is likely to be deteriorated in dispersing property. When a titanium complex is used as the transition metal complex, it is preferred to treat the silane-treated product with the organic silane compound of an amount which can remove water remaining very slightly in the silane-treated product or a surface hydroxyl group originally held by the silane-treated product and then prepare a polymerization catalyst comprising the silane-treated product and the transition metal complex to polymerize olefin and/or diene.

The olefin-based composite resin of the above second aspect of the invention is prepared by adding a metal salt compound and/or a basic inorganic compound to the olefin-based resin composition described above. Adding these compounds raises the rigidity. The metal salt compound includes metal salts of aliphatic carboxylic acids such as palmitic acid, stearic acid and oleic acid; metal salts of aromatic carboxylic acids such as benzoic acid and naphthoic acid; metal alcolates and metal amides. The metal for the metal salt compound is preferably typical metal (1st to 3rd metal elements in the periodic table) such as sodium, potassium, lithium, magnesium, calcium and aluminum. The basic inorganic compound is preferably a compound having a carbonic acid ion or a basic hydroxyl group. The compound having a carbonic acid ion includes hydrotalcite and calcium carbonate, and the compound having a basic hydroxyl group includes aluminum hydroxide..

An addition amount of these compounds is preferably 0.01 to 5 parts by weight, more preferably 0.1 to 5 parts by weight per 100 parts by weight of the olefin-based resin composition described above. An optimum addition amount of these compounds is varied according to the properties and the content of the layered compound used for the polymerization. An addition amount of these compounds is preferably 1 to 100% by weight, more preferably 10 to 60% by weight based on a use amount of the layered compound.

These compounds can be blended with the olefin-based resin composition described above by adding them directly to a polymerization reaction slurry (liquid) in an after-step in a polymerization reacting apparatus or adding them before and/or after molding the olefin-based resin composition into pellets.

Next, the third aspect of the invention shall be explained.

In the production process for the high rigidity composite molded article of the third aspect of the invention, a layered compound as one component for a polymerizing catalyst is used as a promoter. Clay, a clay mineral or an ion-exchangeable layered compound can be nominated as this layered compound. The clay, the clay mineral or the ion-exchangeable layered compound described above is the same as explained in the first aspect of the invention described above.

The layered compound used in the above third aspect of the invention is preferably a silane-treated product obtained by treating with an organic silane compound. The above organic silane compound is preferably an organic silane compound having carbon in an element bonded directly to silicon and more preferably an organic silane compound represented by Formula (1)

R^{a}₄₋ₙSiXₙ (1)

(wherein R^{a} represents a group in which an element bonded directly to silicon is carbon, silicon or hydrogen, and at least one R^{a} is a group in which an element bonded directly to silicon is carbon; when a plurality of R^{a} is present, a plurality of R^{a} may be the same or different; X represents a halogen atom or a group in which an element bonded directly to silicon is nitrogen or oxygen, and when a plurality of X is present, a plurality of X may be the same or different; and n is an integer of 1 to 3). In Formula (1), the group in which an element bonded directly to silicon is carbon includes an alkyl group, an alkenyl group, an aryl group, an aralkyl group and a cyclic saturated hydrocarbon group. In the above third aspect of the invention, an alkyl group, an alkenyl group and a cyclic saturated hydrocarbon group are preferred. When it is an alkyl group, the alkyl group has preferably 2 to 12 carbon atoms.

The alkyl group includes methyl, ethyl, n-propyl, isopropyl, n-butyl, isobutyl, tert-butyl, n-hexyl and n-decyl. The alkenyl group includes vinyl, propenyl and cyclohexenyl, and in the above third aspect of the invention, the groups having 2 to 6 carbon atoms are preferred. The aryl group includes phenyl, tolyl, xylyl and naphthyl. The aralkyl group includes benzyl and phenethyl. The cyclic saturated hydrocarbon group includes cyclopentyl, cyclohexyl and cyclooctyl, and in the above third aspect of the invention, cyclopentyl and cyclohexyl are preferred.

The group in which an element bonded directly to silicon is silicon includes hexamethyldisilane, hexaphenyldisilane, 1,2-dimethyl-1,1,2,2-tetraphenyldisilane and dodecamethylcyclohexadisilane.

The group in which an element bonded directly to silicon is hydrogen includes ethyldichlorosilane, dimethylchlorosilane, trimethoxysilane, diethylsilane, dimethyldiethylaminosilane and allyldimethylsilane.

X is the same as explained in X of the organic silane compound represented by Formula (1′) described above. The same ones as shown as the specific examples of the organic silane compound represented by Formula (1) can be nominated as the specific examples of the organic silane compound represented by Formula (1). Among the organic silane compounds represented by Formula (1), the preferred organic silane compounds can be nominated by the organic silane compounds represented by Formula (1a) as is the case with the first aspect of the invention described above.

A treating method for the above layered compound in the above third aspect of the invention is the same as explained in the first aspect of the invention described above.

The transition metal complex used in the above third aspect of the invention is usually called a principal catalyst and includes a metallocene complex of a Group 4 to Group 6 in the Periodic Table and a chelate complex of transition metals of a Group 4 to Group 10 in the Periodic Table. In the above third aspect of the invention, the metallocene complex of the Group 4 to Group 6 in the Periodic Table is preferred. The metallocene complex includes various publicly known ones shown in the explanation of the first aspect of the invention described above.

The specific examples of the metallocene complex include the foregoing compounds described as the examples in the first aspect of the invention.

On the other hand, the chelate complex of transition metal is the same as explained in the second aspect of the invention described above.

In the above third aspect of the invention, those preferred among these transition metal complexes include indenyl-based complexes having a polymerizing ability with propylene and cross-linking half metallocene (including a constrained geometrical type ligand complex) having a good copolymerizing ability.

The specific examples thereof include dimethylsilylenebis(2-methyl-4,5-benzoindenyl)-zirconium dichloride, dimethylsilylenebis(2-methyl-4-phenylindenyl)zirconium dichloride, dimethylsilylenebis(2-methyl-4-naphthylinderyl)-zirconium dichloride, (1,2-dimethylsilylene)(2,1′-dimethylsilylene)bis(indenyl)zirconium dichloride, (t-butylamide)dimethyl(tetramethyl-η⁵-cyclopentadienyl) silanetitanium dichloride and (1,2-ethanediyl)(methylamide)(tetramethyl-η⁵-cyclopentadienyl)silanetitanium dichloride.

In the above third aspect of the invention, the contact order of the layered compound, the transition metal complex and the monomer in producing the polyolefin-based composite resin shall not specifically matter.

However, in order to remove water present between the layers of the layered compound and a surface hydroxyl group, they are reacted with an organic aluminum compound and removed, and then olefin and/or diene are preferably polymerized using the catalyst prepared by bringing the layered compound into contact with the transition metal complex.

In particular, when using the metallocene complex or the chelate complex of the metal of Group 4 to Group 6 in the Periodic Table, the layered compound is preferably treated with the organic aluminum compound.

Conditions for treating the layered compound with the organic aluminum compound are the same as the conditions for treating with the organic aluminum compound in order to remove the moisture of the silane-treated product described above.

In a system in which the silane-treated product is treated with the organic aluminum compound, carrying out again the treatment described above further raises the polymerizing property and the dispersing property of the layered compound.

Capable of being used as the olefin in the above third aspect of the invention are various α-olefins, halogen-substituted α-olefins, cyclic olefins, linear dienes, cyclic dienes and styrenes which were given as the examples of the olefins in the second aspect of the invention described above.

In the polymerization of olefin using the catalyst comprising the layered compound and the complex of transition metal of the Group 4 to Group 10 in the Periodic Table, selected is such condition that 0.2 to 80% by weight of the layered compound is usually present in the resulting polyolefin-based composite resin.

A larger use amount of the transition metal complex to the layered compound makes the dispersing property of the layered compound better, but from a practical point of view, it is preferably 0.01 to 100 micromole, further preferably 0.1 to 100 micromole and more preferably 1 to 50 micromole per 1 g of the layered compound. When the polymerization temperature is 150° C. or higher, the layered compound contained in the polyolefin-based composite resin is deteriorated in dispersing property, and therefore it is not preferred. Accordingly, the polymerization is preferably carried out in a range of a room temperature to lower than 150° C.

A content of the polyolefin polymer contained in the polyolefin-based composite resin is an amount obtained by deducting a blending amount of the layered compound from the whole amount and is usually 99.8 to 20% by weight. When the content of the polyolefin polymer is less than 20% by weight, the polyolefin-based composite resin is reduced in physical properties, and the layered compound is likely to be notably deteriorated in dispersing property.

Included in the polyolefin.polymer are not only a homopolymer but also a copolymer of ethylene with α-olefin and norbornene, a random copolymer of propylene with ethylene and an alternating copolymer of ethylene with styrene.

The copolymer is preferably a copolymer obtained by polymerizing at least one monomer selected from 1-olefins having 2 to 4 carbon atoms and dienes.

The high rigidity composite molded article of the above third aspect of the invention can be produced as well by blending the polyolefin-based composite resin with a metal salt compound and subjecting it to shearing treatment during heating.

The rigidity is further improved by adding the metal salt compound. The metal salt compound includes metal salts of aliphatic fatty acids such as palmitic acid, stearic acid and oleic acid; metal salts of aromatic fatty acids such as benzoic acid and naphthoic acid; organic phosphates such as sodium 2,2′-methylenebis(4,6-di-t-butylphenyl)phosphate, sodium 2,2′-methylenebis(4-methyl-6-t-butylphenyl)-phosphate and sodium 2,2′-ethylidenebis(4-methyl-6-t-butylphenyl)phosphate, metal alcolates, metal phenolates and metal amides. Metal for the metal salt compound is preferably typical metal (1st to 3rd metal elements in the Periodic Table) such as sodium, potassium, lithium, magnesium, calcium and aluminum.

The specific examples thereof include calcium distearate, sodium stearate and di(p-t-butylbenzoic acid)aluminum hydroxide.

An addition amount of the metal salt compound is preferably 0.01 to 5 parts by weight, more preferably 0.1 to 5 parts by weight per 100 parts by weight of the polyolefin-based composite resin.

An optimum addition amount of the metal salt compound is varied according to the properties and the content of the layered compound used for the polymerization. An addition amount thereof is preferably 1 to 100% by weight, more preferably 2 to 40% by weight based on a use amount of the layered compound.

The metal salt compound can be blended with the polyolefin-based composite resin by adding it directly to a polymerization reaction slurry (liquid) in an after-step in a polymerization reacting apparatus or adding it before and/or after molding the polyolefin-based composite resin into pellets.

The high rigidity composite molded article of the above third aspect of the invention can be produced as well by using the polyolefin-based composite resin as a master batch, blending it with a thermoplastic resin and molding it after subjecting to shearing treatment during heating.

The thermoplastic resin includes polyolefin-based resins such as polypropylene and polyethylene, polystyrene resins, polycarbonate resins, polyacetal resins, polyester resins and polyamides.

A phenol-based antioxidant can be blended as well. The phenol-based antioxidant includes 2,6-di-tert-butyl-p-cresol, 2,6-di-tert-butyl-p-phenol, 2,4-dimethyl-6-di-tert-butyl-cresol, butylhydroxyanisole, 2,2′-methylenebis(4-methyl-6-tert-butylphenol), 4,4′-butylidenebis(3-methyl-6-tert-butylphenol), 4,4′-thiobis(3-methyl-6-tert-butylphenol), tetrakis[methylene-3-(3,5-di-tert-butyl-4-hydroxyphenyl)propionate]methane and 1,1,3-tris(2-methyl-4-hydroxy-5-tert-butylphenyl)butane. A blending amount of the phenol-based antioxidant is preferably 0.001 to 5 parts by weight, more preferably 0.01 to 1 part by weight per 100 parts by weight of the polyolefin-based composite resin.

A composite material having a satisfactory rigidity is not obtained only by subjecting the polyolefin-based composite resin to hot press by means of a molding machine, and it is after subjecting to shearing treatment during heating that the markedly high rigidity is revealed.

The shearing treatment means operation in which a shearing force is acted onto the polyolefin-based composite resin.

A Henschel mixer, a single screw or multi-screw extruder, a kneader, a Banbury mixer, a roll and a plasto-mill can be used for the operation thereof.

The shearing treatment pressure is usually 0 to 40 MPa, preferably 0.1 to 10 MPa.

The shearing treatment temperature may be a temperature at which the polyolefin polymer contained in the polyolefin-based composite resin is molten, and it is usually 100 to 300° C., preferably 160 to 230° C.

The shearing treatment time may be 10 seconds to one hour.

In carrying out the shearing treatment, the polyolefin-based composite resin is preferably left under inert gas atmosphere. Volatile matters contained in the polyolefin-based composite resin may be removed by adding steam or applying reduced pressure in some cases.

In respect to the molding conditions after the shearing treatment, the molding pressure is usually 2 to 40 MPa.

The molding temperature falls in a range of usually 100 to 300° C., preferably 160 to 230° C.

A short shaft or long screw-extruder, a twin screw extruder and the like are used for the molding machine.

An extrusion molding machine and an injection-molding machine can be used for shearing operation to carry out shearing treatment and molding at the same time.

Next, the fourth aspect of the invention shall be explained.

In a production process for an olefin/polar vinyl monomer copolymer in this fourth aspect of the invention, a catalyst comprising a layered compound as component (A) and a complex of a transition metal of Group 4 to Group 10 in the Periodic Table as component (B) is used. Clay, a clay mineral or an ion-exchangeable layered compound can be nominated as the layered compound of the component (A) described above. The clay, the clay mineral or the ion-exchangeable layered compound described above component (B) is the same as explained in the first aspect of the invention described above.

The layered compound used in the above fourth aspect of the invention is preferably treated with an organic silane compound. An organic silane compound having carbon in an element bonded directly to silicon can be used for this organic silane compound. The organic silane compound represented by Formula (1) can preferably be given as such organic silane compound. The organic silane compound represented by Formula (1′) is more preferred.

The above organic silane compound is the same as explained above and in the first aspect of the invention described above.

In order to treat the layered compound of the component (A) with the organic silane compound, the layered compound is first added to water of an amount which is enough for preparing a clay colloid aqueous dispersion, preferably water of as large amount as 40 times the weight of the layered compound or more to prepare a colloid aqueous dispersion of the layered compound. Next, the organic silane compound described above is added to the layered compound colloid aqueous dispersion thus prepared and heated while stirring, whereby the layered compound is treated with the organic silane compound. This treatment can be carried out at a temperature of −30 to 100° C., and it is preferably carried out at a temperature close to 100° C. in order to shorten time for preparing the catalyst. This treating time is changeable depending on the kind of the layered compound used and the treating temperature, and it is 30 minutes to 10 hours.

A use proportion of the organic silane compound used in this case is 0.001 to 1000, preferably 0.01 to 500 in terms of a mole number of a silicon atom per 1 kg of the layered compound of the component (A) . When a mole number of this silane compound is smaller than 0.001, a polymerization activity of the catalyst is reduced. When it exceeds 1000, the activity is reduced again in a certain case.

Thus, the layered compound colloid aqueous dispersion is turned into a slurry suspension by treating the layered compound colloid aqueous dispersion with the organic silane compound. Water is added again to this slurry and washed, and it is filtrated through a filter and dried, whereby an organic silane-treated layered compound can be obtained in the form of a solid matter.

When a chelate complex of a metal of Group 4 to Group 6 in the Periodic Table or a titanium complex is used as a component (B) described later, the layered compound of the component (A) is subjected to silane treatment, further treated with an organic aluminum compound (the same one as described later can be used), then brought into contact with the transition metal complex and used for copolymerizing olefin with a polar vinyl monomer, whereby the catalyst activity grows higher. When using a metallocene catalyst complex of transition metal other than titanium, the activity becomes higher by subjecting the layered compound to silane treatment, and pre-treatment by an organic aluminum compound is not necessarily required.

In the above fourth aspect of the invention, a metallocene complex containing transition metal of Group 4 to Group 6 in the Periodic Table or a chelate complex containing transition metal of Group 4 to Group 10 in the Periodic Table, preferably a Group 8 to Group 10 in the Periodic Table and having a ligand of a hetero atom is used as a complex of a transition metal of Group 4 to Group 10 in the Periodic Table as component (B). Among them, an indenyl complex is preferred from the viewpoint of having a polymerizing ability with ethylene and propylene and providing a high activity. Further, cross-linking half metallocene (including a constrained geometrical type ligand complex and a CGC complex) having a good copolymerizing ability can be used as well. Transition metal compounds represented by the following Formulas (3C) to (5C) can be nominated as the preferred metallocene complex containing transition metal of Group 4 to Group 6 in the Periodic Table in terms of the activity, and a transition metal compound represented by the following Formula (6C) can be nominated as the preferred chelate complex containing transition metal of Group 8 to Group 10 in the Periodic Table:

Q¹ₐ(C₅H_{5-a-b}R^{7c}_{b})(C₅H_{5-a-c}R^{8c}_{c})M¹X³ₚY¹_{q} (3C)

Q²ₐ(C₅H_{5-a-d}R^{9c}_{d})Z¹M¹X³ₚY¹_{q} (4C)

M¹X⁴ᵣ (5C)

L^{1c}L^{2c}M²X⁴ᵤY²ᵥ (6C)

[wherein Q¹ represents a bonding group which cross-links two conjugate five-membered cyclic ligands (C₅H_{5-a-b}R^{7c}_{b}) and (C₅H_{5-a-c}R^{8c}_{c}); Q² represents a bonding group which cross-links a conjugate five-membered ligand (C₅H_{5-a-d}R^{9c}_{d}) and a Z¹ group; R^{7c}, R^{8c} and R^{9c} each represent a hydrocarbon group, a halogen atom, an alkoxy group, a silicon-containing hydrocarbon group, a phosphorus-containing hydrocarbon group, a nitrogen-containing hydrocarbon group or a boron-containing hydrocarbon group; a is 0, 1 or 2; b, c and d each represent an integer of 0 to 5 when a is 0, an integer of 0 to 4 when a is 1 and an integer of 0 to 3 when a is 2; (p+q) is (valence of M¹-2), and r represents a valence of M¹; M¹ represents transition metal of Group 4 to Group 6 in the Periodic Table; M² represents transition metal of Group 8 to Group 10 in the Periodic Table, and (u+v) represents a valence of M²; L^{1c} and L^{2c} each represent a covalent bonding ligand; X³, Y¹, Z¹, X⁴ and Y² each represent a covalent bonding or ionic bonding ligand; L^{1c}, L^{2c}, X⁴ and Y² may be combined with each other to form a cyclic structure].

The specific examples of these Q¹ and Q² include (1) an alkylene group having 1 to 4 carbon atoms such as methylene, ethylene, isoprene, methylphenylmethylene, diphenylmethylene and cyclohexylene, a cycloalkylene group or a side chain lower alkyl or phenyl-substituted group thereof, (2) a silylene group such as silylene, dimethylsilylene, methylphenylsilylene, diphenylsilylene, disilylene and tetramethyldisilylene, an oligosilylene group or a side chain lower alkyl or phenyl-substituted group thereof and (3) a hydrocarbon group [a lower alkyl group, a phenyl group, a hydrocarbyloxy group (preferably a lower alkoxy group) and the like] containing germanium, phosphorus, nitrogen, boron or aluminum, such as a (CH₃)₂Ge group, a (C₆H₅)₂Ge group, a (CH₃)P group, a (C₆H₅)P group, a (C₄H₉)N group, a (C₆H₅)N group, a (CH₃)B group, a (C₄H₉)B group, a (C₆H₅)B group, a (C₆H₅)Al group and a (CH₃O)Al group. Among them, an alkylene group and a silylene group are preferred in terms of the activity.

(C₅H_{5-a-b}R^{7c}_{b}), (C₅H_{5-a-c}R^{8c}_{c}) and (C₅H_{5-a-d}R^{9c}_{d}) are conjugate five-membered cyclic ligands; R^{7c}, R^{8c} and R^{9c} each represent a hydrocarbon group, a halogen atom, an alkoxy group, a silicon-containing hydrocarbon group, a phosphorus-containing hydrocarbon group, a nitrogen-containing hydrocarbon group or a boron-containing hydrocarbon group; a is 0, 1 or 2; and b, c and d each represent an integer of 0 to 5 when a is 0, an integer of 0 to 4 when a is 1 and an integer of 0 to 3 when a is 2. In this case, the hydrocarbon group has preferably 1 to 20 carbon atoms, particularly preferably 1 to 12 carbon atoms. This hydrocarbon group as a monovalent group may be combined with a cyclopentadienyl group which is a conjugate five-membered cyclic group, and when a plurality thereof is present, two groups thereof may be combined with each other to form a cyclic structure together with a part of a cyclopentadienyl group. That is, the typical examples of the above conjugate five-membered cyclic ligand are a substituted or non-substituted cyclopentadienyl group, an indenyl group and a fluorenyl group. The halogen atom includes chlorine, bromine, iodine and fluorine, and the alkoxy group preferably includes those having 1 to 12 carbon atoms. The silicon-containing hydrocarbon group includes, for example, —Si(R^{10c})(R^{11c})(R^{12c}) (R^{10c}, R^{11c} and R^{12c} are hydrocarbon groups having 1 to 24 carbon atoms), and the phosphorus-containing hydrocarbon group, the nitrogen-containing hydrocarbon group and the boron-containing hydrocarbon group include —P(R^{13c})(R^{14c}), —N(R^{13c})(R^{14c}) and —B(R^{13c})(R^{14c}) respectively (R^{13c} and R^{14c} are hydrocarbon groups having 1 to 18 carbon atoms). When a plurality of R^{7c}, R^{8c} and R^{9c} is present respectively, a plurality of R^{7c}, a plurality of R^{8c} and a plurality of R^{9c} may be the same as or different from each other. Further, in Formula (3C), (C₅H_{5-a-b}R^{7c}_{b}) and (C₅H_{5-a-c}R^{8c}_{c}) may be the same or different.

The hydrocarbon group having 1 to 24 carbon atoms and the hydrocarbon group having 1 to 18 carbon atoms include an alkyl group, an alkenyl group, an aryl group, an aralkyl group and an alicyclic aliphatic hydrocarbon group. The alkyl group includes methyl, ethyl, n-propyl, isopropyl, n-butyl, isobutyl, tert-butyl, n-hexyl and n-decyl, and in the present invention, the groups having 1 to 20 carbon atoms are preferred. The alkenyl group includes vinyl, 1-propenyl, 1-butenyl, 1-hexenyl, 1-octenyl and cyclohexenyl, and in the present invention, the groups having 2 to 10 carbon atoms are preferred. The aryl group includes phenyl, tolyl, xylyl and naphthyl. The aralkyl group includes benzyl and phenethyl, and in the present invention, the groups having 6 to 14 carbon atoms are preferred. The alicyclic aliphatic hydrocarbon group includes cyclopropyl, cyclopentyl and cyclohexyl.

On the other hand, M¹ represents transition metal of Group 4 to Group 6 in the Periodic Table, and titanium, zirconium, hafnium, vanadium, niobium, molybdenum and tungsten ca be nominated as the specific examples thereof. Among them, titanium, zirconium and hafnium are preferred in terms of the activity. Z¹ is a covalent bonding ligand and represents, to be specific, a halogen atom, oxygen (—O—), sulfur (—S—), an alkoxy group having 1 to 20 carbon atoms, preferably 1 to 10 carbon atoms, a thioalkoxy group having 1 to 20 carbon atoms, preferably 1 to 12 carbon atoms, a nitrogen-containing hydrocarbon group having 1 to 40 carbon atoms, preferably 1 to 18 carbon atoms (for example, t-butylamino, t-butylimino and the like) and a phosphorus-containing hydrocarbon group having 1 to 40 carbon atoms, preferably 1 to 18 carbon atoms. X³ and Y¹ each are a covalent bonding or an ionic bonding ligand and represent, to be specific, a hydrogen atom, a halogen atom, a hydrocarbon group having 1 to 20 carbon atoms, preferably 1 to 10 carbon atoms, an alkoxy group having 1 to 20 carbon atoms, preferably 1 to 10 carbon atoms, an amino group, a phosphorus-containing hydrocarbon group having 1 to 20 carbon atoms, preferably 1 to 12 carbon atoms (for example, diphenylphosphine), a silicon-containing hydrocarbon group having 1 to 20 carbon atoms, preferably 1 to 12 carbon atoms (for example, trimethylsilyl), a hydrocarbon group having 1 to 20 carbon atoms, preferably 1 to 12 carbon atoms or a halogen-containing boron compound (for example, B(C₆H₅)₄ and BF₄) . Among them, the halogen atom and the hydrocarbon groups are preferred. These X³ and Y¹ may be the same as or different from each other. X⁴ is a covalent bonding ligand and represents, to be specific, a halogen atom, a hydrocarbylamino group or a hydrocarbyloxy group, preferably an alkoxy group. In the above fourth aspect of the invention, the component (B) is preferably the transition metal compound represented by Formula (3C) or (4C) described above, and among them, the complex having a ligand having an indenyl, cyclopentadienyl or fluorenyl structure is particularly preferred.

(I) The specific examples of the transition metal compound represented by Formula (3C) or (4C) described above include the following compounds:

(i) The transition metal compounds which do not have cross-linkable bonding groups and which have two conjugate five-membered cyclic ligands, such as bis(cyclopentadienyl)zirconium dichloride, bis(methylcyclopentadienyl)titanium dichloride, bis(dimethylcyclopentadienyl)titanium dichloride, bis(trimethylcyclopentadienyl)titanium dichloride, bis(tetramethylcyclopentadienyl)titanium dichloride, bis(pentamethylcyclopentadienyl)titanium dichloride, bis(n-butylcyclopentadienyl)titanium dichloride, bis(indenyl)titanium dichloride, bis(fluorenyl)titanium dichloride, bis(cyclopentadienyl)titanium chlorohydride, bis(cyclopentadienyl)methyltitanium chloride, bis(cyclopentadienyl)ethyltitanium chloride, bis(cyclopentadienyl)phenyltitanium chloride, bis(cyclopentadienyl)dimethyltitanium, bis(cyclopentadienyl)diphenyltitanium, bis(cyclopentadienyl)dineopentyltitanium, bis(cyclopentadienyl)dihydrotitanium, (cyclopentadienyl)(indenyl)titanium dichloride, (cyclopentadienyl)(fluorenyl)titanium dichloride, bis(cyclopentadienyl)zirconium dichloride, bis(methylcyclopentadienyl)zirconium dichloride, bis(dimethylcyclopentadienyl)zirconium dichloride, bis(trimethylcyclopentadienyl)zirconium dichloride, bis(tetramethylcyclopentadienyl)zirconium dichloride, bis(pentamethylcyclopentadienyl)zirconium dichloride, bis(n-butylcyclopentadienyl)zirconium dichloride, bis(indenyl)zirconium dichloride, bis(fluorenyl)zirconium dichloride, bis(cyclopentadienyl)zirconium chlorohydride, bis(cyclopentadienyl)methylzirconium chloride, bis(cyclopentadienyl)ethylzirconium chloride, bis(cyclopentadienyl)phenylzirconium chloride, bis(cyclopentadienyl)dimethylzirconium, bis(cyclopentadienyl)diphenylzirconium, bis(cyclopentadienyl)dineopentylzirconium, bis(cyclopentadienyl)dihydrozirconium, (cyclopentadienyl)(indenyl)zirconium dichloride and (cyclopentadienyl)(fluorenyl)zirconium dichloride;

(ii) the transition metal compounds having two conjugate five-membered cyclic ligands which are cross-linked with an alkylene group, such as methylenebis(indenyl)titanium dichloride, ethylenebis(indenyl)titanium dichloride, methylenebis(indenyl)titanium chlorohydride, ethylenebis(indenyl)methyltitanium chloride, ethylenebis(indenyl)methoxychlorotitanium, ethylenebis(indenyl)titanium diethoxide, ethylenebis(indenyl)dimethyltitanium, ethylenebis-(4,5,6,7-tetrahydroindenyl)titanium dichloride, ethylenebis(2-methylindenyl)titanium dichloride, ethylenebis(2,4-dimethylindenyl)titanium dichloride, ethylenebis(2-methyl-4-trimethylsilylindenyl)titanium dichloride, ethylenebis(2,4-dimethy-5,6,7-6 1 trihydroindenyl)titanium dichloride, ethylene(2,4-dimethylcyclopentadienyl)(3′,5′-dimethylcyclopentadienyl)titanium dichloride, ethylene(2-methyl-4-t-butylcyclopentadienyl)(3′-t-butyl-5′-methylcyclopentadienyl)titanium dichloride, ethylene(2,3,5-trimethylcyclopentadienyl)(2′,4′,5′-trimethylcyclopentadienyl)titanium dichloride, isopropylidenebis(2-methylindenyl)titanium dichloride, isopropylidenebis(indenyl)titanium dichloride, isopropylidenebis(2,4-dimethylindenyl)titanium dichloride, isopropylidene(2,4-dimethylcyclopentadienyl)(3′,5′-dimethylcyclopentadienyl)titanium dichloride, isopropylidene(2-methyl-4-t-butylcyclopentadienyl)-(3′-t-butyl-5′-methylcyclopentadienyl)titanium dichloride, methylene(cyclopentadienyl)(3,4-dimethylcyclopentadienyl)titanium dichloride, methylene(cyclopentadienyl)(3,4-dimethylcyclopentadienyl)titanium chlorohydride, methylene(cyclopentadienyl)(3,4-dimethylcyclopentadienyl)dimethyltitanium, methylene(cyclopentadienyl)(3,4-dimethylcyclopentadienyl)diphenyltitanium, methylene(cyclopentadienyl)-(trimethylcyclopentadienyl)titanium dichloride, methylene(cyclopentadienyl)-(tetramethylcyclopentadienyl)titanium dichloride, isopropylidene(cyclopentadienyl)(3,4-dimethylcyclopentadienyl)titanium dichloride, isopropylidene(cyclopentadienyl)(2,3,4,5-tetramethylcyclopentadienyl)titanium dichloride, isopropylidene(cyclopentadienyl)(3-methylindenyl)titanium dichloride, isopropylidene-(cyclopentadienyl)(fluorenyl)titanium dichloride, isopropylidene(2-methylcyclopentadienyl)-(fluorenyl)titanium dichloride, isopropylidene(2,5-dimethylcyclopentadienyl)(3,4-dimethylcyclopentadienyl)titanium dichloride, isopropylidene(2,5-dimethylcyclopentadienyl)-(fluorenyl)titanium dichloride, ethylene-(cyclopentadienyl)(3,5-dimethylcyclopentadienyl)-titanium dichloride, ethylene(cyclopentadienyl)-(fluorenyl)titanium dichloride, ethylene(2,5-dimethylcyclopentadienyl)(fluorenyl)titanium dichloride, ethylene(2,5-diethylcyclopentadienyl)-(fluorenyl)titanium dichloride, diphenylmethylene-(cyclopentadienyl)(3,4-diethylcyclopentadienyl)-titanium dichloride, diphenylmethylene-(cyclopentadienyl)(3,4-diethylcyclopentadienyl)-titanium dichloride, cyclohexylidene-(cyclopentadienyl)(fluorenyl)titanium dichloride, cyclohexylidene(2,5-dimethylcyclopentadienyl)(3′,4′-dimethylcyclopentadienyl)titanium dichloride, methylenebis(indenyl)zirconium dichloride, ethylenebis(indenyl)titanium dichloride, methylenebis(indenyl)zirconium chlorohydride, ethylenebis(indenyl)methylzirconium chloride, ethylenebis(indenyl)methoxychlorozirconium, ethylenebis(indenyl)zirconium diethoxide, ethylenebis(indenyl)dimethylzirconium, ethylenebis-(4,5,6,7-tetrahydroindenyl)zirconium dichloride, ethylenebis(2-methylindenyl)zirconium dichloride, ethylenebis(2,4-dimethylindenyl)zirconium dichloride, ethylenebis(2-methyl-4-trimethylsilylindenyl)-zirconium dichloride, ethylenebis(2,4-dimethy-5,6,7-trihydroindenyl)zirconium dichloride, ethylene(2,4-dimethylcyclopentadienyl)(3′,5′-dimethylcyclopentadienyl)zirconium dichloride, ethylene(2-methyl-4-t-butylcyclopentadienyl)(3′-t-butyl-5′-methylcyclopentadienyl)zirconium dichloride, ethylene(2,3,5-trimethylcyclopentadienyl)(2′,4′,5′-trimethylcyclopentadienyl)zirconium dichloride, isopropylidenebis(2-methylindenyl)zirconium dichloride, isopropylidenebis(indenyl)zirconium dichloride, isopropylidenebis(2,4-dimethylindenyl)zirconium dichloride, isopropylidenebis(2,4-dimethylcyclopentadienyl)-zirconium chlorohydride, isopropylidene(2,4-dimethylcyclopentadienyl)(3′,5′-dimethylcyclopentadienyl)zirconium dichloride, isopropylidene(2-methyl-4-t-butylcyclopentadienyl)-(3′-t-butyl-5′-methylcyclopentadienyl)zirconium dichloride, methylene(cyclopentadienyl)(3,4-dimethylcyclopentadienyl)zirconium dichloride, methylene(cyclopentadienyl)(3,4-dimethylcyclopentadienyl)zirconium chlorohydride, methylene(cyclopentadienyl)(3,4-dimethylcyclopentadienyl)dimethylzirconium, methylene(cyclopentadienyl)(3,4-dimethylcyclopentadienyl)diphenylzirconium, methylene(cyclopentadienyl)-(trimethylcyclopentadienyl)zirconium dichloride, methylene(cyclopentadienyl)-(tetramethylcyclopentadienyl )zirconium dichloride, isopropylidene(cyclopentadienyl)(3,4-dimethylcyclopentadienyl)zirconium dichloride, isopropylidene(cyclopentadienyl)(2,3,4,5-tetramethylcyclopentadienyl)zirconium dichloride, isopropylidene(cyclopentadienyl)(3-methylindenyl)-zirconium dichloride, isopropylidene-(cyclopentadienyl)(fluorenyl)zirconium dichloride, isopropylidene(2-methylcyclopentadienyl)-(fluorenyl)zirconium dichloride, isopropylidene (2,5-dimethylcyclopentadienyl)(3,4-dimethylcyclopentadienyl)zirconium dichloride, isopropylidene(2,5-dimethylcyclopentadienyl)-(fluorenyl)zirconium dichloride, ethylene-(cyclopentadienyl)(3,5-dimethylcyclopentadienyl)-zirconium dichloride, ethylene(cyclopentadienyl)-(fluorenyl)zirconium dichloride, ethylene(2,5-dimethylcyclopentadienyl)(fluorenyl)zirconium dichloride, ethylene(2,5-diethylcyclopentadienyl)-(fluorenyl)zirconium dichloride, diphenylmethylene-(cyclopentadienyl)(3,)hafnium diethoxide, ethylenebis(indenyl)dimethylhafnium-4-diethylcyclopentadienyl)zirconium dichloride, diphenylmethylene(cyclopentadienyl)(3,4-diethylcyclopentadienyl)zirconium dichloride, cyclohexylidene(cyclopentadienyl)(fluorenyl)zirconium dichloride, cyclohexylidene(2,5-dimethylcyclopentadienyl)(3′,4′-dimethylcyclopentadienyl)zirconium dichloride, methylenebis(indenyl)hafnium dichloride, ethylenebis(indenyl)hafnium dichloride, methylenebis(indenyl)hafnium chlorohydride, ethylenebis(indenyl)methylhafnium chloride, ethylenebis(indenyl)methoxychlorohafnium, ethylenebis(indenyl)hafnium diethoxide, ethylenebis(indenyl)dimethylhafnium, ethylenebis-(4,5,6,7-tetrahydroindenyl)hafnium dichloride, ethylenebis(2-methylindenyl)hafnium dichloride, ethylenebis(2,4-dimethylindenyl)hafnium dichloride, ethylenebis(2-methyl-4-trimethylsilylindenyl)hafnium dichloride, ethylenebis(2,4-dimethy-5,6,7-trihydroindenyl)hafnium dichloride, ethylene(2,4-dimethylcyclopentadienyl)(3′,5′-dimethylcyclopentadienyl)hafnium dichloride, ethylene(2-methyl-4-t-butylcyclopentadienyl) (3′-t-butyl-5′-methylcyclopentadienyl)hafnium dichloride, ethylene(2,3,5-trimethylcyclopentadienyl)(2′,4′,5′-trimethylcyclopentadienyl)hafnium dichloride, isopropylidenebis(2-methylindenyl)hafnium dichloride, isopropylidenebis(indenyl)hafnium dichloride, isopropylidenebis(2,4-dimethylindenyl)hafnium dichloride, isopropylidene(2,4-dimethylcyclopentadienyl)(3′,5′-dimethylcyclopentadienyl)hafnium dichloride, isopropylidene(2-methyl-4-t-butylcyclopentadienyl)-(3′-t-butyl-5′-methylcyclopentadienyl)hafnium dichloride, methylene(cyclopentadienyl)(3,4-dimethylcyclopentadienyl)hafnium dichloride, methylene(cyclopentadienyl)(3,4-dimethylcyclopentadienyl)hafnium chlorohydride, methylene(cyclopentadienyl)(3,4-dimethylcyclopentadienyl)dimethylhafnium, methylene(cyclopentadienyl)(3,4-dimethylcyclopentadienyl)diphenylhafnium, methylene(cyclopentadienyl)-(trimethylcyclopentadienyl)hafnium dichloride, methylene(cyclopentadienyl)-(tetramethylcyclopentadienyl)hafnium dichloride, isopropylidene(cyclopentadienyl)(3,4-dimethylcyclopentadienyl)hafnium dichloride, isopropylidene(cyclopentadienyl)(2,3,4,5-tetramethylcyclopentadienyl)hafnium dichloride, isopropylidene(cyclopentadienyl)(3-methylindenyl)hafnium dichloride, isopropylidene-(cyclopentadienyl)(fluorenyl)hafnium dichloride, isopropylidene(2-methylcyclopentadienyl)-(fluorenyl)hafnium dichloride, isopropylidene(2,5-dimethylcyclopentadienyl)(3,4-dimethylcyclopentadienyl)hafnium dichloride, isopropylidene(2,5-dimethylcyclopentadienyl)-(fluorenyl)hafnium dichloride, ethylene-(cyclopentadienyl)(3,5-dimethylcyclopentadienyl)-hafnium dichloride, ethylene(cyclopentadienyl)-(fluorenyl)hafnium dichloride, ethylene(2,5-dimethylcyclopentadienyl)(fluorenyl)hafnium dichloride, ethylene(2,5-diethylcyclopentadienyl)-(fluorenyl)hafnium dichloride, diphenylmethylene(cyclopentadienyl)(3,4-diethylcyclopentadienyl)hafnium m dichloride, cyclohexylidene(cyclopentadienyl)(fluorenyl)hafnium dichloride and cyclohexylidene(2,5-dimethylcyclopentadienyl)(3′,4′-dimethylcyclopentadienyl)hafnium dichloride;

(iii) the transition metal compounds having two conjugate five-membered cyclic ligands which are cross-linked with a silylene group, such as dimethylsilylenebis(indenyl)titanium dichloride, dimethylsilylenebis(4,5,6,7-tetrahydroindenyl)titanium dichloride, dimethylsilylenebis(2-methylindenyl)titanium dichloride, dimethylsilylenebis(2,4-dimethylindenyl)titanium dichloride, dimethylsilylenebis(2,4-dimethylcyclopentadienyl)-(3′,5′-dimethylcyclopentadienyl)titanium dichloride, dimethylsilylenebis(2-methyl-4,5-benzoindenyl)-titanium dichloride, dimethylsilylenebis(2-methyl-4-naphthylindenyl)titanium dichloride, dimethylsilylenebis(2-methyl-4-phenylindenyl)titanium dichloride, phenylmethylsilylenebis(indenyl)titanium dichloride, phenylmethylsilylenebis(4,5,6,7-tetrahydroindenyl)titanium dichloride, phenylmethylsilylenebis(2,4-dimethylindenyl)titanium dichloride, phenylmethylsilylenebis(2,4-dimethylcyclopentadienyl)(3′,5′-dimethylcyclopentadienyl)titanium dichloride, phenylmethylsilylene(2,3,5-trimethylcyclopentadienyl)(2′,4′,5′-trimethylcyclopentadienyl)titanium dichloride, phenylmethylsilylenebis(tetramethylcyclopentadienyl)-titanium dichloride, diphenylsilylenebis(2,4-dimethylindenyl)titanium dichloride, diphenylsilylenebis(indenyl)titanium dichloride, diphenylsilylenebis(2-methylindenyl)titanium dichloride, tetramethyldisilylenebis(indenyl)titanium dichloride, tetramethyldisilylenebis-(cyclopentadienyl)titanium dichloride, tetramethyldisilylene(3-methylcyclopentadienyl)-(indenyl)titanium dichloride, dimethylsilylene-(cyclopentadienyl)(3,4-dimethylcyclopentadienyl)-titanium dichloride, dimethylsilylene-(cyclopentadienyl)(trimethylcyclopentadienyl)titanium dichloride, dimethylsilylene(cyclopentadienyl)-(tetramethylcyclopentadienyl)titanium dichloride, dimethylsilylene(cyclopentadienyl)(3,4-diethylcyclopentadienyl)titanium dichloride, dimethylsilylene(cyclopentadienyl)-(triethylcyclopentadienyl)titanium dichloride, dimethylsilylene(cyclopentadienyl)-(tetraethylcyclopentadienyl)titanium dichloride, dimethylsilylene(cyclopentadienyl)(fluorenyl)titanium dichloride, dimethylsilylene(cyclopentadienyl)(2,7-di-t-butylfluorenyl)titanium dichloride, dimethylsilylene(cyclopentadienyl)-(octahydrofluorenyl)titanium dichloride, dimethylsilylene(2-methylcyclopentadienyl)-(fluorenyl)titanium dichloride, dimethylsilylene(2,5-dimethylcyclopentadienyl)(fluorenyl)titanium dichloride, dimethylsilylene(2-ethylcyclopentadienyl)(fluorenyl)titanium dichloride, dimethylsilylene(2,5-diethylcyclopentadienyl)-(fluorenyl)titanium dichloride, diethylsilylene(2-methylcyclopentadienyl)(2′,7′-di-t-butylfluorenyl)titanium dichloride, dimethylsilylene-(2,5-dimethylcyclopentadienyl)(2′,7′-di-t-butylfluorenyl)titanium dichloride, dimethylsilylene-(2-ethylcyclopentadienyl)(2′,7′-di-t-butylfluorenyl)-titanium dichloride, dimethylsilylene-(diethylcyclopentadienyl)(2,7-di-t-butylfluorenyl)-titanium dichloride, dimethylsilylene-(methylcyclopentadienyl)(octahydrofluorenyl)titanium dichloride, dimethylsilylene-(dimethylcyclopentadienyl)(octahydrofluorenyl)-titanium dichloride, dimethylsilylene-(ethylcyclopentadienyl)(octahydrofluorenyl)-titanium dichloride, dimethylsilylene-(diethylcyclopentadienyl)(octahydrofluorenyl)-titanium dichloride, dimethylsilylenebis(indenyl)-zirconium dichloride, dimethylsilylenebis(4,5,6,7-tetrahydroindenyl)zirconium dichloride, dimethylsilylenebis(2-methylindenyl)zirconium dichloride, dimethylsilylenebis(2,4-dimethylindenyl)zirconium dichloride, dimethylsilylenebis(2,4-dimethylcyclopentadienyl)-(3′,5′-dimethylcyclopentadienyl)zirconium dichloride, dimethylsilylenebis(2-methyl-4,5-benzoindenyl)-zirconium dichloride, dimethylsilylenebis(2-methyl-4-naphthylindenyl)zirconium dichloride, dimethylsilylenebis(2-methyl-4-phenylindenyl)-zirconium dichloride, phenylmethylsilylenebis-(indenyl)zirconium dichloride, phenylmethylsilylenebis(4,5,6,7-tetrahydroindenyl)zirconium dichloride, phenylmethylsilylenebis(2,4-dimethylindenyl)zirconium dichloride, phenylmethylsilylenebis(2,4-dimethylcyclopentadienyl)(3′,5′-dimethylcyclopentadienyl)zirconium dichloride, phenylmethylsilylene(2,3,5-trimethylcyclopentadienyl)(2′,4′,5′-trimethylcyclopentadienyl)zirconium dichloride, phenylmethylsilylenebis(tetramethylcyclopentadienyl)-zirconium dichloride, diphenylsilylenebis(2,4-dimethylindenyl)zirconium dichloride, diphenylsilylenebis(indenyl)zirconium dichloride, diphenylsilylenebis(2-methylindenyl)zirconium dichloride, tetramethyldisilylenebis(indenyl)-zirconium dichloride, tetramethyldisilylenebis-(cyclopentadienyl)zirconium dichloride, tetramethyldisilylene(3-methylcyclopentadienyl)-(indenyl)zirconium dichloride, dimethylsilylene-(cyclopentadienyl)(3,4-dimethylcyclopentadienyl)-zirconium dichloride, dimethylsilylene-(cyclopentadienyl)(trimethylcyclopentadienyl)-zirconium dichloride, dimethylsilylene-(cyclopentadienyl)(tetramethylcyclopentadienyl)-zirconium dichloride, dimethylsilylene-(cyclopentadienyl)(3,4-diethylcyclopentadienyl)-zirconium dichloride, dimethylsilylene-(cyclopentadienyl)(triethylcyclopentadienyl)zirconium dichloride, dimethylsilylene(cyclopentadienyl)-(tetraethylcyclopentadienyl)zirconium dichloride, dimethylsilylene(cyclopentadienyl)(fluorenyl)zirconium dichloride, dimethylsilylene(cyclopentadienyl)(2,7-di-t-butylfluorenyl)zirconium dichloride, dimethylsilylene(cyclopentadienyl)-(octahydrofluorenyl)zirconium dichloride, dimethylsilylene(2-methylcyclopentadienyl)-(fluorenyl)zirconium dichloride, dimethylsilylene(2,5-dimethylcyclopentadienyl)-(fluorenyl)zirconium dichloride, dimethylsilylene(2-ethylcyclopentadienyl)(fluorenyl)zirconium dichloride, dimethylsilylene(2,5-diethylcyclopentadienyl)-(fluorenyl)zirconium dichloride, diethylsilylene(2-methylcyclopentadienyl)(fluorenyl)zirconium dichloride, diethylsilylene(2-methylcyclopentadienyl)(2′,7′-di-t-butylfluorenyl)-zirconium dichloride, dimethylsilylene(2,5-dimethylcyclopentadienyl)(2′,7′-di-t-butylfluorenyl)-zirconium dichloride, dimethylsilylene(2-ethylcyclopentadienyl)(2′,7′-di-t-butylfluorenyl)-zirconium dichloride, dimethylsilylene-(diethylcyclopentadienyl)(2,7-di-t-butylfluorenyl)-zirconium dichloride, dimethylsilylene-(methylcyclopentadienyl)(octahydrofluorenyl)zirconium dichloride, dimethylsilylene-(dimethylcyclopentadienyl)(octahydrofluorenyl)-zirconium dichloride, dimethylsilylene-(ethylcyclopentadienyl)(octahydrofluorenyl)zirconium dichloride, dimethylsilylene-(diethylcyclopentadienyl)(octahydrofluorenyl)-zirconium dichloride, dimethylsilylenebis(indenyl)hafnium dichloride, dimethylsilylenebis(4,5,6,7-tetrahydroindenyl)hafnium dichloride, dimethylsilylenebis(2-methylindenyl)-hafnium dichloride, dimethylsilylenebis(2,4-dimethylindenyl)hafnium dichloride, dimethylsilylenebis(2,4-dimethylcyclopentadienyl)-(3′,5′-dimethylcyclopentadienyl)hafnium dichloride, dimethylsilylenebis(2-methyl-4,5-benzoindenyl)hafnium dichloride, dimethylsilylenebis(2-methyl-4-naphthylindenyl)hafnium dichloride, dimethylsilylenebis(2-methyl-4-phenylindenyl)hafnium dichloride, phenylmethylsilylenebis(indenyl)hafnium dichloride, phenylmethylsilylenebis(4,5,6,7-tetrahydroindenyl)hafnium dichloride, phenylmethylsilylenebis(2,4-dimethylindenyl)hafnium dichloride, phenylmethylsilylenebis(2,4-dimethylcyclopentadienyl)(3′,5′-dimethylcyclopentadienyl)hafnium dichloride, phenylmethylsilylenebis(2,3, 5-trimethylcyclopentadienyl)-(2′,4′,5′-trimethylcyclopentadienyl)hafnium dichloride, phenylmethylsilylenebis(tetramethylcyclopentadienyl)-hafnium dichloride, diphenylsilylenebis(2,4-dimethylindenyl)hafnium dichloride, diphenylsilylenebis(indenyl)hafnium dichloride, diphenylsilylenebis(2-methylindenyl)hafnium dichloride, tetramethyldisilylenebis(indenyl)hafnium dichloride, tetramethyldisilylenebis-(cyclopentadienyl)hafnium dichloride, tetramethyldisilylene(3-methylcyclopentadienyl)-(indenyl)hafnium dichloride, dimethylsilylene-(cyclopentadienyl)(3,4-dimethylcyclopentadienyl)-hafnium dichloride, dimethylsilylene-(cyclopentadienyl)(trimethylcyclopentadienyl)hafnium dichloride, dimethylsilylene(cyclopentadienyl)-(tetramethylcyclopentadienyl)hafnium dichloride, dimethylsilylene(cyclopentadienyl)(3,4-diethylcyclopentadienyl)hafniumn dichloride, dimethylsilylene(cyclopentadienyl)-(triethylcyclopentadienyl)hafnium dichloride, dimethylsilylene cyclopentadienyl)-(tetraethylcyclopentadienyl)hafnium dichloride, dimethylsilylene(cyclopentadienyl)(fluorenyl)hafnium dichloride, dimethylsilylene(cyclopentadienyl)(2,7-di-t-butylfluorenyl)hafnium dichloride, dimethylsilylene(cyclopentadienyl)-(octahydrofluorenyl)hafnium dichloride, dimethylsilylene(2-methylcyclopentadienyl)-(fluorenyl)hafnium dichloride, dimethylsilylene(2,5-diethylcyclopentadienyl)(fluorenyl)hafnium dichloride, diethylsilylene(2-methylcyclopentadienyl)(2′,7′-di-t-butylfluorenyl)hafnium dichloride, dimethylsilylene-(2,5-diethylcyclopentadienyl)(2′,7′-di-t-butylfluorenyl)hafnium dichloride, dimethylsilylene-(2-ethylcyclopentadienyl)(2′,7′-di-t-butylfluorenyl)-hafnium dichloride, dimethylsilylene-(diethylcyclopentadienyl)(2,7-di-t-butylfluorenyl)-hafnium dichloride, dimethylsilylene-(methylcyclopentadienyl)(octahydrofluorenyl)hafnium dichloride, dimethylsilylene-(dimethylcyclopentadienyl)(octahydrofluorenyl)-hafnium dichloride, dimethylsilylene-(ethylcyclopentadienyl)(octahydrofluorenyl)hafnium dichloride and dimethylsilylene-(diethylcyclopentadienyl)(octahydrofluorenyl)hafnium dichloride;

(iv) the transition metal compounds having two conjugate five-membered cyclic ligands which are cross-linked with a hydrocarbon group containing germanium, aluminum, boron, phosphorus or nitrogen, such as dimethylgermylenebis(indenyl)titanium dichloride, dimethylgermylene(cyclopentadienyl)-(fluorenyl)titanium dichloride, methylalumylenebis-(indenyl)titanium dichloride, phenylalumylenebis-(indenyl)titanium dichloride, phenylphosphylenebis-(indenyl)titanium dichloride, ethylborenebis-(indenyl)titanium dichloride, phenylalumylenebis-(indenyl)titanium dichloride, phenylalumylene-(cyclopentadienyl)(fluorenyl)titanium dichloride, dimethylgermylenebis(indenyl)zirconium dichloride, dimethylgermylene(cyclopentadienyl)(fluorenyl)-zirconium dichloride, methylalumylenebis-(indenyl)zirconium dichloride, phenylalumylenebis-(indenyl)zirconium dichloride, phenylphosphylenebis-(indenyl)zirconium dichloride, ethylborenebis-(indenyl)zirconium dichloride, phenylalumylenebis-(indenyl)zirconium dichloride, phenylalumylene-(cyclopentadienyl)(fluorenyl)zirconium dichloride, dimethylgermylenebis(indenyl)hafnium dichloride, dimethylgermylene(cyclopentadienyl)(fluorenyl)-hafnium dichloride, methylalumylenebis-(indenyl)hafnium dichloride, phenylalumylenebis-(indenyl)hafnium dichloride, phenylphosphylenebis-(indenyl)hafnium dichloride, ethylborenebis-(indenyl)hafnium dichloride, phenylalumylenebis-(indenyl)hafnium dichloride and phenylalumylene-(cyclopentadienyl)(fluorenyl)hafnium dichloride;

(v) the transition metal compounds having one conjugate five-membered cyclic ligand, such as pentamethylcyclopentadienyl(diphenylamino)titanium dichloride, indenyl(diphenylamino)titanium dichloride, pentamethylcyclopentadienyl-bis(trimethylsilyl)-aminotitanium dichloride, pentamethylcyclopentadienylphenoxytitanium dichloride, dimethylsilylene(tetramethylcyclopentadienyl)t-butylaminotitanium dichloride, dimethylsilylene-(tetramethylcyclopentadienyl)phenylaminotitanium dichloride, dimethylsilylene(tetrahydroindenyl)-decylaminotitanium dichloride, dimethylsilylene-(tetrahydroindenyl)[bis(timethylsilyl)amino]titanium dichloride, dimethylgermylene-(tetramethylcyclopentadienyl)phenylaminotitanium dichloride, pentamethylcyclopentadienyltitanium trimethoxide, pentamethylcyclopentadienyltitanium trichloride, pentamethylcyclopentadienyl-bis(phenyl)aminozirconium dichloride, indenyl-bis(phenyl)aminozirconium dichloride, pentamethylcyclopentadienyl-bis(trimethylsilyl)-aminozircoium dichloride, pentamethylcyclopentadienylphenoxyzirconium dichloride, dimethylsilylene-(tetramethylcyclopentadienyl)t-butylaminozirconium dichloride, dimethylsilylene-(tetramethylcyclopentadienyl)phenylaminozirconium dichloride, dimethylsilylene(tetrahydroindenyl)-decylaminozirconium dichloride, dimethylsilylene-(tetrahydroindenyl)[bis(timethylsilyl)amino]zirconium dichlioride, dimethylgermylene-(tetramethylcyclopentadienyl)phenylaminozirconium dichloride, pentamethylcyclopentadienylzirconium trimethoxide, pentamethylcyclopentadienylzirconium trichloride, pentamethylcyclopentadienyl-bis(phenyl)aminohafnium dichloride, indenyl-bis(phenyl)aminohafnium dichloride, pentamethylcyclopentadienyl-bis(trimethylsilyl)-aminohafnium dichloride, pentamethylcyclopentadienylphenoxyhafnium dichloride, dimethylsilylene(tetramethylcyclopentadienyl)t-butylaminohafnium dichloride, dimethylsilylene-(tetramethylcyclopentadienyl)phenylaminohafnium dichloride, dimethylsilylene(tetrahydroindenyl)-decylaminohafnium dichloride, dimethylsilylene-(tetrahydroindenyl)[bis(timethylsilyl)amino]hafnium dichloride, dimethylgermylene-(tetramethylcyclopentadienyl)phenylaminohafnium dichloride, pentamethylcyclopentadienylhafnium trimethoxide and pentamethylcyclopentadienylhafnium trichloride;

(vi) the transition metal compounds having two conjugate five-membered cyclic ligands which are doubly cross-linked by themselves, such as (1,1′-dimethylsilylene)(2,2′-isopropylidene)-bis(cyclopentadienyl)titanium dichloride, (1,1′-dimethylsilylene)(2,2′-dimethylsilylene)-bis(cyclopentadienyl)titanium dichloride, (1,1′-dimethylsilylene)(2,2′-isopropylidene)-bis(cyclopentadienyl)dimethyltitanium, (1,1′-dimethylsilylene)(2,2′-isopropylidene)-bis(cyclopentadienyl)dibenzyltitanium, (1,1′-dimethylsilylene)(2,2′-isopropylidene)-bis (cyclopentadienyl)bis(trimethylsilyl)titanium, (1,1′-dimethylsilylene)(2,2′-isopropylidene)-bis(cyclopentadienyl)bis(trimethylsilylmethyl)-titanium, (1,2′-dimethylsilylene)(2,1′-ethylene)-bis(indenyl)titanium dichloride, (1,1′-dimethylsilylene)(2,2′-ethylene)-bis(indenyl)titanium dichloride, (1,1′-ethylene)(2,2′-dimethylsilylene)-bis(indenyl)titanium dichloride, (1,1′-dimethylsilylene)(2,2′-cyclohexylidene)-bis(indenyl)titanium dichloride, (1,1′-dimethylsilylene)(2,2′-isopropylidene)-bis(cyclopentadienyl)zirconium dichloride, (1,1′-dimethylsilylene)(2,2′-dimethylsilylene)-bis(cyclopentadienyl)zirconium dichloride, (1,1′-dimethylsilylene)(2,2′-isopropylidene)-bis(cyclopentadienyl)dimethylzirconium, (1,1′-dimethylsilylene)(2,2′-isopropylidene)-bis(cyclopentadienyl)dibenzylzirconium, (1,1′-dimethylsilylene)(2,2′-isopropylidene)-bis(cyclopentadienyl)bis(trimethylsilyl)zirconium, (1,1′-dimethylsilylene)(2,2′-isopropylidene)-bis(cyclopentadienyl)bis(trimethylsilylmethyl)-zirconium, (1,2′-dimethylsilylene)(2,1′-ethylene)-bis(indenyl)zirconium dichloride, (1,1′-dimethylsilylene)(2,2′-ethylene)-bis(indenyl)zirconium dichloride, (1,1′-ethylene)(2,2′-dimethylsilylene)-bis(indenyl)zirconium dichloride, (1,1′-dimethylsilylene)(2,2′-cyclohexylidene)-bis(indenyl)zirconium dichloride, (1,1′-dimethylsilylene)(2,2′-isopropylidene)-bis(cyclopentadienyl)hafnium dichloride, (1,1′-dimethylsilylene)(2,2′-dimethylsilylene)-bis(cyclopentadienyl)hafnium dichloride, (1,1′-dimethylsilylene)(2,2′-isopropylidene)-bis(cyclopentadienyl)dimethylhafnium, (1,1′-dimethylsilylene)(2,2′-isopropylidene)-bis(cyclopentadienyl)dibenzylhafnium, (1,1′-dimethylsilylene)(2,2′-isopropylidene)-bis(cyclopentadienyl)bis(trimethylsilyl)hafnium, (1,1′-dimethylsilylene)(2,2′-isopropylidene)-bis(cyclopentadienyl)bis(trimethylsilylmethyl)-hafnium, (1,2′-dimethylsilylene)(2,1′-ethylene)-bis(indenyl)hafnium dichloride, (1,1′-dimethylsilylene)(2,2′-ethylene)-bis(indenyl)hafnium dichloride, (1,1′-ethylene)(2,2′-dimethylsilylene)-bis(indenyl)hafnium dichloride and (1,1′-dimethylsilylene)(2,2′-cyclohexylidene)-bis(indenyl)hafnium dichloride,

(vii) further those obtained by substituting chlorine atoms of these compounds described in the foregoing items (i) to (vi) with a bromine atom, an iodine atom, a hydrogen atom, methyl, phenyl, benzyl, methoxy and dimethylamino; and

(viii) the transition metal compounds of the foregoing item (iii) having two conjugate five-membered cyclic ligands which are cross-linked with a silylene group, in which the transition metal is zirconium or titanium among the compounds described in the foregoing items (i) to (vii), particularly preferably used.

(II) The specific examples of the transition metal compound represented by Formula (5C) include the tetra-n-butoxytitanium, tetra-i-propoxytitanium, tetraphenoxytitanium, tetracresoxytitanium, tetrachlorotitanium, tetrakis(diethylamino)titanium, tetrabromotitanium and compounds obtained by substituting titanium with zirconium and hafnium. Among these transition metal compounds, the alkoxytitanium compounds, the alkoxyzirconium compounds and the alkoxyhafnium compounds are preferred.

(III) In the transition metal compound represented by Formula (6C), M² represents transition metal of Group 8 to Group 10 in the Periodic Table, and to be specific, it includes iron, cobalt, nickel, palladium and platinum. Among them, nickel, palladium and iron are preferred. L^{1c} and L^{2c} each represent a covalent bonding organic ligand bonded to transition metal via a nitrogen atom or a phosphorus atom, and X⁴ and Y² each represent a covalent bonding or ionic bonding ligand. To be specific, X⁴ and Y² represent, as described above, a hydrogen atom, a halogen atom, a hydrocarbon group having 1 to 20, preferably 1 to 10 carbon atoms, an alkoxy group having 1 to 20, preferably 1 to 10 carbon atoms, an imino group, an amino group, a phosphorus-containing hydrocarbon group having 1 to 20, preferably 1 to 12 carbon atoms (for example, diphenylphosphine and the like), a silicon-containing hydrocarbon group having 1 to 20, preferably 1 to 12 carbon atoms (for example, trimethylsilyl and the like), a hydrocarbon group having 1 to 20, preferably 1 to 12 carbon atoms or a halogen-containing boron compound [for example, B(C₆H₅), BF₄]. Among them, a halogen atom and the hydrocarbon groups are preferred. These X⁴ and Y² may be the same as or different from each other. Further, the specific examples of L^{1c} and L^{2c} include triphenylphosphine, acetonitrile, benzonitrile, 1,2-bisdiphenylphosphine, 1,3-bisdiphenylphosphinopropane, 1,1-bisdiphenylphosphinoferrocene, cyclooctadiene, pyridine, quinoline, N-methylpyrrolidine and bistrimethylsilylaminobistrimethylsilylimino-phosphorane. L^{1c}, L^{2c}, X⁴ and Y² each described above may be combined with each other to form a cyclic structure.

The specific examples of the transition metal compound represented by this Formula (6C) includes dibromobistriphenylphosphinenickel, dichlorobistriphenylphosphinenickel, dibromodiacetonitrilenickel, dibromodibenzonitrilenickel, dibromo(1,2-bisdiphenylphosphinoethane)nickel, dibromo(1,3-bisdiphenylphosphinopropane)nickel, dibromo(1,1′-diphenylbisphosphinoferrocene)nickel, dimethylbistriphenylphosphinenickel, dimethyl(1,2-bisdiphenylphosphinoethane)nickel, methyl(1,2-bisdiphenylphosphinoethane)nickel tetrafluoroborate, (2-diphenylphosphino-1-phenylethyleneoxy)-phenylpyridinenickel, dichlorobistriphenylphosphinepalladium, dichlorodibenzonitrilepalladium, dichlorodiacetonitrilepalladium, dichloro(1,2-bisdiphenylphosphinoethane)palladium, bistriphenylphosphinepalladium bistetrafluoroborate, bis(2,2′-bipyridine)methyliron tetrafluoroborate and compounds shown below:

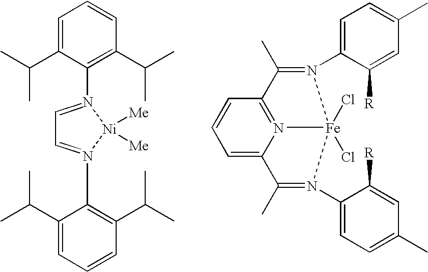

wherein Me represents methyl, and R represents methyl or isopropyl.

Among these compounds, preferably used are cationic complexes such as methyl(1,2-bisdiphenylphosphinoethane)nickel tetrafluoroborate, bistriphenylphosphinepalladium bistetrafluoroborate and bis(2,2′-bipyridine)methyliron tetrafluoroborate and the compounds represented by the formula shown above. In the catalyst of the above fourth aspect of the invention, the transition metal compounds of the component (B) may be used alone or in combination of two or more kinds thereof.

The olefin of the component (C) includes olefins and styrenes.

The olefins shall not specifically be restricted and is preferably α-olefin having 3 to 20 carbon atoms. This α-olefin includes, for example, linear or branched α-olefins such as propylene, 1-butene, 1-pentene, 1-hexene, 1-heptene, 1-octene, 1-nonene, 1-decene, 4-phenyl-1-butene, 6-phenyl-1-hexene, 3-methyl-1-butene, 4-methyl-1-butene, 3-methyl-1-pentene, 4-methyl-1-hexene, 5-methyl-1-hexene, 3,3-dimethyl-1-pentene, 3,4-dimethyl-1-pentene, 4,4-dimethyl-1-pentene and vinylcyclohexane, dienes such as 1,3-butadiene, 1,4-pentadiene and 1,5-hexadiene, halogen-substituted α-olefins such as hexafluoropropene, tetrafluoroethylene, 2-fluoropropene, fluoroethylene, 1,1-difluoroethylene, 3-fluoropropene, trifluoroethylene and 3,4-dichloro-1-butene and cyclic olefins such as cyclopentene, cyclohexene, norbornene, 5-methylnorbornene, 5-ethylnorbornene, 5-propylnorbornene, 5,6-dimethylnorbornene and 5-benzylnorbornene. The styrenes include styrene, alkylstyrenes such as p-methylstyrene, p-ethylstyrene, p-propylstyrene, p-isopropylstyrene, p-butylstyrene, p-t-butylstyrene, p-phenylstyrene, o-methylstyrene, o-ethylstyrene, o-propylstyrene, o-isopropylstyrene, m-methylstyrene, m-ethylstyrene, m-isopropylstyrene, m-butylstyrene, mesitylstyrene, 2,4-dimethylstyrene, 2,5-dimethylstyrene and 3,5-dimethylstyrene, alkoxystyrenes such as p-methoxystyrene, o-methoxystyrene and m-methoxystyrene, halogenated styrenes such as p-chlorostyrene, m-chlorostyrene, o-chlorostyrene, p-bromostyrene, m-bromostyrene, o-bromostyrene, p-fluorostyrene, m-fluorostyrene, o-fluorostyrene and o-methyl-p-fluorbstyrene, trimethylsilylstyrene, vinyl acetate and divinylbenzene.

In the above fourth aspect of the invention, the olefins of the component (C) may be used alone or in combination of two or more kinds thereof. When copolymerizing two or more kinds of the olefins, the olefins described above can optionally be combined.

In the above fourth aspect of the invention, the olefins described above may be copolymerized with the other monomers, and the other monomers used in this case can be given by, for example, linear dienes such as butadiene, isoprene, 1,4-pentadiene and 1,5-hexadiene, polycyclic olefins such as norbornene, 1,4,5,8-dimetano-1,2,3,4,4a, 5,8,8a-octahydronapthalene and 2-norbornene and cyclic diolefins such as norbornadiene, 5-ethylidenenorbornene, 5-vinylnorbornene and dicyclopentadiene.

In the above fourth aspect of the invention, the olefins of the component (C) are preferably those selected from ethylene, propylene, 1-olefins having 4 to 12 carbon atoms, cyclic olefins and styrene. Among them, any ones of ethylene, propylene, 1-butene, 1-hexene, 1-octene and styrene are more preferred, and ethylene and propylene are particularly suited.

An olefin unit content in the copolymer is preferably 70 to 99.9% by weight, particularly preferably 90 to 99.9% by weight. The production process of the above fourth aspect of the invention is a production process in which propylene is used as olefin and which is suited for obtaining a copolymer having a propylene unit content of 70% by weight or more in the copolymer.

The polar vinyl monomer of the component (D) shall not specifically be restricted, but it is preferably a compound represented by Formula (1C):

CH₂═CR^{1c}(CR^{2c}₂)_{g}X^{1c} (1C)

[wherein R^{1c} and R^{2c} represent a hydrogen atom or a hydrocarbon group having 1 to 10 carbon atoms; X^{1c} represents OH, OR^{3c}, NH₂, NHR^{3c}, NR^{3c}₂, COOH, COOR^{3c}, SH, Cl, F, I or Br (R^{3c} represents a hydrocarbon group having 1 to 10 carbon atoms or a functional group containing silicon or aluminum); and g is an integer of 0 to 20].

The hydrocarbon group having 1 to 10 carbon atoms include an alkyl group, an alkenyl group and an aryl group. The alkyl group includes methyl, ethyl, n-propyl, isopropyl, n-butyl, isobutyl, tert-butyl, n-hexyl and n-decyl, and in the above fourth aspect of the invention, the groups having 1 to 20 carbon atoms are preferred. The alkenyl group includes vinyl, 1-propenyl, 1-butenyl, 1-hexenyl, 1-octenyl and cyclohexenyl, and in the above fourth aspect of the invention, the groups having 2 to 10 carbon atoms are preferred. The aryl group includes phenyl, tolyl, xylyl and naphthyl, and in the above fourth aspect of the invention, the groups having 6 to 14 carbon atoms are preferred.

The functional group containing silicon includes trimethylsilyl, triethylsilyl, tri-t-butylsilyl and triisopropylsilyl. n is preferably 1 to 10.

In the above fourth aspect of the invention, the polar vinyl monomer shall not specifically be restricted, but it is particularly preferably a compound represented by Formula (1C′):

CH₂═CHCH₂X^{2c} (1C′)

[wherein X^{2c} represents OH, OR^{3c}, NH₂, NHR^{3c}, NR^{3c}₂ or SH (R^{3c} represents a hydrocarbon group having 1 to 10 carbon atoms or a functional group containing silicon or aluminum)].

Specific examples of the polar vinyl monomer include amines such as N-trimethylsilylallylamine, N-trimethylsilyl-3-butenylamine and N-trimethylsilyl-5-hexenylamine, alcohols such as allyl alcohol, 2-methyl-3-butene-2-ol, 3-butene-1-ol, 2-methyl-3-butene-1-ol, 4-pentene-1-ol, 5-hexene-1-ol, 6-heptene-1-ol, 7-octene-1-ol, 8-nonene-1-ol, 9-decene-1-ol and 10-undecene-1-ol and ethers such as allyl butyl ether, allyl ethyl ether, allyl benzyl ether, diallyl ether, 3-butenyl butyl ether and 3-butenyl benzyl ether.

When using the polar vinyl monomer having active hydrogen such as an OH group and an NH group, the polymerization activity can be increased by protecting it in advance with a functional group containing silicon or aluminum.

The polymerization reaction is carried out in the presence of a solvent such as hydrocarbon including butane, pentane, hexane, toluene and xylene and liquefied α-olefin or on the condition of no solvent. Although the more the use amount of the transition metal complex as component (B) to the layered compound as component (A) is, the more the activity per the catalyst weight is raised, from the viewpoint of practical use, a use amount of the transition metal complex is 0.1 to 100 micromole per 1 g of the layered compound. The polymerization temperature is −50 to 250° C., preferably a room temperature to 150° C. The pressure shall not specifically be restricted falls preferably an atmospheric pressure to 200 MPa. Further, hydrogen may be present as a molecular weight controlling agent in the polymerization system.

In the polymerization step, the selectivity of the copolymerization as well as the polymerization activity can be secured if satisfied is any condition of (i) suppressing a rise in an internal temperature caused by heat generated in a polymerization reaction bath to 15° C. or lower (preferably 10° C. or lower) and (ii) subjecting the polymerization catalyst in advance to pre-polymerization treatment with olefin.

In the polymerization, the following organic aluminum compound can be added if necessary. A compound (excluding trimethylaluminum) represented by the following Formula (7C) can be used as the organic aluminum compound:

R^{15c}ᵥAlQ³₃₋ᵥ (7C)

(wherein R^{15c} represents an alkyl group having 1 to 10 carbon atoms; Q³ represents a hydrogen atom, an alkoxy group having 1 to 20 carbon atoms, an aryl group having 6 to 20 carbon atoms or a halogen atom; and v is an integer of 1 to 3).

The specific examples of the compound represented by Formula (7C) include triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride and ethylaluminum sesquichloride. These organic aluminum compounds may be used alone or in combination of two or more kids thereof.

Also, the other organic aluminum compound includes aluminumoxy compounds. Examples of the aluminumoxy compound include linear aluminoxane represented by the following Formula (8C):

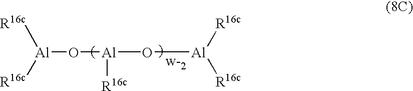

(wherein R^{16c} represents a hydrocarbon group such as an alkyl group having 1 to 20, preferably 2 to 12 carbon atoms, an alkenyl group and an arylalkyl group or a halogen atom; w represents an average polymerization degree and is usually an integer of 2 to 50, preferably 2 to 40; and respective R^{16c} may be the same or different) and cyclic aluminoxane represented by the following Formula (9C):

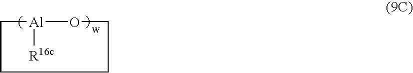

(wherein R^{16c} and w are the same as in Formula (8C) described above) The specific examples of the aluminoxane described above include ethylaluminoxane and isobutylaluminoxane.

In the above fourth aspect of the invention, the organic aluminum compound is preferably triethylaluminum, triisopropylaluminum or the compound represented by Formula (8C) described above in which at least one of R^{16c} is an alkyl group having 2 or more carbon atoms and in which the remainder of R^{16c} is an alkyl group having 1 to 10 carbon atoms. When trimethylaluminum and methylaluminoxane are used, the addition polymer becomes massive, and handling operation after the polymerization is likely to be difficult.

Next, the fifth aspect of the present invention shall be explained.

The fifth aspect of the invention relates to a catalyst for polymerizing a vinyl compound, a production process for the same, a process for polymerizing a vinyl compound using the polymerizing catalyst described above, a vinyl compound polymer obtained from the same and a composite resin and a composite resin composition comprising the above vinyl compound polymer.

The catalyst for polymerizing the vinyl compound in this fifth aspect of the invention comprises an alkenylsilane-treated product as component (X) obtained by treating a layered compound with alkenylsilane and a complex of a transition metal of Group 4 to Group 6 or Group 8 to Group 10 in the Periodic Table as component (Y).

Clay, a clay mineral or an ion-exchangeable layered compound can be described as the layered compound as the component (X) described above. The clay, the clay mineral and the ion-exchangeable layered compound described above are the same as explained in the first aspect of the invention described above.

Examples of the alkenylsilane used for treating this layered compound include a silane compound represented by Formula (1d):

R^{9d}₄₋ₙSiXₙ (1d)

(wherein R^{9d} represents a hydrocarbon-containing group, and at least one of them is a group having a carbon•carbon double bond; X represents a halogen atom or a group in which an element bonded directly to silicon is nitrogen or oxygen; n is an integer of 1 to 3; provided that when a plurality of R^{9d} is present, R^{9d} may be the same or different and that when a plurality of X is present, a plurality of X may be the same or different).

The specific examples thereof include vinyltrichlorosilane, vinylmethyldichlorosilane, vinylethyldichlorosilane, vinyloctyldichlorosilane, vinyldiphenylchlorosilane, allyltrichlorosilane, allylmethyldichlorosilane, allylethyldichlorosilane, allyl(2-cyclohexenyl-2-ethyl)dichlorosilane, allyldimethylchlorosilane, allylhexyldichlorosilane, allylphenyldichlorosilane, 5-(bicycloheptenyl)-methyldichlorosilane, 5-(bicycloheptenyl)-trichlorosilane, (2-(3-cyclohexenyl)ethyl)-methyldichlorosilane and (2-(3-cyclohexenyl)ethyl)-trichlorosilane.

Also, the specific examples include silane compounds obtained by substituting the halides in the compounds described above with an alkoxy group, an amino group and an amide group and a group of vinyl silicons (vinyl-terminal silicon oils) called reactive silicon.

Further, the specific examples of the alkenylsilane used in the present invention include a silane compound containing hydride represented by Formula (1d′):

CH₂═CH—(CH₂)ₖ—SiHₘR₃₋ₘ (1d′)

(wherein R is an alkyl group having 1 to 5 carbon atoms; k is an integer of 1 or more; and m is an integer of 1 to 3). Formula (1d′) represents, for example, allyldimethylsilane.

On the other hand, among the complexes of transition metal of Group 4 to Group 6 or Group 8 to Group 10 in the Periodic Table used as the component (Y), the preferred complexes of a transition metal of Group 4 to Group 6 in the Periodic Table can be nominated by compounds represented by the following Formulas (3C) to (5C), and the preferred complexes of transition metal of Group 8 to Group 10 in the Periodic Table may be compounds represented by the following Formula (6C):

Q¹ₐ(C₅H_{5-a-c}R^{7c}_{c})(C₅H_{5-a-c}R^{8c}_{c})M¹X³ₚY¹_{q} (3C)

Q²ₐ(C₅H_{5-a-d}R^{9c}_{d})Z¹M¹X³ₚY¹_{q} (4C)

M¹X⁴ᵣ (5C)

L^{1c}L^{2c}M²X⁴Y²ᵤ (6C)

These transition metal complexes are the same as explained in the component (B) in the fourth aspect of the invention described above.

In the above fourth aspect of the invention, the transition metal complexes of the component (Y) described above may be used alone or in combination of two or more kinds thereof.

In particular, the preferred complexes are the transition metal complexes represented by Formulas (3C) and (4C), and the complexes having ligands having indenyl, cyclopentadienyl and fluorenyl structures are preferred.

In the production process for the catalyst for polymerizing the vinyl compound of the above fifth aspect of the invention, the respective catalyst components described above are brought into contact in the following order. Operation after treatment of the layered compound with the alkenylsilane is advisably carried out in inert gas atmosphere.

First, the layered compound is added to water of an amount that is enough for preparing a colloid aqueous dispersion, preferably water of as large amount as 40 times the weight of the layered compound or more to prepare a colloid aqueous dispersion.

Next, the alkenylsilane is added to the colloid aqueous dispersion thus prepared and heated while stirring, whereby the layered compound is treated with the alkenylsilane. This treatment can be carried out at a temperature of −30 to 100° C., and it is preferably carried out at a temperature close to 100° C. in order to shorten time for preparing the catalyst.

This treating time is changeable depending on the kind of the layered compound used and the treating temperature, and it is 30 minutes to 10 hours.

A use proportion of the alkenylsilane used in this case is 0.001 to 1000, preferably 0.01 to 100 in terms of a mole number of a silicon atom per 1 kg of the layered compound.

When a mole number of this alkenylsilane is smaller than 0.001, a non-Newtonian property of the polymer of the vinyl compound is not raised or the mechanical characteristics such as a tensile characteristic are reduced. When it exceeds 1000, the polymerization activity is reduced in a certain case.

Thus, the colloid aqueous dispersion is turned into a slurry suspension by treating the colloid aqueous dispersion with the alkenylsilane. Water is added again to this slurry and washed, and it is filtrated through a filter and dried, whereby the compound can be obtained in the form of a solid matter.

Further, the alkenylsilane alone may be brought into contact with the layered compound, and it is preferably brought into contact with the layered compound using in combination with an organic silane compound.

When using in combination with the organic silane compound, it is preferably used in an amount of the same mole or more to the alkenylsilane. In bringing into contact with the layered compound, it may be treated at the same time or successively treated with the alkenylsilane and the organic silane compound. This treatment is preferably carried out in water, and it can be carried out in a gas phase.

The organic silane compound used in this case includes an organic silane compound represented by Formula (1e):

R^{10d}₄₋ₙSiXₙ (1e)

(wherein R^{10d} represents a hydrocarbon group having no carbon•carbon double bond; X represents a halogen atom or a group in which an element bonded directly to silicon is nitrogen or oxygen; and n is an integer of 1 to 3).

The specific compounds of the organic silane compound include, for example, trialkylsilyl chlorides such as trimethylsilyl chloride, triethylsilyl chloride, triisopropylsilyl chloride, t-butyldimethylsilyl chloride, t-butyldiphenylsilyl chloride and phenethyldimethylsilyl chloride, dialkylsilyl dichlorides such as dimethylsilyl dichloride, diethylsilyl dichloride, diisopropylsilyl dichloride, di-n-hexylsilyl dichloride, dicyclohexylsilyl dichloride, docosylmethylsilyl dichloride, bis(phenethyl)silyl dichloride, methylphenethylsilyl dichloride, diphenylsilyl dichloride, dimesitylsilyl dichloride and ditolylsilyl dichloride, alkylsilyl trichlorides such as methylsilyl trichloride, ethylsilyl trichloride, isopropylsilyl trichloride, t-butylsilyl trichloride, phenylsilyl trichloride and phenethylsilyl trichloride and silyl halides obtained by substituting a part of chloride in the compounds described above with the other halogen elements.

They include silanes having hydride such as dimethylchlorosilane, (N,N-diethylamino)-dimethylsilane and diisobutylchlorosilane, alkylsilyl hydroxides such as trimethylsilyl hydroxide, triethylsilyl hydroxide, triisopropylsilyl hydroxide, t-butyldimethylsilyl hydroxide, phenethyldimethylsilyl hydroxide, dicyclohexylsilyl dihydroxide and diphenylsilyl dihydroxide, and polysilanols which are called by a common name of peralkylpolysiloxypolyol.

The organic silane compound described above includes a bissilyl compound represented by Formula (1e′):

R^{10d}ₜX₃₋ₜSi(CH₂)ₛSiX₃₋ₜR^{10d}ₜ (1e′)

(wherein R^{10d} represents a hydrocarbon group having no carbon•carbon double bond; X represents a halogen atom or a group in which an element bonded directly to silicon is nitrogen or oxygen; s is an integer of 1 to 10, and t is an integer of 1 to 3), polynuclear polysiloxane and polysilazane.

The bissilyl compound includes bissilyls such as bis(methyldichlorosilyl)methane, 1,2-bis(methyldichlorosilyl)ethane, 1,2-bis(methyldichlorosilyl)octane and bis(triethoxysilyl)ethane.

The polynuclear polysiloxane includes cyclic polysiloxanes such as 1,3,5,7-tetramethyl-cyclotetrasiloxane, 1,3,5,7-tetraethyl-cyclotetrasiloxane and 1,3,5,7-tetramethyl-1,3,5,7-tetraphenyl-cyclotetrasiloxane and linear polysiloxanes such as 1,1,5,5-tetraphenyl-1,3,3,5-tetramethyltrisiloxane.

The polysilazane includes bis(trimethylsilyl)-amide, bis(triethylsilyl)amide, bis-(triisopropylsilyl)amide, bis(dimethylethylsilyl)-amide, bis(diethylmethylsilyl)amide, bis-(dimethylphenylsilyl)amide, bis(dimethyltolylsilyl)-amide and bis(dimethylmenthylsilyl)amide.

In the organic silane compound used in combination with the alkenylsilane, the substituent R^{10d} does not have preferably a nitrogen atom and a sulfur atom, and it is more preferably a hydrocarbon group.

In the above fifth aspect of the invention, an organic aluminum compound is preferably brought into contact with the alkenylsilane-treated product obtained by treating the layered compound with the alkenylsilane. In this case, a mole number of an aluminum atom in the organic aluminum compound per 1 kg of the alkenylsilane-treated product described above may be usually 0.1 to 1000, preferably 1 to 100. When this addition proportion is less than 0.1, the improving effect of the polymerization activity is not satisfactory. On the other hand, when it is an amount exceeding 1000, a rise in the activity corresponding to it is less liable to be obtained. In this contact treatment, it is suitably carried out by a method in which these both components are mixed by suspending or dissolving in an organic solvent such as, for example, pentane, hexane, heptane, toluene and xylene.

The organic aluminum compound used in this case includes the compound represented by Formula (7C) described above, to be specific, trimethylaluminum, triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride and ethylaluminum sesquichloride.

These organic aluminum compounds may be used alone or in combination of two or more kids thereof.

Also, the other organic aluminum compound includes aluminumoxy compounds. The linear aluminoxane represented by Formula (8C) described above or the cyclic aluminoxane represented by Formula (9C) described above can be described as the aluminumoxy compound.

The specific examples of the aluminoxanes described above include ethylaluminoxane and isobutylaluminoxane.

This organic aluminum compound is preferably triethylaluminum, triisobutylaluminum or the aluminumoxy compound represented by Formula (2) described above.

If trimethylaluminum and methylaluminoxane are used, the polymer becomes massive, and handling operation after the polymerization is difficult in a certain case.

Next, in bringing the alkenylsilane-treated product of the component (X) thus obtained into contact with the transition metal complex of the component (Y), a mole number of a metal atom contained in the transition metal complex per 1 kg of the alkenylsilane-treated product is suitably 0.0001 to 0.5, preferably 0.001 to 0.2. When this addition proportion of the transition metal complex is less than 0.0001, the improving effect of the polymerization activity is not satisfactory. On the other hand, when it exceeds 0.5, the polymerization activity per transition metal is reduced.

The vinyl compound of the component (Z) includes olefins, styrenes, acrylic acid derivatives and fatty acid vinyls.

Among the vinyl compounds described above, the same olefins and the styrenes as the examples in the fourth aspect of the invention described above are employable.

The acrylic acid derivatives include ethyl acrylate, butyl acrylate, methyl methacrylate and ethyl methacrylate.

The fatty acid vinyls include vinyl acetate, isopropenyl acetate and vinyl acrylate.

In the above fifth aspect of the invention, the vinyl compounds described above may be used alone or in combination of two or more kinds thereof. When two or more kinds of the vinyl compounds are copolymerized, the olefins described above can optionally be combined.

Further, in the present invention, the olefins described above may be copolymerized with the other monomers, and typical examples of the other monomers used in this case include, for example, linear dienes such as butadiene, isoprene, 1,4-pentadiene and 1,5-hexadiene, polycyclic olefins such as norbornene, 1,4,5,8-dimetano-1,2,3,4,4a,5,8,8a-octahydronapthalene and 2-norbornene, cyclic diolefins such as norbornadiene, 5-ethylidenenorbornene, 5-vinylnorbornene and dicyclopentadiene and unsaturated esters such as ethyl acrylate and methyl methacrylate.

The vinyl compound is preferably any of ethylene, propylene, 1-butene, 1-hexene, 1-octene and styrene, and among them, ethylene and propylene are particularly suited.

The polymerization reaction is carried out in the presence of a solvent such as hydrocarbon including butane, pentane, hexane, toluene and cyclohexane and liquefied α-olefin or on the condition of no solvent. The temperature is a room temperature to 200° C., and the pressure shall not specifically be restricted and falls preferably in a range of an atmospheric pressure to 200 MPa•G. Further, hydrogen may be present as a molecular weight controlling agent in the system.

When obtaining an olefin-based polymer, the polymerization condition that the layered compound is contained in a proportion of 0.001 to 20% by weight is preferably selected. When the layered compound has a larger content than this, the additional polymer composition is reduced in physical properties, and the layered compound is deteriorated in dispersing property. For example, when the polymer powder is molded into a film with a thickness of 1 mm by pressing, the lump of the layered compound is visually observed in the film.

When the polymerizing temperature is raised higher than 200° C., the layered compound is deteriorated in dispersing property, and it is not preferred. Accordingly, the polymerization is suitably carried out in a range of a room temperature to 200° C. Although the more the use amount of the transition metal complex to the layered compound is, the more the activity per the catalyst weight is raised, from the viewpoint of practical use, a use amount of the transition metal complex is 0.1 to 100 micromole per 1 g of the layered compound.

The alkenylsilane-treated product is uniformly dispersed in the composite resin comprising the vinyl compound polymer of the above fifth aspect of the invention and a thermoplastic resin.

The particles of this alkenylsilane-treated product have particularly preferably a particle diameter of 1 μm or smaller.

The thermoplastic resin used in the above fifth aspect of the invention includes polyolefin-based resins, styrene-based resins and acrylic acid-based resins.

The polyolefin-based resins include various polyethylenes, various polypropylenes, polybutadiene, polyisobutylene, polyisoprene, ethylene/acrylic acid copolymers, ethylene/methacrylic acid copolymers, ethylene/ethyl acrylic copolymers, ethylene/vinyl acetate copolymers, ethylene/vinyl alcohol copolymers and ethylene/vinyl acetate/vinyl alcohol ternary copolymers.

The styrene-based resins include various polystyrenes, styrene/acrylonitrile copolymers and acrylonitrile/butadiene/styrene ternary copolymers.

The acrylic acid-based resins include polymethyl acrylate and polyethyl acrylate.

The following additive components can be contained, if necessary, in the composite resin comprising the vinyl compound polymer of the above fifth aspect of the invention and the thermoplastic resin.

The additive components include, for example, an antioxidant, a flame retardant, a UV absorbent, a colorant, a reinforcing agent such as a filler and glass, a plasticizer, an antistatic agent and a lubricant, etc.

A blending amount of these components shall not specifically be restricted as long as it falls in a range where the characteristics of the composite resin of the above fifth aspect of the invention are maintained.

Next, a production process for the composite resin of the above fifth aspect of the invention shall be explained.

This composite resin is obtained by blending the vinyl compound polymer with the thermoplastic resin, further blending them with the additive components described above used if necessary in a prescribed proportion and the kneading them.

Blending and kneading in this case can be carried out by a method in which pre-mixing is carried out by means of an apparatus usually used, for example, a ribbon blender and a drum tumbler and in which used are a Banbury mixer, a single screw extruder, a dual screw extruder, a multi-screw extruder and a co-kneader.

The heating temperature in kneading is selected usually in a range of 150 to 300° C.

In this melting, kneading and molding, an extrusion molding machine, particularly a vent type extrusion-molding machine is preferably used.

In the above fifth aspect of the invention, provided as well is the composite resin composition comprising the copolymer of alkenylsilane and propylene and the layered compound, wherein the layered compound is dispersed in the copolymer in the form of a particle having a particle diameter of 1 μm or smaller.

Next, the present invention shall be explained in further details with reference to examples, but the present invention shall by no means be restricted by these examples.

### EXAMPLE 1

### (Production of Composite Resin Using Montmorillonite (Bengel))

(i) Preparation of Silane-Treated Clay Slurry A-1

A three neck flask having an internal volume of 10 liters was charged with 5 liters of distilled water, and 20 g of Na-montmorillonite (Bengel, available from HOJUN Yoko Co., Ltd.) was slowly added thereto while stirring by means of a stirrer. After addition, the mixture was stirred at a room temperature for one hour to prepare a clay colloid aqueous dispersion. Next, 8 milliliters of diethyldichlorosilane [(C₂H₅)₂SiCl₂] was slowly dropwise added to the clay colloid aqueous dispersion. After dropwise addition, the mixture was stirred at a room temperature for one hour, and then the temperature was raised up to 100° C. to stir the aqueous dispersion at the same temperature for 4 hours. During this period, the colloid dispersion was changed to a clay slurry liquid. This slurry liquid was subjected to filtration during heating by means of a pressurizer (using a membrane filter having an air pressure of 0.5 MPa and a membrane pore diameter of 3 μm). Time required for the filtration was 10 minutes.

The resulting filtered matter was dried at a room temperature, and 10 g of the dried filtered matter was suspended in 250 milliliters of toluene. Further, 250 milliliters of a toluene aqueous solution (0.5 mole/liter) of triisobutylaluminum was added thereto, and the solution was stirred at 100° C. for one hour to obtain a slurry. The slurry thus obtained was washed with toluene, and then toluene was added to adjust the whole amount of the liquid to 250 milliliters, whereby a silane-treated clay slurry A-1 was prepared.

(ii) Production of Composite Resin A-1

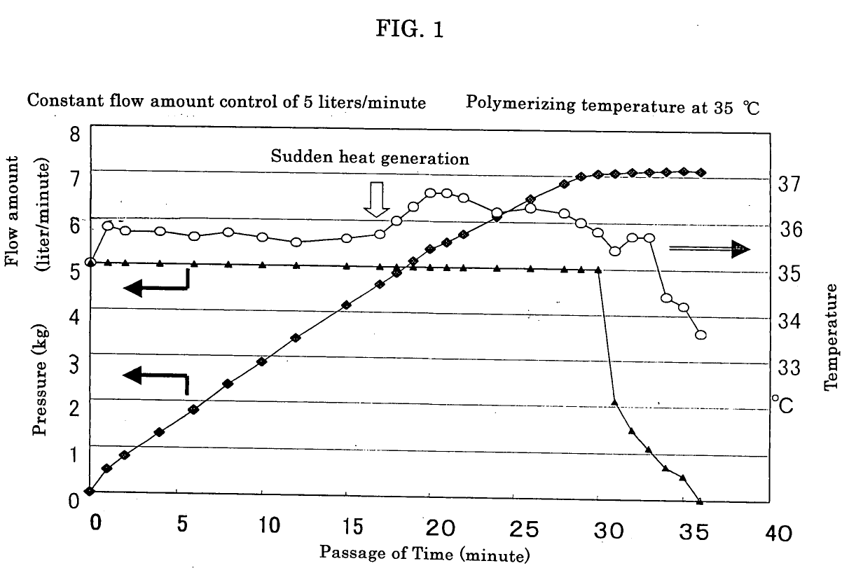

An autoclave having an internal volume of 1.6 liter was charged in order with 400 milliliters of heptane, 2.0 millimole of triisobutylaluminum and 25 milliliters (containing 1.0 g of the silane-treated clay) of the silane-treated clay slurry A-1 prepared in (1) described above, and the temperature was elevated to 35° C. The mixture was maintained at the same temperature for 5 minutes, and then added thereto was 2 milliliters of a solution (1 micromole/milliliter of heptane) of dimethylsilylenebis (2-methyl-4-phenylindenyl)-zirconium dichloride suspended in heptane. Then, the reaction pressure was slowly raised so that the inner temperature was settled in a range of 35 to 37° C. while continuously feeding propylene gas. When the reaction pressure reached 0.7 MPa (gauge pressure), the feeding rate of propylene was suppressed, and the polymerization was continued while maintaining the reaction pressure at 0.7 MPa (gauge pressure). Then, methanol was added at the timing when 36 minutes passed since the initiation of the polymerization and terminated the polymerization. The detailed profile of the polymerization reaction is shown in FIG. 1. In FIG. 1, the curve made of white small circles shows a change in the inner temperature of the autoclave. The curve made of black small squares shows a change in the internal pressure of the autoclave in terms of gauge pressure. This internal pressure was raised by pressingly introducing propylene up to 0.7 MPa (gauge pressure) as a settled pressure. The curve made of black small triangles shows a change in the amount of propylene fed into the autoclave. Propylene was fed at 5 liter/minute until the settled pressure was reached, and thereafter, the feeding amount was reduced.

Next, the polymer (polypropylene-based composite resin) thus obtained was separated by filtering and dried at 90° C. for 12 hours under reduced pressure. As a result thereof, 29.5 g of the composite resin A-1 was obtained. A content of the silane-treated clay in the composite resin A-1 was 3.4% by weight.

The composite resin A-1 (staying in a wet state of a heptane-methanol mixed solution) immediately after taken out from the autoclave was visually observed to find that the dots of the silane-treated clay (brown color) were not detected in the white polymer powder. That is, it was found that the polymerization proceeded evenly in the respective particles of the clay and that the intended composite resin was obtained.

### EXAMPLE 2

### (Production of Composite Resin Using Montmorillonite (Bengel))

(i) Production of Composite Resin A-2

An autoclave having an internal volume of 1.6 liter was charged in order with 400 milliliters of heptane, 1.0 millimole of triisobutylaluminum and 25 milliliters (containing 1.0 g of the silane-treated clay) of the silane-treated clay slurry A-1 prepared in (i) of Example 1, and the temperature was elevated to 50° C. The mixture was maintained at the same temperature for 5 minutes, and then added thereto was 2 milliliters of a solution (1 micromole/milliliter of heptane) of dimethylsilylenebis(2-methyl-4,5-benzoindenyl)-zirconium dichloride suspended in heptane. Then, the reaction pressure was slowly raised so that the inner temperature was settled in a range of 50 to 51° C. while continuously feeding propylene gas. When the reaction pressure reached 0.65 MPa (gauge pressure), that is, after 20 minutes passed since the initiation of the polymerization, propylene was stopped being introduced, and methanol was added to thereby terminate the polymerization. Then, the polymer (polypropylene-based composite resin) thus obtained was separated by filtering and dried at 90° C. for 12 hours under reduced pressure. As a result thereof, 23.8 g of the composite resin A-2 was obtained. The silane-treated clay in the composite resin A-2 had a content of 4.2% by weight.

The composite resin A-2 (staying in a wet state of a heptane-methanol mixed solution) immediately after taken out from the autoclave was visually observed to find that the dots of the silane-treated clay (brown color) were not detected in the white polymer powder. That is, it was found that the polymerization proceeded evenly in the respective particles of the clay and that the intended composite resin was obtained.

### EXAMPLE 3

### (Production of Composite Resin Using Montmorillonite (Kunipia F))

(i) Preparation of Silane-Treated Clay Slurry A-3

Treatment of clay with silane and triisobutylaluminum treatment were carried out in the same manner as in Example 1, except that in the preparation of the silane-treated clay slurry A-1 in (i) of Example 1, Na-montmorillonite was changed from Bengel available from HOJUN Yoko C., Ltd. to Kunipia F available from Kunimine Ind. Co., Ltd. Thus, a silane-treated clay slurry A-3 (1.0 g of silane-treated clay/25 milliliters of toluene) in which a slurry concentration was adjusted with toluene was obtained. Bengel available from HOJUN Yoko C., Ltd. is different from Kunipia F manufactured by Kunimine Ind. Co., Ltd. in the points that the former has a smaller particle diameter and that the latter has a higher content of montmorillonite.

(ii) Production of Composite Resin A-3

An autoclave having an internal volume of 1.6 liter was charged in order with 400 milliliters of heptane, 1.0 millimole of triisobutylaluminum and 25 milliliters (containing 1.0 g of the silane-treated clay) of the silane-treated clay slurry A-3 prepared in (i) described above, and the temperature was elevated to 70° C. The mixture was maintained at the same temperature for 5 minutes, and then added thereto was 2 milliliters of a solution (1 micromole/milliliter of heptane) of dimethylsilylenebis(2-methyl-4,5-benzoindenyl)-zirconium dichloride suspended in heptane. Then, the reaction pressure was slowly raised so that the inner temperature was settled in a range of 70 to 75° C. while continuously feeding propylene gas. When the reaction pressure reached 0.7 MPa (gauge pressure), that is, after 12 minutes passed since the initiation of the polymerization, propylene was stopped being introduced, and methanol was added to thereby terminate the polymerization. Then, the polymer (polypropylene-based composite resin) thus obtained was separated by filtering and dried at 90° C. for 12 hours under reduced pressure. As a result thereof, 20.8 g of the composite resin A-3 was obtained. The silane-treated clay in the composite resin A-3 had a content of 4.8% by weight.

The composite resin A-3 (staying in a wet state of a heptane-methanol mixed solution) immediately after taken out from the autoclave was visually observed to find that the dots of the silane-treated clay (brown color) were not detected in the white polymer powder. That is, it was found that the polymerization proceeded evenly in the respective particles of the clay and that the intended composite resin was obtained.

### EXAMPLE 4

### (Production of Composite Resin Using Synthetic Swelling Mica)

(i) Preparation of Silane-Treated Clay Slurry A-3

Treatment of clay with silane and triisobutylaluminum treatment were carried out in the same manner as in Example 1, except that in the preparation of the silane-treated clay slurry A-1 in (i) of Example 1, Na-montmorillonite was changed to Na-fluorine tetrasilicon mica [Synthetic swelling mica (NaMg_{2.5}Si₄O₁₀F₂, available from CO-OP Chemical Co., Ltd.)]. Thus, a silane-treated clay slurry A-4 (1.0 g of silane-treated clay/10 milliliters of toluene) in which a slurry concentration was adjusted with toluene was obtained.

(ii) Production of Composite Resin A-4

An autoclave having an internal volume of 1.6 liter was charged in order with 400 milliliters of heptane, 0.5 millimole of triisobutylaluminum and 25 milliliters (containing 1.0 g of the silane-treated clay) of the silane-treated clay slurry A-4 prepared in (i) described above, and the temperature was elevated to 70° C. The mixture was maintained at the same temperature for 5 minutes, and then added thereto was 0.6 milliliters of a solution (1 micromole/milliliter of heptane) of dimethylsilylenebis(2-methyl-4,5-benzoindenyl)-zirconium dichloride suspended in heptane. Then, the reaction pressure was slowly raised so that the inner temperature was settled in a range of 70 to 71° C. while continuously feeding propylene gas. When the reaction pressure reached 0.7 MPa (gauge pressure), the pressure was stopped being raised. Propylene was stopped being introduced after 18 minutes, and methanol was added to thereby terminate the polymerization. Next, the polymer (polypropylene-based composite resin) thus obtained was separated by filtering and dried at 90° C. for 12 hours under reduced pressure. As a result thereof, 26.3 g of the composite resin A-4 was obtained. The silane-treated clay in the composite resin A-4 had a content of 3.8% by weight.

The composite resin A-4 (staying in a wet state of a heptane-methanol mixed solution) immediately after taken out from the autoclave was visually observed to find that the dots of the silane-treated clay (yellow color) were not detected in the white polymer powder. That is, it was found that the polymerization proceeded evenly in the respective particles of the clay and that the intended composite resin was obtained.

### EXAMPLE 5

### (Physical Property Evaluation of the Composite Resin Using Montmorillonite (Bengel))

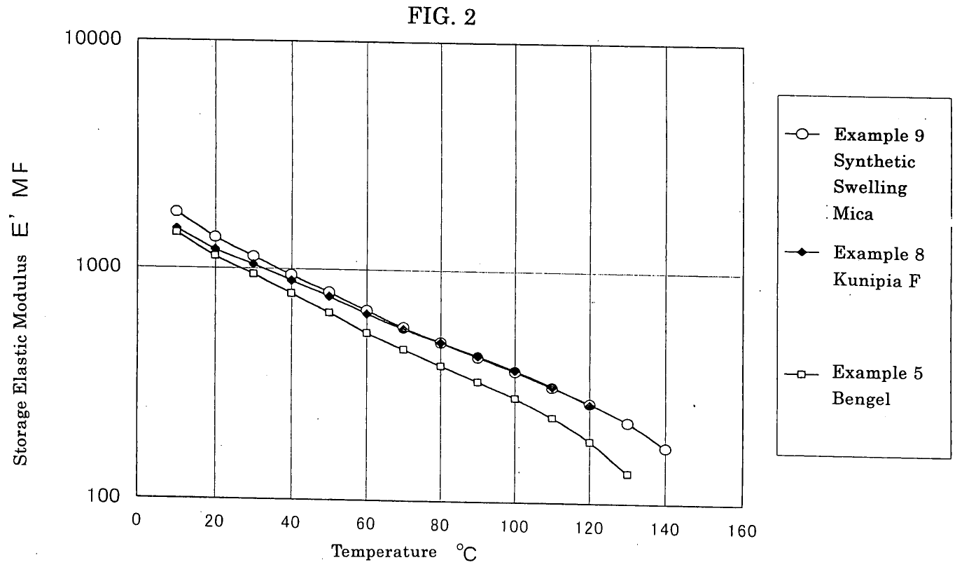

The composite resin A-1 produced in Example 1 was used and molded at a molding temperature of 230° C. to prepare a press sheet (width: 2 cm, length: 7 cm and thickness: 0.3 mm). Next, a sheet having a width of 4 mm and a length of 7 cm was cut out from the sheet prepared and measured for a solid viscoelasticity. A full automatic measuring type solid viscoelasticity measuring apparatus, viscoelasticity spectrometer, type VES-E-F-III produced by Iwamoto Seisakusho Co., Ltd., was used as the measuring apparatus. The sample size was set to 40 mm×4 mm×1 mm. The measurement was carried out on the conditions of a distortion displacement range of 0.02 mm, a chuck interval of 20 mm, an initial load of 9.8N, a frequency of 10 Hz, a starting temperature of 0° C. and a terminating temperature of 160° C. The measured data is shown in FIG. 2. To show the numerical value in order to clarify merits and demerits between the following examples and comparative examples, the storage elastic modulus at 50° C. was 652 MPa.

### EXAMPLE 6

### (Physical Property Evaluation of the Composite Resin Using Montmorillonite (Bengel))

A resin composition prepared by blending 5 g of the composite resin A-1 produced in Example 1 with 7000 ppm (35 mg) of a phenol derivative (Irganox 1010, available from Ciba Specialty Chemicals KK) was molded at a molding temperature of 230° C. to prepare a press sheet (width: 2 cm, length: 7 cm and thickness: 0.3 mm). Then, the press sheet was measured for a solid viscoelasticity on the same evaluation conditions as in Example 5. As a result thereof, the storage elastic modulus at 50° C. was 816 MPa.

### EXAMPLE 7

### (Physical Property Evaluation of the Composite Resin Using Montmorillonite (Kunipia F))

A press sheet (width: 2 cm, length: 7 cm and thickness: 0.3 mm) was prepared in the same manner as in Example 6, except that in Example 6, a blending amount of the phenol derivative (Irganox 1010, available from Ciba Specialty Chemicals KK) was changed from 35 mg to 105 mg. Then, the press sheet was measured for a solid viscoelasticity on the same evaluation conditions as in Example 5. As a result thereof, the storage elastic modulus at 50° C. was 939 MPa.

### EXAMPLE 8

### (Physical Property Evaluation of the Composite Resin Using Montmorillonite (Kunipia F))

The composite resin A-3 produced in Example 3 was used and molded at a molding temperature of 230° C. to prepare a press sheet (width: 2 cm, length: 7 cm and thickness: 0.3 mm). Then, the press sheet was measured for a solid viscoelasticity on the same evaluation conditions as in Example 5. As a result thereof, the storage elastic modulus at 50° C. was 765 MPa. The measured data was shown together in FIG. 2.

### COMPARATIVE EXAMPLE 1

### (Physical Property Evaluation of the Composite Resin Using Montmorillonite (Kunipia F))

(i) Production of Composite Resin B-1

In Example 3, the polymerization solvent was changed from heptane to toluene, and an amount of the silane-treated clay slurry A-1 was changed from 25 milliliters (containing 1.0 g of the silane-treated clay) to 2.5 milliliters (containing 0.1 g of the silane-treated clay). Then, a pressure of propylene gas was stopped being raised when the polymerization pressure reached 0.7 MPa (gauge pressure), and the polymerization reaction was carried out under the same pressure for one hour while continuously introducing propylene gas. As a result thereof, the polymer (composite resin B-1) thus obtained had a yield of 102.2 g. Accordingly, a content of the silane-treated clay in the resin was 0.1% by weight by calculation.

(ii) Evaluation of Viscoelasticity

The press sheet of the composite resin B-1 was prepared on the same conditions as in Example 8 to measure a solid viscoelasticity. As a result thereof, the storage elastic modulus at 50° C. was 554 MPa.

### EXAMPLE 9

### (Production of Composite Resin Using Synthetic Swelling Mica)

The composite resin A-4 produced in Example 4 was used to prepare a press sheet on the same conditions as in Example 5 to measure a solid viscoelasticity. The measured data was shown together in FIG. 2. The storage elastic modulus at 50° C. was 798 MPa.

### EXAMPLE 10

### (Physical Property Evaluation of Resin Composition Using Synthetic Swelling Mica)

A resin composition prepared by blending 5 g of the composite resin A-4 produced in Example 4 with 7000 ppm (35 mg) of the phenol derivative (Irganox 1010, available from Ciba Specialty Chemicals KK) was molded at a molding temperature of 230° C. to prepare a press sheet (width: 2 cm, length: 7 cm and thickness: 0.3 mm). Then, the press sheet was measured for a solid viscoelasticity on the same evaluation conditions as in Example 5. As a result thereof, the storage elastic modulus at 50° C. was 972 MPa.

### PRODUCTION EXAMPLE 1

### (Production of Composite Resin I Using Synthetic Swelling Mica)

(i) Preparation of Silane-Treated Clay Slurry

A three neck flask having an internal volume of 5 liters was charged with 4 liters of distilled water, and 20 g of Na-fluorine tetrasilicon mica (available from CO-OP Chemical Co., Ltd.) was slowly added thereto while stirring by means of a stirrer. After addition, the mixture was stirred at a room temperature for one hour to prepare a clay colloid aqueous dispersion. Next, 8 milliliters of diethyldichlorosilane [(C₂H₅)₂SiCl₂] was slowly dropwise added to the clay colloid aqueous dispersion. After dropwise addition, stirring was continued at a room temperature for one hour, and then the temperature was raised up to 100° C. to stir the aqueous dispersion at the same temperature for 4 hours. During this period, the colloid dispersion was changed to a clay slurry liquid. This slurry liquid was subjected to filtration during heating by means of a pressurizer (using a membrane filter having an air pressure of 0.5 MPa and a membrane pore diameter of 3 μm). Time required for filtration was 7 minutes.

The resulting filtered matter was dried at a room temperature, and 10 g of the dried filtered matter was suspended in 250 milliliters of toluene. Further, 250 milliliters of a toluene aqueous solution (0.5 mole/liter) of triisobutylaluminum was added thereto, and the solution was stirred at 100° C. for one hour to obtain slurry. The slurry thus obtained was washed with toluene, and then toluene was added to adjust the whole amount of the liquid to 100 milliliters, whereby silane-treated clay slurry was prepared.

(ii) Production of Resin Composition I

An autoclave having an internal volume of 1.6 liter was charged in order with 400 milliliters of toluene, 0.5 millimole of triisobutylaluminum and 10 milliliters (containing 1.0 g of the silane-treated clay) of the silane-treated clay slurry prepared in (i) described above, and the temperature was elevated to 70° C. The mixture was maintained at the same temperature for 5 minutes, and then added thereto was 0.6 milliliters of a solution (1 micromole/milliliter of heptane) of dimethylsilylenebis(2-methyl-4,5-benzoindenyl)-zirconium dichloride suspended in heptane. Then, the reaction pressure was slowly raised so that the inner temperature was settled in a range of 70 to 71° C. while continuously feeding propylene gas. When the reaction pressure reached 0.7 MPa (gauge pressure), the pressure was stopped being raised. Propylene gas was stopped being introduced after 18 minutes, and methanol was added to thereby terminate the polymerization. Next, the polymer (resin composition) thus obtained was separated by filtering and dried at 90° C. for 12 hours under reduced pressure. As a result thereof, 26.3 g of the resin composition I was obtained. The silane-treated clay in the resin composition I had a content of 3.8% by weight.

The resin composition I (staying in a wet state of a toluene-methanol mixed solution) immediately after taken out from the autoclave was visually observed to find that the dots of the silane-treated clay (yellow color) were not detected in the white polymer powder. That is, it was found that the polymerization proceeded evenly in the respective particles of the clay and that the composite resin was obtained.

### PRODUCTION EXAMPLE 2

### (Production of Resin Composition II Using Synthetic Swelling Mica)

The reaction pressure was slowly raised in the same manner as in (ii) of Production Example 1 so that the inner temperature was settled in a range of 70 to 71° C. while introducing propylene gas. When the reaction pressure reached 0.7 MPa (gauge pressure), propylene was stopped being fed, and methanol was immediately added to thereby terminate the polymerization. Next, the polymer (resin composition) thus obtained was separated by filtering and dried at 90° C. for 12 hours under reduced pressure. As a result thereof, 20.1 g of the resin composition II was obtained. The silane-treated clay in the resin composition II had a content of 5.0% by weight.

The resin composition II (staying in a wet state of a toluene-methanol mixed solution) immediately after taken out from the autoclave was visually observed to find that the dots of the silane-treated clay (yellow color) were not detected in the white polymer powder. That is, it was found that the polymerization proceeded evenly in the respective particles of the clay and that the composite resin was obtained.

### EXAMPLE 11

### (Composite Resin Blended with Fatty Acid Calcium Salt)

The resin composition I obtained in Production Example 1 in an amount of 100 parts by weight was mixed with one part by weight of calcium distearate [CH₃(CH₂)₁₆COOH]₂Ca, and this was molded at a molding temperature of 230° C. to prepare a press sheet (width: 2 cm, length: 7 cm and thickness: 0.3 mm). Next, a sheet having a width of 4 mm and a length of 7 cm was cut out from the sheet prepared, and a solid viscoelasticity of the press sheet was measured on the same evaluation conditions as in Example 5. The storage elastic moduli at 20° C., 50° C. and 140° C. were 1550 MPa, 860 MPa and 185 MPa respectively.

### EXAMPLE 12

### (Composite Resin Blended with Fatty Acid Aluminum Salt)

A press sheet was prepared in the same manner as in Example 11 and measured for a solid viscoelasticity in the same manner, except that in Example 11, aluminum distearate [CH₃(CH₂)₁₆COOH]₂AlOH was substituted for calcium distearate. The storage elastic moduli at 20° C., 50° C. and 140° C. were 1590 MPa, 882 MPa and 192 MPa respectively.

### EXAMPLE 13

### (Composite Resin Blended with Fatty Acid Aluminum Salt)

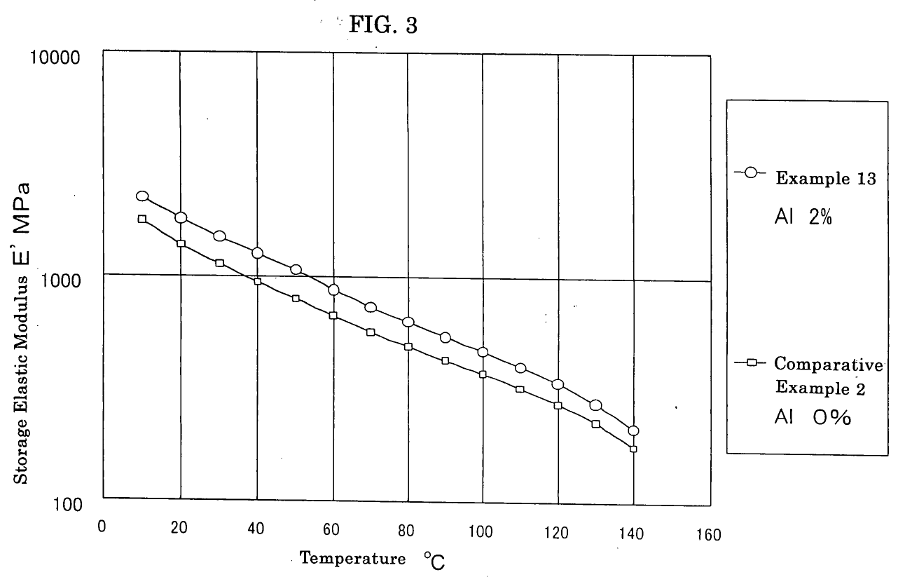

A press sheet was prepared in the same manner as in Example 12 and measured for a solid viscoelasticity in the same manner and measured for a solid viscoelasticity in the same manner, except that in Example 12, an addition amount of aluminum distearate was changed from one part by weight to 2 parts by weight. The measured data is shown in FIG. 3. The storage elastic moduli at 20° C., 50° C. and 140° C. were 1800 MPa, 1070 MPa and 213 MPa respectively.

### COMPARATIVE EXAMPLE 2

### (Composite Resin Blended with No Metal Salt Compound)

A press sheet was prepared in the same manner as in Example 12 and measured for a solid viscoelasticity in the same manner, except that in Example 12, aluminum distearate [CH₃(CH₂)₁₆COOH]₂AlOH was not blended. The measured data is shown together in FIG. 3. The storage elastic moduli at 20° C., 50° C. and 140° C. were 1270 MPa, 798 MPa and 176 MPa respectively.

### EXAMPLE 14

### (Composite Resin Blended with Aromatic Carboxylic Acid Aluminum Salt)

The resin composition II obtained in Production Example 2 in an amount of 100 parts by weight was kneaded with one part by weight of aluminum p-t-butylbenzoate [C₄H₉C₆H₄COOH]₂AlOH on the conditions of. 210° C., 50 revolutions/minute and 5 minutes by means of a plastomill. The kneaded matter thus obtained was used to prepare a press sheet in the same manner as in Example 11, and the solid viscoelasticity was measured in the same manner. The storage elastic moduli at 20° C., 50° C. and 140° C. were 2150 MPa, 1400 MPa and 328 MPa respectively.

### COMPARATIVE EXAMPLE 3

### (Composite Resin Absent of the Addition of Metal Salt Compound)

A press sheet was prepared in the same manner as in Example 14 and measured for a solid viscoelasticity in the same manner and measured for a solid viscoelasticity in the same manner, except that in Example 14, aluminum p-t-butylbenzoate [C₄H₉C₆H₄COOH]₂AlOH was not blended. The storage elastic moduli at 20° C., 50° C. and 140° C. were 2120 MPa, 1270 MPa and 292 MPa respectively.

### PRODUCTION EXAMPLE 3

### (Production of Synthetic Mica-Containing Polyolefin-Based Composite Resin I)

(i) Preparation of Silane-Treated Layered Compound Slurry I

A three neck flask having an internal volume of 5 liters was charged with 4 liters of distilled water, and 20 g of fluorine tetrasilicon mica (ME-100 (interlayer: Na ion), available from CO-OP Chemical Co., Ltd.) was slowly added thereto while stirring. After adding, the mixture was stirred at a room temperature for one hour to prepare a layered compound colloid aqueous dispersion. Next, 8 milliliters of diethyldichlorosilane [(C₂H₅)₂SiCl₂] was slowly dropwise added to the layered compound colloid aqueous dispersion. After dropwise addition, stirring was continued at a room temperature for one hour, and then the temperature was raised up to 100° C. to stir the aqueous dispersion at the same temperature for 4 hours. During this period, the colloid dispersion was changed to a slurry solution. This slurry solution was subjected to filtration during heating by means of a pressurizer (using a membrane filter having an air pressure of 0.5 MPa and a membrane pore diameter of 3 μm). Time required for filtration was 7 minutes.

The resulting filtered matter was dried at a room temperature, and 10 g of the dried filtered matter was suspended in 250 milliliters of toluene. Further, 250 milliliters of a toluene aqueous solution (0.5 mole/liter) of triisobutylaluminum was added thereto, and the solution was stirred at 100° C. for one hour to obtain slurry. The slurry thus obtained was washed with toluene, and then toluene was added to adjust the whole amount of the liquid to 100 milliliters, whereby a silane-treated layered compound slurry I was prepared.

(ii) Production of Composite Resin I

An autoclave having an internal volume of 1.6 liters was charged in order with 400 milliliters of toluene, 0.5 millimole of triisobutylaluminum and 10 ml (containing 1.0 g of the silane-treated layered compound) of the silane-treated layered compound slurry I prepared in (i) described above, and the temperature was elevated to 70° C. The mixture was maintained at the same temperature for 5 minutes, and then added thereto was 0.6 milliliters of a solution (1 micromole/milliliter of heptane) of dimethylsilylenebis(2-methyl-4,5-benzoindenyl)zirconium dichloride suspended in heptane. Then, the reaction pressure was slowly raised so that the inner temperature was settled in a range of 70 to 71° C. while continuously feeding propylene gas. When the reaction pressure reached 0.7 MPa (gauge pressure), propylene gas was stopped being fed, and methanol was immediately added to thereby terminate the polymerization. Next, the polymer (composite resin) thus obtained was separated by filtering and dried at 90° C. for 12 hours under reduced pressure. As a result thereof, 20.1 g of the composite resin I was obtained. The silane-treated layered compound in the composite resin I had a content of 5.0% by weight.

The composite resin I (staying in a wet state of a toluene-methanol mixed solution) immediately after taken out from the autoclave was visually observed to find that the dots of the silane-treated layered compound (yellow color) were not detected in the white polymer powder. That is, it was found that the polymerization proceeded evenly in the respective particles of the layered compound and that the composite resin was obtained.

### PRODUCTION EXAMPLE 4

### (Production of Synthetic Mica-Containing Polyolefin-Based Composite Resin II)

(i) Preparation of Silane-Treated Layered Compound Slurry II

In (i) of Production Example 3, 25 g of Na-fluorine tetrasilicon mica and 10 milliliters of diethyldichlorosilane were used to carry out reaction. Next, 25 g of a silane-treated layered compound obtained by filtering was treated in a toluene solution of triisobutylaluminum in the same manner to prepare 500 milliliters of a silane-treated layered compound slurry II.

(ii) Production of Composite Resin II

An autoclave having an internal volume of 5.0 liters was charged in order with 2.3 liters of toluene, 2.0 millimole of triisobutylaluminum and 200 milliliters (containing 10.0 g of the silane-treated layered compound) of the silane-treated layered compound slurry II prepared in (i) described above, and the temperature was elevated to 70° C. The mixture was maintained at the same temperature for 5 minutes, and then added thereto was 6.0 milliliters of a solution (1 micromole/milliliter of heptane) of dimethylsilylenebis(2-methyl-4,5-benzoindenyl)zirconium dichloride suspended in heptane. Then, the reaction pressure was slowly raised so that the inner temperature was settled in a range of 70 to 71° C. while continuously feeding propylene gas. When 30 minutes passed since the reaction pressure reached 0.7 MPa (gauge pressure), propylene gas was stopped being fed, and methanol was immediately added to thereby terminate the polymerization. Next, the polymer (composite resin) thus obtained was separated by filtering and dried at 90° C. for 12 hours under reduced pressure. As a result thereof, 244 g of the composite resin II was obtained. The silane-treated layered compound in the composite resin II had a content of 4.1% by weight.

The composite resin II (staying in a wet state of a toluene-methanol mixed solution) immediately after taken out from the autoclave was visually observed to find that the dots of the silane-treated layered compound (yellow color) were not detected in the white polymer powder. That is, it was found that the polymerization proceeded evenly in the respective particles of the layered compound and that a composite resin was obtained.

### EXAMPLE 15

The powder 20 g of the composite resin I prepared in Production Example 3 was weighed, and a shearing force was worked thereon under heating by means of a lab plastomill (roller mixer R30: chamber capacity about 30 milliliters) produced by Toyo Seiki Mfg. Co., Ltd.) (kneading conditions: 210° C., 50 revolutions/minute, 5 minutes). This shear-treated matter was hot-pressed at a molding temperature of 230° C. to prepare a sheet having a width of 1.5 cm, a length of 4.0 cm and a thickness of 1.0 mm. Next, a sheet having a width of 4 mm and a length of 4.0 cm was cut out from the sheet prepared, and a solid viscoelasticity of the press sheet was measured on the same evaluating conditions as in Example 5.

The measured results of the storage elastic moduli at 20 and 140° C. are shown in Table 1.

### EXAMPLE 16

The solid viscoelasticity was measured in the same manner as in Example 15, except that the powder of the composite resin II prepared in Production Example 4 was used.

The measured results of the storage elastic moduli at 20 and 140° C. are shown in Table 1.

### EXAMPLE 17

The solid viscoelasticity was measured in the same manner as in Example 16, except that in Example 16, the kneading conditions were changed to 200° C., 110 revolutions/minute and 5 minutes.

The measured results of the storage elastic moduli at 20 and 140° C. are shown in Table 1.

### EXAMPLE 18

The solid viscoelasticity was measured in the same manner as in Example 16, except that in Example 16, 20 g of the powder of the composite resin was kneaded with 0.2 g of di(p-t-butylbenzoic acid) aluminum hydroxide [C₄H₉C₆H₄COOH]₂AlOH] which was a metal salt compound.

The measured results of the storage elastic moduli at 20 and 140° C. are shown in Table 1.

### COMPARATIVE EXAMPLE 4

### (System in which a Shearing Force was not Worked under Heating)

The powder of the composite resin I prepared in Production Example 3 was filled into a metal mold having 7 cm square and a thickness of 2 mm and molded at 5 MPa. This molded article obtained by compression-molding was hot-pressed at a molding temperature of 230° C. to prepare a sheet having a width of 1.5 cm, a length of 4.0 cm and a thickness of 1.0 mm. Next, a sheet having a width of 4 mm and a length of 4.0 cm was cut out from the sheet prepared to measure a solid viscoelasticity in the same manner. The measured results of the storage elastic moduli at 20 and 140° C. are shown in Table 1.

### COMPARATIVE EXAMPLE 5

### (System in which the Layered Compound was not Used and in which a Shearing Force was Worked)

An autoclave having an internal volume of 1.6 liters was charged in order with 400 milliliters of toluene and a toluene solution (1.0 millimole in terms of Al) of methylaluminoxane, and the temperature was elevated to 70° C. The mixture was maintained at the same temperature for 5 minutes, and then added thereto was 2.0 milliliters of a solution (1 micromole/milliliter of heptane) of dimethylsilylenebis(2-methyl-4,5-benzoindenyl)-zirconium dichloride suspended in heptane. Then, the reaction pressure was slowly raised so that the inner temperature was settled in a range of 70° C. while continuously feeding propylene gas. When the reaction pressure reached 0.7 MPa (gauge pressure), the polymerization was carried out for 70 minutes.

The polymer (composite resin) thus obtained was separated by filtering and dried at 90° C. for 12 hours under reduced pressure. As a result thereof, 49 g of the composite resin III was obtained.

Next, the solid viscoelasticity was measured in the same manner as in Example 15, except that the powder of this composite resin III was used.

The measured results of the storage elastic moduli at 20 and 140° C. are shown in Table 1.

TABLE 1

| | | | Fluorine | Storage elastic | |
|---|---|---|---|---|---|
| | Shearing | Kneading | tetrasilicon | modulus MPa | |
| | action | revolution/ | mica | 20° | |
| | in heating | min | (weight %) | C. | 140° C. |
| Example 15 | Present | 50 | 5.0 | 2,170 | 297 |
| Example 16 | Present | 50 | 4.1 | 2,100 | 267 |
| Example 17 | Present | 110 | 4.1 | 2,220 | 293 |
| Example 18 | Present | 50 | 4.1 | 2,390 | 325 |
| Comparative | None | 0 | 5.0 | 1,310 | 176 |
| Example 4 | | | | | |
| Comparative | Present | 50 | 0.0 | 1,730 | 213 |
| Example 5 | | | | | |

### EXAMPLE 19

(i) Preparation of Silane-Treated Layered Compound

A three neck flask having an internal volume of 5 liters was charged with 4 liters of distilled water, and 25 g of a layered compound (Synthetic swelling mica; Na-fluorine tetrasilicon mica, brand name: Somashif ME-100, charge: 0.6, available from CO-OP Chemical Co., Ltd.) was slowly added thereto while stirring. After adding, the layered compound suspension was stirred at a room temperature for one hour. Next, 5 milliliters of diethyldichlorosilane [(C₂H₅)₂SiCl₂] was slowly added to this suspension. After addition, stirring was continued at a room temperature for one hour, and then the temperature was raised up to 100° C. to stir the suspension at the same temperature for 3 hours. During this period, the suspension was changed to precipitable hydrophobic slurry. This hydrophobic slurry was subjected to filtration during heating by means of a pressurizer (using a membrane filter having an air pressure of 0.5 MPa and a membrane pore diameter of 3 μm) . Time required for filtration was 7 minutes.

The resulting filtered matter was dried at a room temperature, and 25 g of this filtered matter was suspended in 250 milliliters of toluene. Further, 160 milliliters of a toluene aqueous solution (1.0 mole/liter) of triisobutylaluminum was slowly added thereto, and after addition, the temperature was elevated up to 100° C. The solution was stirred at the same temperature for one hour. The aluminum-treated slurry thus obtained was washed with toluene, and then toluene was added to adjust the whole amount of the liquid to 500 milliliters, whereby a silane-treated layered compound slurry was obtained.

(ii) Copolymerization of Propylene with N-trimethylsilylallylamine Using the Silane-Treated Layered Compound Slurry

A three neck flask having an internal volume of 1.6 liters was charged in order with 400 milliliters of dried toluene, 0.5 millimole of triisobutylaluminum, 20 milliliters (1.0 g of the silane-treated layered compound) of the silane-treated layered compound slurry prepared in (i) described above and 0.5 millimole of N-trimethylsilylallylamine [(CH₂═CHCH₂NHSi(CH₃)₃), and the temperature was elevated to 70° C. Next, the pressure was raised while continuously feeding propylene gas to maintain the internal pressure at 0.7 MPa (gauge pressure). Then, 2 milliliters of a solution (1 micromole/milliliter of heptane) of dimethylsilylenebis(2-methyl-4,5-benzoindenyl)zirconium dichloride suspended in heptane was added to the polymerization system while maintaining the inner temperature at 70° C. Propylene was continued to be fed while maintaining the polymerization pressure at 0.7 MPa and the inner temperature at 70° C. to carry out the polymerization. When 2 hours passed since starting the polymerization, methanol was added to the polymerization system to terminate the polymerization. Next, the product was separated by filtering and dried at 90° C. for 12 hours under reduced pressure. As a result thereof, 146 g of a copolymer in terms of a dry weight was obtained. The silane-treated layered compound in the copolymer had a content of 0.68% by weight, and the polymerization activity was 802 kg/g of Zr.

(iii) Confirming Test of Functional Group Introduction

A solution of 23 g of the copolymer obtained in (ii) described above and 10 milliliters of trichlorobenzene was heated to a temperature of 150° C., and the insoluble layered compound was filtered off through a filter (mesh 5 μm). The filtrate was added to 300 milliliters of methanol while stirring to re-precipitate the dissolved polymer. Next, the precipitated polymer was filtered off through a filter having a mesh of 0.2 μm and dried under vacuum at 90° C. for 4 hours.

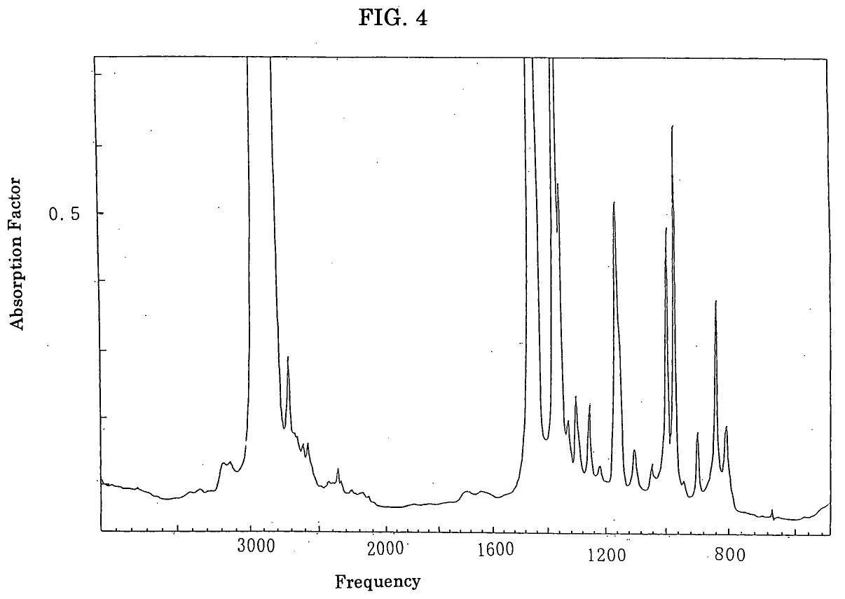

Next, an infrared absorption spectral apparatus was used to confirm the presence of primary amine contained in the copolymer by a characteristic absorption spectrum. An infrared spectrum of polypropylene containing primary amine is shown in FIG. 4. Antisymmetric stretching vibration and symmetric oscillation of NH₂ appeared in 3414 cm⁻¹ and 3347 cm⁻¹ respectively, and scissor vibration of NH₂ appeared in 1642 cm⁻¹. Accordingly, it was found that the copolymerization of allylamine with propylene proceeded. The N-trimetylsilyl group was reacted with methanol in treating the copolymer with methanol to liberate free amine.

(iv) Distribution Measurement of Allylamine Unit in the Copolymer

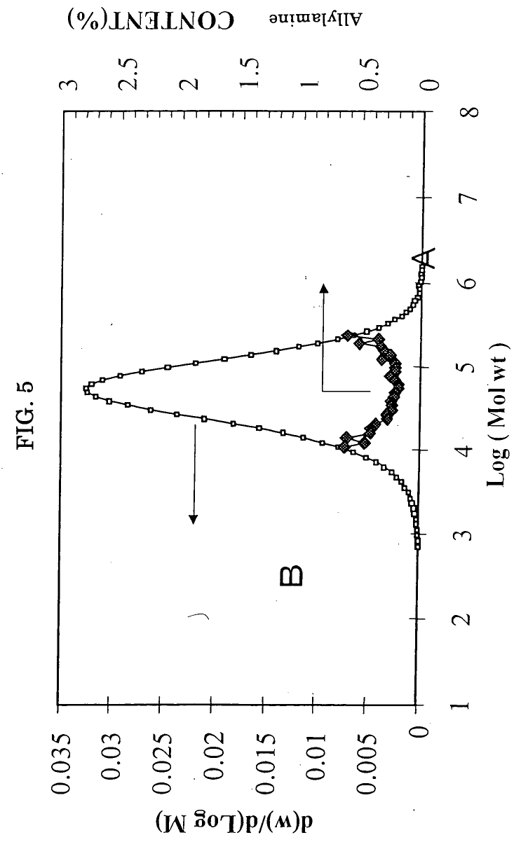

A solution obtained by dissolving 22 mg of the copolymer obtained in (ii) described above in 10 milliliters of trichlorobenzene was heated to a temperature of 150° C., and the insoluble layered compound was filtered off through a filter (mesh 5 μm). Then, the filtrate was subjected to a GPC-FTIR apparatus (gel permeation chromatography Fourier transform infrared apparatus). An apparatus in which a GPC main body was coupled with an FTIR main body through a transfer tube and a flow cell was used as the GPC-FTIR. The molecular weight distribution of the copolymer described above and the composition distribution of the allylamine unit in the copolymer were measured in accordance with the following methods. The measured results are shown in FIG. 5. In FIG. 5, A shows the contents of the allylamine units in the polymers of the respective molecular weights, and B shows the molecular weight distribution of the resin.

It can be found from FIG. 5 that the allylamine unit contained in the polymer is distributed extending over the respective molecular weights and that the copolymerization of propylene with allylamine proceeds.

(a) Measuring Apparatus

GPC main body: high temperature GPC column oven produced by GL Sciences Inc.

FTIR: Nicolet OMNIC E. S. P and

Nicolet SPEC-FTIR Ver. 2. 10. 2

(b) Measuring Conditions

Solvent: 1,2,4-trichlorobenzene, measuring temperature: 145° C., flow rate: 1.0 milliliter/minute; sample concentration: 0.3 (w/v); sample injection amount: 1.000 millilters; and GPC column: Shodex UT806MLT 2 columns.

(c) Measuring Conditions of FTIR

Type of detector: MCT detector, resolution of IR spectrum: 4 cm⁻¹; scanning frequency of 1 data (IR spectrum): 13 scan; and receiving time of 1 data (IR spectrum): receiving 1 data every 10.8 seconds.

(d) Measurement of Molecular Weight Distribution Curve, Mw (Weight Average Molecular Weight) and Mn (Number Average Molecular Weight)

A chromatograph was obtained by means of the GPC-FTIR described above, and this chromatograph was subjected to data analysis by means of a data analysis software for GPC-FTIR (Nicolet SPEC-FTIR Ver. 2. 10. 2) to thereby determine the molecular weight distribution curve [log₁₀ M to d (w)/d (log₁₀ M)], the weight average molecular weight Mw and the number average molecular weight Mn. The molecular weights were calculated according to a standard calibration curve prepared using standard polystyrene available from Toso Co., Ltd. All of the molecular weights were determined based on a Q value method in terms of a polypropylene amount.

(e) Measurement of Allylamine Composition Curve

The data analysis software for GPC-FTIR was used to calculate an amount of allylamine (measured according to an intensity ratio of methyl to methylene in the copolymer) which was copolymerized with propylene, and the composition curve of the allylamine unit was prepared from this calculated value.

### COMPARATIVE EXAMPLE 6

(i) Copolymerization of Propylene with N-trimethylsilylallylamine Using Methylaluminoxane

Propylene was copolymerized with N-trimethylsilylallylamine in the same manner as in (ii) of Example 19, except that in (ii) of Example 19, 0.5 milliliters of MAO (toluene-diluted methylaluminoxane: 2.0 millimole/milliliter in terms of an Al atom, available from Toso-Akzo Co., Ltd.) was substituted for 1.0 g of the silane-treated layered compound. The copolymerization slowly proceeded, and 30 g of a polymer in terms of a dry weight was obtained.

(ii) Measurement of Distribution of Allylamine Unit in the Polymer

The polymer was dissolved and filtered in the same manner as in (iv) of Example 19, and the resulting filtrate was dispersed in methanol to re-precipitate the polymer. Then, the polymer obtained after drying was subjected to the GPC-FTIR apparatus to determine a content of amine to find that a content of the allylamine unit showed zero in the respective molecular weights. That is, in the case where MAO was substituted for the layered compound, the copolymerization of propylene with N-trimethylsilylallylamine did not proceed.

### EXAMPLE 20

(i) Copolymerization of Propylene with Allyl Alcohol

Propylene was copolymerized with allyl alcohol in the same manner as in (ii) of Example 19, except that in (ii) of Example 19, 0.5 milliliter of allyl alcohol was substituted for 0.5 milliliter of N-trimethylsilylallylamine and that the use amount of tributylaluminum was changed from 0.5 millimole to 2 millimole. The polymerization slowly went on, and 9.7 g of a polymer in terms of a dry weight was obtained. A content of the silane-treated layered compound contained in the copolymer was 10.3% by weight, and the polymerization activity was 55 kg/g of Zr.

(ii) Distribution Measurement of Allyl Alcohol Unit in the Copolymer

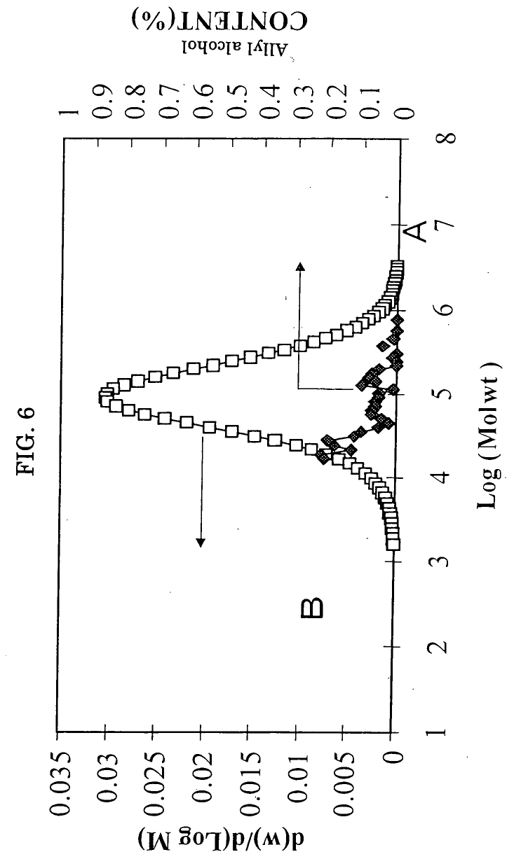

The copolymer was treated in the same manner as in (iv) of Example 19, and the filtrate was subjected to the GPC-FTIR apparatus. The result thereof is shown in FIG. 6. In FIG. 6, A shows a content of the allyl alcohol unit in the resins of the respective molecular weights, and B shows the molecular weight distribution of the resin.

It can be found from FIG. 6 that allyl alcohol contained in the copolymer is distributed, though slightly, extending over the respective molecular weights and that the copolymerization of propylene with allyl alcohol goes on.

### COMPARATIVE EXAMPLE 7

Propylene was copolymerized with allyl alcohol in the same manner as in (i) of Example 20, except that in (i) of Example 20, 0.5 milliliter of MAO (toluene-diluted methylaluminoxane: 2.0 millimole/ml in terms of an Al atom, manufactured by Toso-Akzo Co., Ltd.) was substituted for 1.0 g of the silane-treated layered compound. However, propylene was not absorbed at all even after 2 hours passed. Further, the liquid obtained after the polymerization operation treatment was dispersed in a large amount of methanol, but the polymer was not formed.

### EXAMPLE 21

(i) Preparation of Vinylsilane-Treated Layered Compound

A three neck flask having an internal volume of 5 liters was charged with 4 liters of distilled water, and 25 g of a 2:1 type layered compound (Na-fluorine tetrasilicon mica, ME-100, layer charge: 0.6, available from CO-OP Chemical Co., Ltd.) was slowly added thereto while stirring. After addition, the layered compound suspension was stirred at a room temperature for one hour. Next, 5 milliliters of diethyldichlorosilane [(C₂H₅)₂SiCl₂] was slowly dropwise added to the layered compound suspension. After dropwise adding, 2.5 milliliters of vinyltrichlorosilane [(CH₂═CH)SiCl₃] was dropwise added to the suspension, and stirring was continued for one hour. Further, the temperature was raised up to 100° C., and the suspension was stirred at the same temperature for 3 hours. During this period, the suspension was changed to precipitable hydrophobic slurry. This hydrophobic slurry was subjected to filtration during heating by means of a pressurizer (using a membrane filter having an air pressure of 0.5 MPa and a menbrane pore diameter of 3 μm). Time required for filtration was 7 minutes.

The filtered matter 25 g dried at a room temperature was suspended in 250 milliliters of toluene. Further, 160 milliliters of a toluene aqueous solution (1.0 mole/liter) of triisobutylaluminum was slowly added thereto, and after addition, the temperature was elevated up to 100° C. The solution was stirred at the same temperature for one hour. The resulting aluminum-treated slurry was washed with toluene, and then toluene was added to adjust the whole amount of the liquid to 500 milliliters, whereby a vinylsilane-treated layered compound slurry C-1 was prepared.

(ii) Polymerization of Propylene Using Dimethylsilylenebis(4-phenyl-2-methylindenyl)-zirconyl Dichloride Complex

An autoclave having an internal volume of 5 liters was charged in order with 2.0 liters of dried toluene, 3.0 millimole of triisobutylaluminum and 100 milliliters (5.0 g of the silane-treated layered compound) of the vinylsilane-treated layered compound slurry C-1 prepared in (i) described above, and the temperature was elevated to 60° C. Next, the pressure was raised while continuously feeding propylene gas to maintain the internal pressure at 0.7 MPa. Further, 30 milliliters of a heptane solution blended with 3 milliliters of a solution (1 micromole/milliliter of heptane) of dimethylsilylenebis(2-methyl-4-phenylindenyl)zirconium dichloride suspended in heptane was added to the polymerization system while maintaining the temperature at 6° C. Propylene was continued to be fed while maintaining the polymerization pressure at 0.7 MPa and the polymerization temperature at 60° C. to carry out the polymerization. When 2 hours passed since the initiation of the polymerization, methanol was added to thereby terminate the polymerization. Next, the polymer was separated by filtering through a filter paper and dried at 90° C. for 12 hours under reduced pressure. As a result thereof, 116 g of an additional polymer was obtained. The silane-treated layered compound in the polymer had a content of 4.3% by weight.

The polymer (staying in a wet state of a toluene-methanol mixed solution) immediately after taken out from the autoclave was observed to find that the dots of the silane-treated layered compound (yellow color) were not visually detected in the white polymer powder.

(iii) Distribution Measurement of Vinylsilane in the Polymer

A solution of 22 mg of the polymer (silane-treated layered compound-containing polymer) obtained in (ii) described above and 10 milliliters of trichlorobenzene was heated to a temperature of 150° C., and then the insoluble layered compound was removed by filtering through a filter (mesh 5 μm) . The filtrate was subjected to the GPC-FTIR apparatus. An apparatus in which a GPC main body was combined with an FTIR main body through a transfer tube and a flow cell was used as the GPC-FTIR.

The molecular weight distribution of the polymer described above and the composition distribution of vinylsilane in the polymer described above were measured in accordance with the following methods.

(a) The measuring apparatus, (b) the measuring conditions, (c) the measuring conditions of FTIR and (d) measurement of the molecular weight distribution curve, Mw and Mn are the same as in Example 19.

(e) Measurement of Vinylsilane Composition Curve

The data analysis software for GPC-FTIR was used to calculate an amount (% by weight) of vinylsilane (measured according to an intensity ratio of methyl to methylene in the copolymer) that was copolymerized with propylene, and a vinylsilane composition curve [log₁₀ M (axis of ordinate)−vinylsilane amount (axis of abscissa)] was prepared from this.

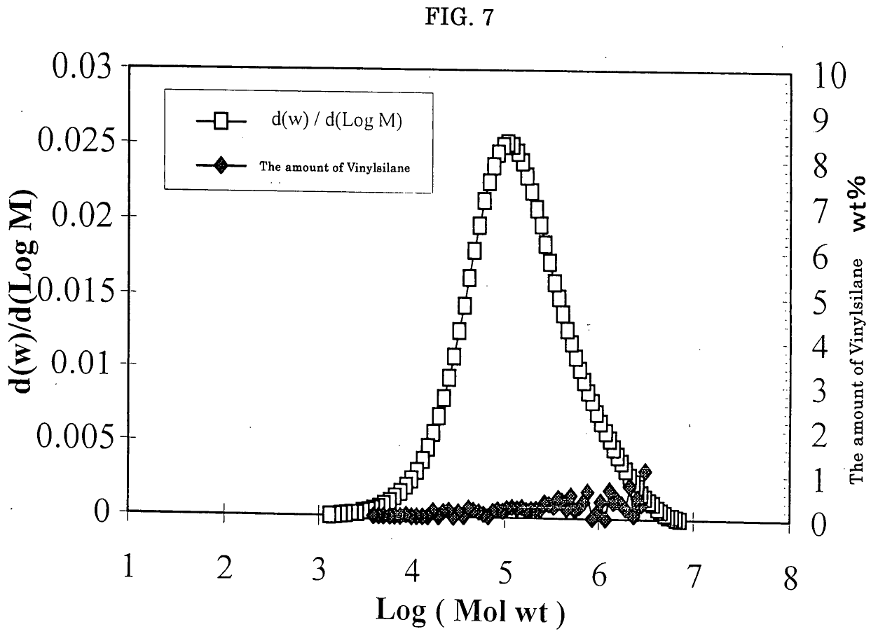

These results are shown in FIG. 7. It can be found from FIG. 7 that vinylsilane contained in the polymer is distributed extending over the respective molecular weights and that the copolymerization of propylene with vinylsilane goes on.

(iv) Observation Under Optical Microscope

A part of the polymer powder obtained in (ii) described above was subjected to hot press molding (molding temperature: 200° C., molding pressure: 5 MPa) using a metallic mold (length: 20 mm, width: 14 mm and thickness: 200 μm).

Next, an optical microscope (BH-2, produced by Olimpas Optical Ind. Co., Ltd.) was used to observe (eye-piece: 10 magnifications, ocular lens: 40 magnifications) the hot press sheet to find that yellow (silane-treated layered compound) particles having a particle diameter of larger than 1 μm were not observed.

### EXAMPLE 22

(i) Preparation of Allylsilane-Treated Layered Compound

Silane treatment was carried out in the same manner as in (i) of Example 21 to obtain a hydrophobic slurry, except that allylmethyldichlorosilane [(CH₂═CHCH₂)CH₃SiCl₂] was substituted for vinyltrichlorosilane [(CH₂═CH)SiCl₃] used in (i) of Example 21.

Next, 25 g of the powder obtained by filtering and drying was subjected to organic aluminum treatment in the same manner as in (i) of Example 21 to obtain an allylsilane-treated layered compound slurry C-2.

(ii) Polymerization of Propylene Using Dimethylsilylenebis(4-phenyl-2-methylindenyl)-zirconyl Dichloride Complex

The polymerization of propylene was carried out in the same manner as in (ii) of Example 21, except that in (ii) of Example 21, changed were 2.0 liter of toluene to 2.0 liter of heptane and 100 milliliter of the vinylsilane-treated layered compound slurry C-1 to a mixed solution of 100 milliliter of the allylsilane-treated layered compound slurry C-2 and 1.0 millimole (in terms of an Al atom) MMAO (modified methylalumoxane, available from Toso•Finechem Co., Ltd.) and that the polymerization temperature was changed from 60° C. to 70° C. The polymerization was terminated after 30 minutes since the initiation of the polymerization.

The polymer thus obtained had a dry weight of 136 g. The polymer had a silane-treated layered compound content of 3.7% by weight.

(iii) Viscoelasticity Measurement of the Polymer

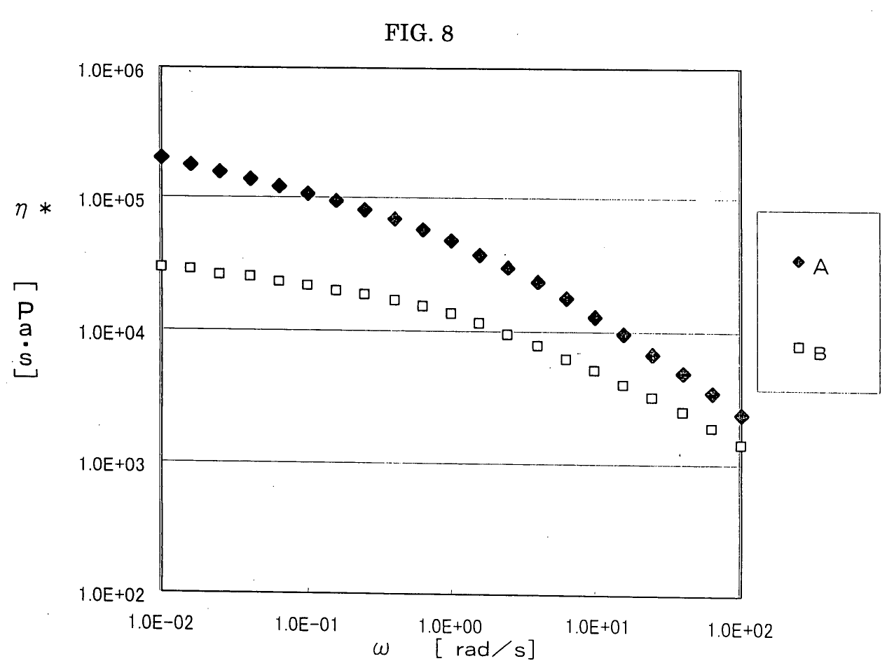

The polymer (silane-treated layered compound-containing polymer) obtained in (ii) described above was subjected to hot press (molding temperature: 210° C.) by means of a metallic mold (disc having a diameter of 30 cm and a thickness of 1 mm). Then, the following ARES viscoelasticity measuring apparatus was used to determine a melt characteristic [steady rotational angular velocity (axis of ordinate)−complex viscosity η* (axis of abscissa)] of the polymer. A in FIG. 8 thereof shows the result.

As a result thereof, the complex viscosity η* (Pa•s) was increased to a large extent as the steady rotational angular velocity (rad/s) was reduced. It has been found that the melt characteristic of the present polymer shows a high non-Newtonian property.

Accordingly, it is considered that the moldability is improved. For example, a discharge amount of a polymer can be increased under a fixed torque in extrusion molding, and therefore the productivity can be improved. In injection molding, the molding cycle can be shortened, and the productivity can be improved. Further, it becomes easy to mold a large-sized molded article.

(a) Measuring Apparatus

Rheometric Science ARES viscoelasticity measuring system (expansion type) transducer: 2k, FRT, NI

Frequency (rad/sec) : 10⁻⁵ to 100

Normal stress range (g): 2.0 to 2000

Environmental system: FCO

(b) Measuring Conditions

Measuring temperature: 175° C., distortion (displacement angle): 20%, steady rotational angular velocity: 10⁻² to 10² rad/s

A silane-treated compound slurry which was subjected to single treatment with 5 milliliter of diethyldicholorosilane without adding allylmethyldicholorosilane was used to polymerize propylene in the same manner as described above, whereby a polymer having a dry weight of 153 g and a silane-treated clay content of 3.3% by weight was obtained. A melt characteristic of the polymer was determined in the same manner as described above (shown by B in FIG. 8). As a result thereof, the complex viscosity η* (Pa•s) was scarcely changed even in the case of the steady rotational angular velocity changed. It has been found that the melt characteristic of this polymer shows a low non-Newtonian property.

### EXAMPLE 23

(i) Preparation of Vinylsilane-Treated (Silane Amount: 2/5) Layered Compound

Silane treatment was carried out in the same manner as in (i) of Example 21 to obtain a hydrophobic slurry, except that the amount of vinyltrichlorosilane [(CH₂═CH)SiCl₃] in (i) of Example 21 was changed from 2.5 milliliter to 1.0 milliliter. Next, 25 g of the powder obtained by filtering and drying was subjected to organic aluminum treatment in the same manner as in (i) of Example 21 to obtain a vinylsilane-treated layered compound slurry C-3.

(ii) Polymerization of Ethylene Using Dimethylsilylenebis(2-methylindenyl)Zirconyl Dichloride Complex

An autoclave having an internal volume of 5 liter was charged in order with 2.0 liter of dried toluene, 3.0 millimole of triisobutylaluminum and 100 milliliter (5.0 g of the silane-treated layered compound) of the vinylsilane-treated layered compound slurry C-3 prepared in (i) described above, and the temperature was elevated to 55° C. Next, the pressure was raised while continuously feeding ethylene gas to maintain the internal pressure at 0.1 MPa•G.

Next, 30 milliliter of a toluene solution prepared by adding a solution (1 micromole/milliliter) of dimethylsilylenebis(2-methylindenyl)zirconium dichloride suspended in heptane was added to the polymerization system. Further, ethylene was continued to be fed so that the polymerization pressure was maintained at 0.1 MPa while maintaining the temperature in a range of 55 to 60° C. to carry out the polymerization. When one hour passed since the initiation of the polymerization, methanol was added to thereby terminate the polymerization. Next, the polymer was separated by filtering and dried at 90° C. for 12 hours under reduced pressure. As a result thereof, 254 g of an additional polymer was obtained. The silane-treated layered compound in the polymer had a content of 2.0% by weight.

The polymer (staying in a wet state of a toluene-methanol mixed solution) immediately after taken out from the autoclave was observed to find that the dots of the silane-treated layered compound (yellow color) were not visually detected in the white polymer powder.

(iii) Preparation of Composite Resin (Pellets Prepared by Blending and Kneading the Polymer with Polyethylene)

The polymer (silane-treated layered compound-containing polymer) 8 g obtained in (ii) described above was kneaded at 50 rpm for 5 minutes with 32 g of HDPE (640UF, available from Idemitsu Petrochemical Co., Ltd.) produced with a Ziegler catalyst by means of a plastomill-mixer (predetermined temperature: 230° C.) having an internal volume of 60 milliliters.

Next, the blended and kneaded matter was subjected to hot press by means of a metallic mold having a length of 20 cm, a width of 20 cm and a thickness of 1 mm. The press conditions were 230° C., 5 MPa and 4 minutes. The sheet thus obtained was cut to prepare the pellets of the composite resin (blended and kneaded).

(iv) Preparation of Test Samples, Bending Test and Izod Impact Test

The pellets of the composite resin (blended and kneaded) prepared in (iii) described above were subjected to an injection-molding machine (MIN-7) produced by Niigata Engineering Co., Ltd. to prepare a sample (length×width=10 mm×114 mm, thickness: 4 mm) for a bending test and a sample (length×width=12 mm×60 mm, thickness: 4 mm) for an Izod impact test.

The measuring method of the bending test was in accordance with JIS-K-7116, and the measuring method of the Izod impact test was in accordance with JIS-K-7110. The flexural strength and the flexural elastic modulus at a test temperature of 23° C. were 24.3 MPa and 857 MPa respectively.

The Izod impact test was carried out on the condition of a test temperature of 23° C. with a notch, and the impact value was 69.3 KJ/m².

### COMPARATIVE EXAMPLE 8

(i) Preparation of Kneaded Pellets of Polyethylene

40 g of HDPE (640UF, available from Idemitsu Petrochemical Co., Ltd.) produced with a Ziegler catalyst was kneaded at 50 rpm for 5 minutes by means of a plastomill-mixer (predetermined temperature: 230° C.) having an internal volume of 60 milliliters.

Next, the blended and kneaded matter was subjected to hot press by means of a metallic mold having a length of 20 cm, a width of 20 cm and a thickness of 1 mm. The press conditions were 230° C., 5 MPa and 4 minutes. The sheet thus obtained was cut to prepare kneaded pellets.

(ii) Preparation of Test Samples, Bending Test and Izod Impact Test

The blended and kneaded pellets prepared in (i) described above were subjected to the injection-molding machine (MIN-7) produced by Niigata Engineering Co., Ltd. to prepare a sample for a bending test and a sample for an Izod impact test in the same manner as in (iv) of Example 23.

As a measuring result of the bending test, the flexural strength and the flexural elastic modulus at a test temperature of 23° C. were 21.3 MPa and 776 MPa respectively.

The Izod impact test was carried out at a test temperature of 23° C. with a notch, and the impact value was 58.0 KJ/m².

### EXAMPLES 24 AND 25

(i) Polymerization of Ethylene Using [(t-butylamide)-dimethyl(tetramethylcyclopentadienyl)silane]titanium Dichloride Complex and Dimethylsilylenebis(4-phenyl-2-methylindenyl)zirconyl Dichloride Complex

An autoclave having an internal volume of 5 liters was charged in order with 2.0 liters of dried toluene, 3.0 millimole of triisobutylaluminum and 100 milliliters (5.0 g of the silane-treated layered compound) of the vinylsilane-treated layered compound slurry C-1 prepared in (i) of Example 21, and the temperature was elevated to 55° C.

Next, the pressure was raised while continuously feeding ethylene gas to maintain the internal pressure at 0.7 MPa (gauge pressure). Further, added to the polymerization system respectively was a [(t-butylamide)dimethyl-(tetramethylcyclopentadienyl)silane]titanium dichloride complex (Example 24) dissolved in toluene or 30 milliliters of a toluene solution blended with 3 milliliters of a solution (each 1 micromole/milliliter) of a dimethylsilylenebis(4-phenyl-2-methylindenyl)zirconyl dichloride complex (Example 25). Then, the temperature was slowly elevated (about 0.5° C./minute) from 55° C., and when reached 70° C., the polymerization was terminated. Next, the polymer was separated by filtering and dried at 90° C. for 12 hours under reduced pressure. As a result thereof, 104 g (Example 24) and 190 g (Example 25) of addition polymers were obtained.

(ii) Heat Resistance Test

A plastomill-mixer having an internal volume of 30 milliliters was maintained at 230° C. and charged with each 20 g of the polymer powders obtained in (i) described above, and they were tried to be molten at 50 rpm for 5 minutes by heating to find that both powders were not molten at all and recovered as they were.

Next, the temperature of the mixer was elevated to 250° C., and the polymer powders were heated and molten again to find that only the polymer powder obtained using the dimethylsilylenebis(4-phenyl-2-methylindenyl)zirconyl dichloride complex was molten. However, the polymer powder polymerized using the [(t-butylamide)dimethyl(tetramethylcyclopentadienyl)-silane]titanium dichloride complex was not molten.

As shown in the present example, the polymer produced using the alkenylsilane layered compound showed a extremely high heat resistance.

### EXAMPLE 26

(i) Polymerization of Ethylene Using Dimethylsilylenebis(4-phenyl-2-methylindenyl)zirconyl Dichloride Complex

An autoclave having an internal volume of 5 liters was charged in order with 2.0 liters of dried toluene, 2.0 millimole of triisobutylaluminum and 100 milliliters (5.0 g of the silane-treated layered compound) of the vinylsilane-treated layered compound slurry C-1 prepared in (i) of Example 21, and the temperature was elevated to 55° C. Next, the pressure was raised while continuously feeding ethylene gas to maintain the internal pressure at 0.4 MPa•G. Further, 30 milliliters of a toluene solution blended with 3 milliliters of a solution (1 micromole/milliliter of heptane) of a dimethylsilylenebis-(2-methyl-4-phenylindenyl)zirconyl dichloride suspended in heptane was added to the polymerization system while maintaining at 55° C. Ethylene was continued to be fed while maintaining the polymerization pressure at 0.4 MPa•G and the polymerization temperature at 55° C. to carry out the polymerization. When 20 minutes passed since starting the polymerization, ethylene was continued to be fed while maintaining the polymerization pressure at 0.4 MPa•G and slowly elevating (10° C./15 minutes) the polymerization temperature. When the temperature reached 75° C., the polymerization was continued at 0.4 MPa•G while maintaining the same temperature. When 3 hours passed since the initiation of the polymerization, methanol was added to thereby terminate the polymerization. Next, the polymer was separated by filtering and dried at 90° C. for 12 hours under reduced pressure. As a result thereof, 207 g of an additional polymer was obtained. The silane-treated layered compound in the polymer had a content of 2.4% by weight.

The polymer (staying in a wet state of a toluene-methanol mixed solution) immediately after taken out from the autoclave was observed to find that the dots of the silane-treated layered compound (yellow color) were not visually detected in the white polymer powder.

(ii) Preparation of Composite Resin (Pellets Prepared by Blending and Kneading the Polymer with Polyethylene)

The polymer (silane-treated layered compound-containing polymer) 8 g obtained in (i) described above was kneaded at 50 rpm for 5 minutes with 32 g of HDPE (640UF, available from Idemitsu Petrochemical Co., Ltd.) produced with a Ziegler catalyst by means of a plastomill-mixer (predetermined temperature: 210° C.) having an internal volume of 60 milliliters.

Next, the blended and kneaded matter was subjected to hot press by means of a metal mold having a length of 15 cm, a width of 15 cm and a thickness of 1 mm. The press conditions were 200° C., 5 MPa and 2 minutes. The sheet thus obtained was cut to prepare the pellets of the composite resin (blended and kneaded).

(iii) Preparation of Test Samples and Various Mechanical Characteristic Tests

The pellets of the composite resin (blended and kneaded) prepared in (ii) described above were subjected to the injection-molding machine (MIN-7) produced by Niigata Engineering Co., Ltd. to prepare a sample (length×width=10 mm×114 mm, thickness: 4 mm) for a bending test, a sample (length×width=12 mm×60 mm, thickness: 4 mm) for an Izod impact test, a sample (width 6 mm) for a tensile test and a sample (length×width=10 mm×114 mm, thickness: 4 mm) for a load deflection temperature test.

The measuring method of the bending test and the measuring method of the Izod impact test are the same as in (iv) of Example 23. The measuring method of the tensile test was in accordance with JIS-K-7161, and the measuring conditions were a test speed of 50 mm/minute, a chuck interval of 80 mm and a temperature of 23° C. The measuring method of the load deflection temperature test was in accordance with JIS-K-7191, and the measuring was carried out at a load of 0.45 MPa and a heating temperature of 120° C./hour without annealing.

As a result thereof, the flexural strength and the flexural elastic modulus at 23° C. were 22.5 MPa and 804 MPa respectively.

The Izod impact test was carried out on the condition of a test temperature of 23° C. with a notch, and the impact value was 60.0 KJ/m².

The results of the tensile test were yield strength of 21.1 MPa, a breaking strength of 40.1 MPa, a breaking elongation of 490% and an elastic modulus of 1150 MPa.

The load deflection temperature was 63.3° C.

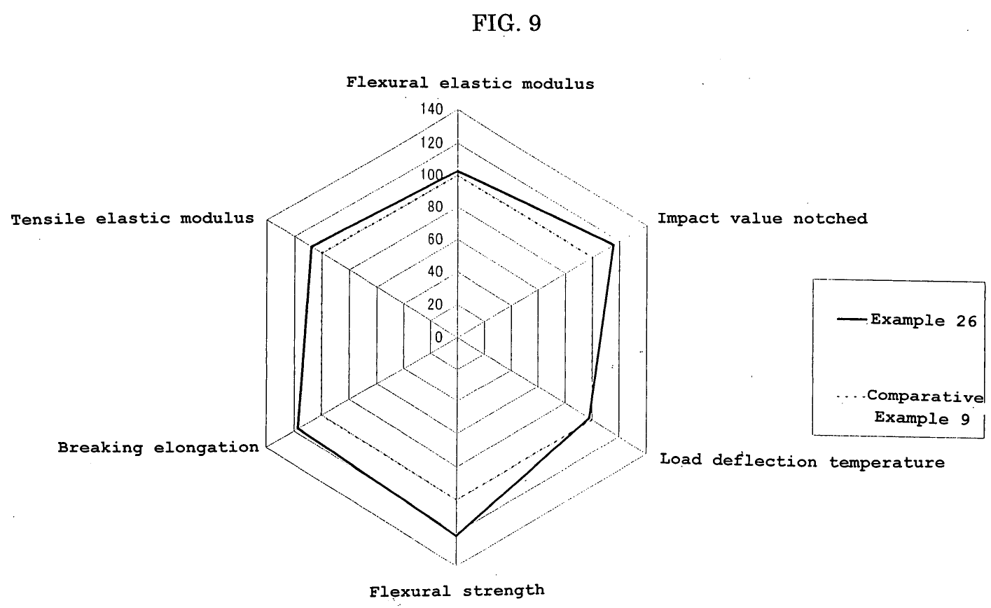

These results are displayed by a radar chart and shown in FIG. 9.

### COMPARATIVE EXAMPLE 9

(i) Preparation of Kneaded Pellets of Polyethylene

40 g of HDPE (640UF, available from Idemitsu Petrochemical Co., Ltd.) produced with a Ziegler catalyst was kneaded at 50 rpm for 5 minutes by means of a plastomill-mixer (predetermined temperature: 210° C.) having an internal volume of 60 milliliters.

Next, the blended and kneaded matter was subjected to hot press by means of a metallic mold having a length of 20 cm, a width of 20 cm and a thickness of 1 mm. The press conditions were 200° C., 5 MPa and 2 minutes. The sheet thus obtained was cut to prepare kneaded pellets.

(ii) Preparation of Test Samples, Bending Test and Izod Impact Test

The blended and kneaded pellets prepared in (i) described above were subjected to the injection-molding machine (MIN-7) produced by Niigata Engineering Co., Ltd. to prepare samples for the tests in the same manner as in (iv) of Example 26.

As a result thereof, the flexural strength and the flexural elastic modulus at a test temperature of 23° C. were 21.9 MPa and 784 MPa respectively.

The Izod impact test was carried out on the conditions of a test temperature of 23° C. with a notch, and the impact value was 52.0 KJ/m².

The results of the tensile test were yield strength of 20.3 MPa, a breaking strength of 33.0 MPa, a breaking elongation of 420% and an elastic modulus of 1070 MPa.

The load deflection temperature was 64.3° C. These results are displayed by a radar chart and shown together in FIG. 9.

### EXAMPLE 27

(i) Block Copolymerization of Propylene with Ethylene Using Dimethylsilylenebis(4-phenyl-2-methylindenyl)-zirconyl Dichloride Complex

An autoclave having an internal volume of 5 liters was charged in order with 2.0 liters of dried toluene, 2.0 millimole of triisobutylaluminum and 100 milliliters (5.0 g of the silane-treated layered compound) of the vinylsilane-treated layered compound slurry C-1 prepared in (i) of Example 21, and the temperature was elevated to 70° C. Next, the pressure was raised while continuously feeding propylene gas to maintain the internal pressure at 0.7 MPa•G. Then, added to the polymerization system was 30 milliliters of a heptane solution blended with 4 milliliters of a solution (1 micromole/milliliter of heptane) of a dimethylsilylenebis(4-phenyl-2-methylindenyl)zirconyl dichloride suspended in heptane. Ethylene was continued to be fed while maintaining the polymerization pressure at 0.7 MPa•G and the polymerization temperature at 70° C. to carry out the polymerization. When 25 minutes passed since the initiation of the polymerization, the polymerization temperature was reduced to 50° C., and propylene was depressurized (gauge pressure: 0) and removed.

The polymerization temperature was elevated again to 60° C., and then ethylene was fed to continue the polymerization at 0.2 MPa•G while maintaining the temperature at 60 to 70° C.

When 10 minutes passed since feeding ethylene, methanol was added to thereby terminate the polymerization. Next, the polymer was separated by filtering and dried at 90° C. for 12 hours under reduced pressure. As a result thereof, 214 g of an addition polymer was obtained. The silane-treated layered compound in the polymer had a content of 2.3% by weight.

The polymer (staying in a wet state of a toluene-methanol mixed solution) immediately after taken out from the autoclave was observed to find that the dots of the silane-treated layered compound (yellow color) were not visually detected in the white polymer powder.

(ii) Measurement of Ethylene Amount in the Polymer and Distribution Measurement Thereof

A solution of 22 mg of the polymer (silane-treated layered compound-containing polymer) obtained in (ii) described above and 10 milliliters of trichlorobenzene was heated to a temperature of 150° C., and then the insoluble layered compound was removed by filtering through a filter (mesh: 5 μm) . The filtrate was subjected to the GPC-FTIR apparatus. An apparatus in which a GPC main body was coupled with an FTIR main body through a transfer tube and a flow cell was used as the GPC-FTIR.

An ethylene composition distribution in the polymer described above was measured according to the same method as in (iii) of Example 21.

As a result thereof, it has been found that an ethylene unit contained in the polymer is evenly distributed extending over the respective molecular weights and that the copolymerization of ethylene and propylene proceeds. The ethylene unit contained in the copolymer had a content of 40% by weight.

(iii) Production of Composite Resin

40 g of a blended matter comprising 50 parts by weight of the polymer powder obtained in (i) described above and 50 parts by weight of isotactic polypropylene (H100M, available from Idemitsu Petrochemical Co., Ltd.) produced by homopolymerizing propylene with a Ziegler catalyst was kneaded at 50 rpm for 5 minutes by means of a plastomill-mixer (predetermined temperature 230° C.) having an internal volume of 60 milliliters. Next, the blended and kneaded matter was subjected to hot press by means of a metallic mold having a length of 15 cm, a width of 15 cm and a thickness of 1 mm. The press conditions were 200° C., 5 MPa and 4 minutes. The sheet thus obtained was cut to prepare the pellets of the composite resin (blended and kneaded).

In the present composite resin, a blending ratio of both components was controlled so that an ethylene unit content was 20% by weight.

(iv) Preparation of Test Samples, Bending Test and Load Deflection Temperature Test

The pellets of the composite resin (blended and kneaded) prepared in (iii) described above were subjected to the injection-molding machine (MIN-7) produced by Niigata Engineering Co., Ltd. to prepare a sample for a bending test and a sample for a load deflection temperature test (length×width=10 mm×114 mm, thickness: 4 mm respectively).

The measuring method of the bending test is the same as in (iv) of Example 23. The measuring method of the load deflection temperature test is the same as in (iii) of Example 26.

As a result thereof, the flexural strength and the flexural elastic modulus at 23° C. were 43.1 MPa and 1628 MPa respectively. Further, the load deflection temperature was 115.5° C.

### COMPARATIVE EXAMPLE 10

(i) Preparation of Kneaded Pellets of Ethylene•Propylene Block Copolymer

40 g of Polypropylene (J763HP, ethylene unit content: 20% by weight, available from Idemitsu Petrochemical Co., Ltd.) produced by block-copolymerizing propylene and ethylene with a Ziegler catalyst was kneaded at 50 rpm for 5 minutes by means of a plastomill-mixer (predetermined temperature 210° C.) having an internal volume of 60 milliliters.

Next, the blended and kneaded matter was subjected to hot press by means of a metallic mold having a length of 20 cm, a width of 20 cm and a thickness of 1 mm. The press conditions were 200° C., 5 MPa and 2 minutes. The sheet thus obtained was cut to prepare kneaded pellets.

(ii) Preparation of Test Samples and Various Mechanical Characteristic Tests

The pellets of the composite resin (blended and kneaded) prepared in (i) described above were subjected to the injection-molding machine (MIN-7) produced by Niigata Engineering Co., Ltd. to prepare samples for the tests in the same manner as in (iii) of Example 26.

As a result thereof, the flexural strength and the flexural elastic modulus at 23° C. were 35.2 MPa and 1346 MPa respectively.

Further, the load deflection temperature was 107° C.

### INDUSTRIAL APPLICABILITY

According to the present invention, use of a transition metal complex as a principal catalyst and clay, a clay mineral or an ion-exchangeable layered compound (generally called a layered compound) or a silane-treated product thereof as a promoter makes it possible to provide a polyolefin-based composite resin having a high rigidity in which the layered compound described above or the silane-treated product thereof is dispersed to a high degree and an olefin/polar vinyl monomer copolymer which is excellent in an adhesive property, a printing property and a hydrophilic property.

Further, capable of being provided is a novel polymerizing catalyst providing a vinyl compound polymer which can be improved in a melt viscoelasticity and mechanical characteristics to a large extent.

What is claimed is:

1. A polyolefin-based composite resin produced using a polymerization catalyst comprising a silane-treated product prepared by treating clay, a clay mineral or an ion-exchangeable layered compound with a silane compound and a complex of a transition metal of Group 4 to Group 6 in the Periodic Table, characterized by comprising a polyolefin resin in an amount of 20 to 99.3% by weight and the silane-treated product in an amount of 80 to 0.7% by weight.

2. The polyolefin-based composite resin as described in claim 1, wherein the clay, the clay mineral or the ion-exchangeable layered compound is subjected to silane treatment by bringing into contact with an organic silane compound having carbon in an element bonded directly to silicon.

3. The polyolefin-based composite resin as described in claim 1 or 2, wherein the silane compound is an organic silane compound represented by Formula (1′):
R¹₄₋ₙSiXₙ (1′)
(wherein R¹ represents a hydrocarbon group, and when a plurality of R¹ is present, a plurality of R¹ may be the same or different; X represents a halogen atom or a group in which an element bonded directly to silicon is nitrogen or oxygen, and when a plurality of X is present, a plurality of X may be the same or different; and n is an integer of 1 to 3), and the clay, the clay mineral or the ion-exchangeable layered compound is a 2:1 type layered compound having a layer charge of 0.05 to 0.7.

4. The polyolefin-based composite resin as described in claim 3, wherein the clay, the clay mineral or the ion-exchangeable layered compound is the 2:1 type layered compound having a layer charge of 0.05 to 0.6.

5. The polyolefin-based composite resin as described in claim 1, wherein the complex of a transition metal of Group 4 to Group 6 in the Periodic Table is a transition metal complex containing a cyclopentadienyl group, a substituted cyclopentadienyl group, an indenyl group or a substituted indenyl group.

6. The polyolefin-based composite resin as described in claim 1, wherein the polyolefin resin is obtained by polymerizing at least one monomer selected from 1-olefins having 2 to 4 carbon atoms and dienes.

7. A composite resin composition prepared by blending the polyolefin-based composite resin as described in claim 1 with a thermoplastic resin, characterized by containing the silane-treated product as described in claim 1 in an amount of 0.2 to 20% by weight.

8. An antioxidant-blended polyolefin-based composite resin composition characterized by blending the polyolefin-based composite resin as described in claim 1 with a phenol-based antioxidant.

9. A production process for a polyolefin-based composite resin comprising a polyolefin resin in an amount of 20 to 99.3% by weight and a silane-treated product in an amount of 80 to 0.73% by weight, characterized by polymerizing at least one of olefin or diene using a polymerization catalyst comprising a silane-treated product prepared by treating clay, a clay mineral or an ion-exchangeable layered compound with a silane compound and a complex of a transition metal of Group 4 to Group 6 in the Periodic Table.

10. The production process as described in claim 9 wherein the polymerization of at least one of the olefin or diene is carried out while a rise in the polymerization temperature in the polymerization is controlled within 15° C. from a predetermined temperature.

11. The production process as described in claim 9, wherein the silane compound is an organic silane compound represented by Formula (1):
R^{a}₄₋ₙSiXₙ (1)
(wherein R^{a} represents a group in which an element bonded directly to silicon is carbon, silicon or hydrogen, and at least one R^{a} is a group in which an element bonded directly to silicon is carbon; when a plurality of R^{a} is present, a plurality of R^{a} may be the same or different; X represents a halogen atom or a group in which an element bonded directly to silicon is nitrogen or oxygen, and when a plurality of X is present, a plurality of X may be the same or different; and n is an integer of 1 to 3), and the clay, the clay mineral or the ion-exchangeable layered compound is a 2:1 type layered compound having a layer charge of 0.05 to 0.7.

12. The production process as described in claim 11, wherein the silane compound is an organic silane compound represented by Formula (1′):
R¹₄₋ₙSiXₙ (1′)
(wherein R¹ represents a hydrocarbon group, and when a plurality of R¹ is present, a plurality of R¹ may be the same or different; X represents a halogen atom or a group in which an element bonded directly to silicon is nitrogen or oxygen, and when a plurality of X is present, a plurality of X may be the same or different; and n is an integer of 1 to 3), and the clay, the clay mineral or the ion-exchangeable layered compound is the 2:1 type layered compound having a layer charge of 0.05 to 0.6.

13. The production process as described in claim 12, wherein the hydrocarbon group in Formula (1′) is an alkyl group having total 2 to 12 carbon atoms, an alkenyl group, an aryl group or a cyclic saturated hydrocarbon group.

14. The production process as described in claim 9, wherein the complex of a transition metal of Group 4 to Group 6 in the Periodic Table is a transition metal complex having a ligand having a conjugate five-membered ring.

15. The production process as described in claim 9, wherein the polymerization catalyst is obtained by bringing 1 g of the silane compound into contact with 0.01 to 100 micromole of a transition metal of Group 4 to Group 6 in the Periodic Table.

16. The production process as described in claim 9, wherein the silane-treated product is further treated with an organic aluminum compound.

17. The production process as described in claim 9, wherein the polymerization is carried out after bringing the polymerization catalyst into contact with the organic aluminum compound.

18. The production process as described in claim 16 or 17, wherein the organic aluminum compound is triethylaluminim, triisobutylaluminim or an aluminumoxy compound represented by the following Formula (2):
R⁴R⁵Al (OAlR⁶)ₘR⁷ (2)
(wherein R⁴, R⁵, R⁶ and R⁷ represent an alkyl group having 1 to 10 carbon atoms, and at least one of them is an alkyl group having 2 to 10 carbon atoms; and m is an integer of 1 to 3).

19. The production process as described in claim 9, wherein the olefin is 1-olefin having 2 to 4 carbon atoms.

20. An olefin-based composite resin comprising an olefin-based resin composition obtained by polymerizing olefin using a polymerization catalyst comprising clay, a clay mineral or an ion-exchangeable layered compound and a transition metal complex and at least one compound selected from a metal salt compound and a basic inorganic compound.

21. The olefin-based composite resin as described in claim 20, wherein the clay, the clay mineral or the ion-exchangeable layered compound is subjected to silane treatment by bringing into contact with an organic silane compound having carbon in an element bonded directly to silicon.

22. The olefin-based composite resin as described in claim 20, wherein the transition metal complex is a metallocene complex of a transition metal of Group 4 to Group 6 in the Periodic Table or a chelate complex of a transition metal of Group 4 to Group 10 in the Periodic Table.

23. The olefin-based composite resin as described in claim 20, wherein the metal salt compound is an organic acid salt, a metal alcolate or a metal amide.

24. The olefin-based composite resin as described in claim 20, wherein the basic inorganic compound is a compound having a carbonic acid ion or a basic hydroxyl group.

25. The olefin-based composite resin as described in claim 20, wherein the olefin is at least one selected from ethylene, propylene, styrene and diene.

26. The olefin-based composite resin as described in claim 25, wherein the olefin is propylene.

27. A production process for a high rigidity composite molded article, comprising a step of molding a polyolefin-based composite resin obtained by polymerizing olefin using a catalyst comprising a layered compound and a complex of a transition metal of Group 4 to Group 10 in the Periodic Table, wherein the above composite resin is subjected to a shearing treatment during heating in the above step.

28. The production process as described in claim 27, wherein the polyolefin-based composite resin containing the layered compound in an amount of 0.2 to 80% by weight is subjected to the shearing treatment during heating.

29. The production process as described in claim 27, wherein the layered compound is clay, a clay mineral or an ion-exchangeable layered compound.

30. The production process as described in claim 27, wherein the layered compound is a silane-treated product which is treated with an organic silane compound.

31. The production process as described in claim 27, wherein the complex of the transition metal of Group 4 to Group 10 in the Periodic Table is a complex of a transition metal of Group 4 to Group 6 in the Periodic Table having a ligand having a conjugate five-membered ring or a chelate complex of a transition metal of Group 4 to Group 10 in the Periodic Table.

32. The production process as described in claim 27, wherein the polyolefin-based composite resin is obtained by polymerizing at least one olefin selected from 1-olefins having 2 to 3 carbon atoms or 4 carbon atoms and diene.

33. The production process as described in claim 27, wherein a temperature of the shearing treatment is 100 to 300° C.

34. The production process as described in claim 27, wherein the polyolefin-based composite resin is blended with a metal salt compound.

35. The production process as described in claim 27, wherein shearing treatment operation is carried out by kneading at a number of revolutions of one revolution/minute or more.

36. A production process for an olefin/polar vinyl monomer copolymer, characterized by using a catalyst comprising a layered compound as component (A) and a complex of a transition metal of Group 4 to Group 10 in the Periodic Table as component (B) and characterized by copolymerizing olefin as component (C) with a polar vinyl monomer as component (D).

37. The production process as described in claim 36, wherein the polar vinyl monomer as component (D) is represented by Formula (1C):
CH₂═CR^{1c}(CR^{2c}₂)_{g}X^{1c} (1C)
(wherein R^{1c} and R^{2c} represent a hydrogen atom or a hydrocarbon group having 1 to 10 carbon atoms; X^{1c} represents OH, OR^{3c}, NH₂, NHR^{3c}, NR^{3c}₂, COOH, COOR^{3c}, SH, Cl, F, I or Br (R^{3c} represents a hydrocarbon group having 1 to 10 carbon atoms or a functional group containing silicon or aluminum); and g is an integer of 0 to 20].

38. The production process as described in claim 36, wherein the component (A) is a 2:1 type layered compound having a layer charge of 0.1 to 0.7.

39. The production process as described in claim 36, wherein the component (A) is a layered compound treated in advance with an organic silane compound represented by Formula (1′):
R¹₄₋ₙSiXₙ (1′)
(wherein R¹ represents a hydrocarbon-containing group, and R¹ may be the same or different; X represents a halogen atom or a group in which an element bonded directly to silicon is nitrogen or oxygen, and when a plurality of X is present, a plurality of X may be the same or different; and n is an integer of 1 to 3).

40. The production process as described in claim 36, wherein the component (B) is a metal complex having a ligand having a conjugate five-membered ring or a chelate ligand of a hetero atom.

41. The production process as described in claim 36, wherein the component (B) is the metal complex having a ligand having a conjugate five-membered ring, and the transition metal is zirconium or titanium.

42. The production process as described in claim 36, wherein the component (C) is at least one selected from ethylene, propylene, 1-olefin having 4 to 12 carbon atoms and cyclic olefin.

43. The production process as described in claim 42, wherein the component (C) is propylene, and a propylene unit content in the copolymer is 7% by weight or more.

44. The production process as described in claim 37, wherein the component (D) is a polar vinyl monomer represented by Formula (1C′):
CH₂═CHCH₂X^{2c} (1C′)
[wherein X^{2c} represents OH, OR^{3c}, NH₂, NHR^{3c}, NR^{3c}₂ or SH (R^{3c} represents a hydrocarbon group having 1 to 10 carbon atoms or a functional group containing silicon or aluminum)].

45. A vinyl compound-polymerizing catalyst comprising an alkenylsilane-treated product as component (X) obtained by treating a layered compound with alkenylsilane and a complex of a transition metal of Group 4 to Group 6 or Group 8 to Group 10 in the Periodic Table as component (Y).

46. The vinyl compound-polymerizing catalyst as described in claim 45, wherein the layered compound is a 2:1 type layered compound having a layer charge of 0.1 to 0.7.

47. The vinyl compound-polymerizing catalyst as described in claim 45, wherein the alkenylsilane is a silane compound represented by Formula (1d):
R^{9d}₄₋ₙSiXₙ (1d)
(wherein R^{9d} represents a hydrocarbon-containing group, and at least one of them is a group having a carbon-carbon double bond; X represents a halogen atom or a group in which an element bonded directly to silicon is nitrogen or oxygen; n is an integer of 1 to 3; provided that when a plurality of R^{9d} is present, a plurality of R^{9d} may be the same or different and that when a plurality of X is present, a plurality of X may be the same or different).

48. The vinyl compound-polymerizing catalyst as described in claim 45, wherein the alkenylsilane is a silane compound containing hydride represented by Formula (1d′):
CH₂═CH—(CH₂)ₖ—SiHₘR₃₋ₘ (1d′)
(wherein R is an alkyl group having 1 to 5 carbon atoms; k is an integer of 1 or more; and m is an integer of 1 to 3).

49. The vinyl compound-polymerizing catalyst as described in claim 45, wherein the component (B) is a metal complex having a ligand having a conjugate five-membered ring or a chelate ligand of a hetero atom.

50. The vinyl compound-polymerizing catalyst as described in claim 45, wherein the layered compound is brought into contact with the alkenylsilane, and the resulting component (X) is brought into contact with the component (Y).

51. The vinyl compound-polymerizing catalyst as described in claim 50, wherein in bringing the layered compound into contact with the alkenylsilane, the layered compound is brought in advance into contact with an organic silane compound excluding an alkenylsilane compound or brought into contact with an organic silane compound excluding an alkenylsilane compound at the same time as the alkenylsilane or at an after-step to prepare the component (X).

52. The vinyl compound-polymerizing catalyst as described in claim 51, wherein the organic silane compound is a silane compound represented by Formula (1e):
R^{10d}₄₋ₙSiXₙ (1e)
(wherein R^{10d} represents a hydrocarbon group having no carbon•carbon double bond; X represents a halogen atom or a group in which an element bonded directly to silicon is nitrogen or oxygen; n is an integer of 1 to 3; provided that when a plurality of R^{10d} is present, a plurality of R^{10d} may be the same or different and that when a plurality of X is present, a plurality of X may be the same or different).

53. A polymerizing process for a vinyl compound, characterized by polymerizing a vinyl compound as component (Z) using the polymerizing catalyst as described in claim 45 or the polymerizing catalyst produced by the process as described in claim 50.

54. The polymerizing process for a vinyl compound as described in claim 53, wherein the component (Z) is at least one olefin selected from ethylene, propylene, butene, butadiene, cyclic olefin having 5 to 20 carbon atoms and styrene.

55. A vinyl compound polymer obtained by the polymerizing process as described in claim 53.

56. A composite resin comprising the vinyl compound polymer as described in claim 55 and a thermoplastic resin.

57. A composite resin composition comprising a copolymer of alkenylsilane and propylene and a layered compound, wherein the layered compound is dispersed in the copolymer in the form of a particle having a particle diameter of 1 μm or less.
